(19) United States
(12) Patent Application Publication
(10) Pub. No.: US 2026/0262638 A1
(43) Pub. Date: Sep. 10, 2026

(54) AGRICULTURAL COMPOSITION

(71) Applicant: ORO AGRI EUROPE S.A., Setubal (PT)

(72) Inventors: Carol Pullen, Amsterdam (NL); Sara Alexandra Valadas Silva Monteiro, Setubal (PT); Robert Malek, Setubal (PT); Aya Ibrahim, Setubal (PT); Charl Guillaume Marais, Setubal (PT); Paulo Sergio Berg, Londrina (BR)

(21) Appl. No.: 18/848,859

(22) PCT Filed: Mar. 21, 2023
(86) PCT No.: PCT/IB2023/052772

§ 371 Date: Sep. 19, 2024

(30) Foreign Application Priority Data
Mar. 22, 2022 (ZA) 2022/03278

(51) Int. Cl. A01N 37/36; A01N 31/02; A01N 37/06; A01N 43/08; A01N 63/22; A01N 65/00; A01P 3/00; A01P 5/00

(52) U.S. Cl. CPC A01N 37/36; A01N 31/02; A01N 37/06; A01N 43/08; A01N 63/22; A01N 65/00; A01P 3/00; A01P 5/00

(57) ABSTRACT

An agricultural carrier compositions that may be loaded with at least one antipathogenic agent and/or at least one biocontrol agent and/or fertilizer agent and/or biostimulant agent and/or an elicitor agent and/or a plant growth regulator and/or an insect repellant; and methods of manufacturing the compositions. The agricultural composition may include a (C₂-C₂₆) alkyl lactate and/or derivate thereof, a (C₂-C₂₂) alcohol, a humectant; and a non-ionic and/or anionic surfactant. The agricultural composition may additionally include a binder, therein provided an agricultural carrier composition; and may further be loaded with at least one antipathogenic agent and/or at least one biocontrol agent and/or fertilizer agent and/or biostimulant agent and/or an elicitor agent and/or a plant growth regulator and/or an insect repellant.

### FIELD OF DISCLOSURE

This disclosure relates to an agricultural composition. Particularly, the disclosure relates to an agricultural carrier composition. Further particularly, this disclosure relates to agricultural carrier compositions that may be loaded with at least one antipathogenic agent and/or at least one biocontrol agent and/or fertilizer agent and/or biostimulant agent and/or an elicitor agent and/or a plant growth regulator and/or an insect repellent. The disclosure extends to methods of manufacturing the aforementioned.

### BACKGROUND

The phylum Nematoda is an extremely diverse animal phylum and is ubiquitous throughout most ecosystems on earth. In agriculture and horticulture, nematodes can be either beneficial or detrimental to plant health depending on the species. Beneficial nematodes may be predatory and kill pests that would otherwise negatively impact the health of a plant. Detrimental nematodes may attack parts of plant anatomy directly and may additionally and/or alternatively act as vectors for spreading plant diseases.

Detrimental nematodes may cause extensive crop damage and are known to be challenging to control and/or kill. Detrimental nematodes may also be parasitic. Plant parasitic nematodes are known to include a hollow mouth spear or stylet used to puncture plant cells to access a food source. Such plant parasitic nematodes secrete metabolites and/or proteins into the plant host and have been noted to induce differentiation of cells in their host providing feeding structures facilitating nematode growth and reproduction resulting in plant invasion and parasitism. Nematodes are known to feed on roots, stems, leaves, flowers and/or seeds of plants.

Owing to traditional nematicidal chemical products being increasingly withdrawn from the market due to environmental and/or ecotoxicological impact concerns, transgenic approaches have been employed to ensure transgenic plant crops express certain proteins that may act as nematicides and/or nematistatic compositions. Transgenic approaches are expensive and often are not readily accessible to farmers in developing world countries due to their prohibitive cost.

A wide range of other protocols are known to control and/or kill detrimental nematodes including traditional chemical approaches, phytochemical approaches, and/or biocontrol approaches, wherein biocontrol is to be understood as using a living organism to suppress and/or reduce and/or inhibit and/or destroy the population of a particular pest. Single tiered approaches may often display limited success, whilst a multi-tiered approach may result in unwanted side effects.

For example, in a multitiered approach, administration of a traditional synthetic chemical compound (or a phytosanitary chemical compound) together with a biocontrol agent to a plant (or soil) may very well result in the synthetic or phytosanitary chemical destroying or impairing the biocontrol agent.

Organic acids and bacteria and fungi have been known to display nematicidal and/or nematistatic activity. However, it is also known that organic acids may be antimicrobial and antifungal. Consequently, the choice of active agents in a multitiered approach is extremely important.

Each component in a multitiered approach may have a different target and/or mode of action, such that when used together in a treatment program the overall impact is effective nematode control and/or destruction. In some instances, there may be synergism, although predicting same is not reasonably possible owing to the diverse biochemical pathways involved at different target sites and the varying modes of action involved. The unpredictability of any success in multitiered approaches is very high.

Multitiered approaches may also be employed to combat resistance since it is known that nematodes may develop resistance to traditional chemical nematicides.

Careful selection of the individual components in a multitiered approach is important to avoid a situation where such individual components counteract one another or destroy one another. Further, in a multitiered approach comprising a plurality of active agents for administration to a plant (or soil surrounding such plant) in a treatment program, the timing of said administration is also important to avoid the individual components counteracting one another or interfering with the other's mode of action.

Typically, a multitiered approach in a treatment program may include separate timed applications of the different components or active agents. This is disadvantageous to the farmer as it will require multiple applications, increased soil compaction caused by agricultural equipment, extra expenditure of time, and extra labor. Further, it requires a high degree of technical understanding of how the individual components will interact and possibly counteract with one another which is disadvantageous in areas of low literacy rates or poor education.

Since separate individual application of individual components in a multitiered approach is disadvantageous, a concomitant administration of the different components is desired.

When considering the concomitant application of the different components in a multitiered approach any carrier composition is of crucial importance. The chemical composition of such carrier composition should not negatively interact with each of the individual components whilst still ensuring protection of each individual component until it is delivered to its desired target site on the plant (or in the soil) where its particular mode of action may facilitate nematode control (and/or destruction). The development of such carrier compositions needs to take into consideration not only physico-chemical properties of the different components, but also the biochemical and physiological pathways associated with biocontrol agents, the desired targets and the modes of action. Similar multitiered approaches are also desirable in treatment protocols to control and/or destroy other plant pathogens and/pr plant pests including insects, larvae, worms, arachnids, bacteria, fungi, viruses and the like.

Further, shelf-life considerations are important in concomitant application of the different components in a multitiered approach when using a carrier composition. The carrier composition is required to be stable and have a stable shelf-life in itself, and mainly when combined with the biocontrol agents (chemical or biochemical compounds, metabolites, dormant or alive biocontrol agents). The individual components should not negatively interact with one another nor negatively interact with the carrier composition in a manner that could lead to a decreased shelf-life. The chemical interactions between all the individual components needs to result in a stable composition. Predicting shelf-life based on individual chemical and/or biochemical and/or microbiological components is extremely challenging.

There is a need to provide more effective agricultural compositions in agro-chemistry. Particularly, there is a need to provide more effective agricultural compositions in multitiered approaches when combatting pests including nematodes, insects, fungi and the like.

There is also a need for increasing performance of plant protection products and/or reducing the incidence of resistance toward same by plant pathogens.

Further, there continues to be a need in promoting increased agricultural yields and/or improving plant health of agricultural crops.

The disclosure described herein below strives to ameliorate at least one of the problems described above and/or otherwise known in the prior art.

### SUMMARY

Broadly, and in accordance with a first aspect of this disclosure there is provided an agricultural composition comprising:
a (C₂-C₂₆) alkyl lactate and/or derivate thereof;
a (C₂-C₂₂) alcohol;
a humectant; and
a non-ionic and/or an anionic surfactant.

The (C₂-C₂₆) alkyl lactate may be a (C₁₀-C₂₂) alkyl lactate and/or derivative thereof.

The (C₂-C₂₆) alkyl lactate and/or derivate thereof may be at least one selected from, but not limited to, the group comprising: ethyl lactate, propyl lactate, butyl lactate, pentyl lactate, hexyl lactate, heptyl lactate, octyl lactate, nonyl lactate, decyl lactate, undecyl lactate, dodecyl lactate, tridecyl lactate, tetradecyl lactate, pentadecyl lactate, hexadecyl lactate, heptadecyl lactate, octadecyl lactate, nonadecyl lactate, eicosyl lactate, heneicosyl lactate, and docosyl lactate, and/or derivatives of the aforementioned.

The alkyl lactate may be a (C₁₀-C₂₂) alkyl lactate or any combination and/or derivative of the aforementioned and combinations thereof. Preferably the (C₁₀-C₂₂) alkyl lactate and/or derivate thereof may be at least one selected from, but not limited to, the following group comprising: a lauryl lactate (dodecyl lactate), a myristyl lactate (tetradecyl lactate), a cetyl lactate (hexadecyl lactate), and lauryl lactyl lactate.

The (C₂-C₂₆) alkyl lactate and/or derivative thereof may be a (C₂-C₂₆) alkyl lactyl lactate and/or derivative thereof.

The (C₂-C₂₆) alkyl lactyl lactate and/or derivate thereof may be at least one selected from, but not limited to, the group comprising: ethyl lactyl lactate, propyl lactyl lactate, butyl lactyl lactate, pentyl lactyl lactate, hexyl lactyl lactate, heptyl lactyl lactate, octyl lactyl lactate, nonyl lactyl lactate, decyl lactyl lactate, undecyl lactyl lactate, dodecyl lactyl lactate, tridecyl lactyl lactate, tetradecyl lactyl lactate, pentadecyl lactyl lactate, hexadecyl lactyl lactate, heptadecyl lactyl lactate, octadecyl lactyl lactate, nonadecyl lactyl lactate, eicosyl lactyl lactate and/or derivatives of the aforementioned.

The (C₂-C₂₆) alkyl lactyl lactate and/or derivative thereof may include a (C₁₀-C₂₂) alkyl lactyl lactate and/or derivative thereof. Preferably the (C₁₀-C₂₂) alkyl lactyl lactate may be lauryl lactyl lactate.

The (C₂-C₂₂) alcohol may include monoalcohols, diols, triol, tetraol, pentaols, hexaols, alkyl alcohols, alkenols, alkynols, primary-, secondary-, tertiary-, aromatic-, cyclic-, alicyclic-, unbranched-, branched-, saturated-, and unsaturated alcohols, and/or any combination and/or derivative of the aforementioned.

The (C₂-C₂₂) alcohol may be at least one selected from, but not limited to, the group comprising: ethanol, propanol, propan-2-ol, butanol, butan-2-ol, pentanol, pentan-2-ol, pentan-3-ol, hexanol, hexan-2-ol, hexan-3-ol, heptanol, heptan-2-ol, heptan-3-ol, heptan-4-ol, octanol, octan-2-ol, octanol-3-ol, octan-4-ol, 2-ethylhexanol, nonanol, nonan-2-ol, nonan-3-ol, nonan-4-ol, nonan-5-ol, decanol, decan-2-ol, decan-3-ol, decan-4-ol, decan-5-ol, undecanol, undecane-2-ol, undecane-3-ol, undecane-4-ol, undecane-5-ol, undecane-6-ol, dodecanol, dodecan-2-ol, dodecan-3-ol, dodecan-4-ol, dodecan-5-ol, dodecan-6-ol, tridecanol, tridecan-2-ol, tridecan-3-ol, tridecan-4-ol, tridecan-5-ol, tridecan-6-ol, tridecan-7-ol, tetradecanol, tretradecan-2-ol, tetradecan-3-ol, tetradecan-4-ol, tetrdecaan-5-ol, tetradecan-6-ol, tetradecan-7-ol, pentadecanol, pentadecan-2-ol, pentadecan-3-ol, pentadecan-4-ol, pentadecan-5-ol, pentadecan-6-ol, pentadecan-7-ol, pentadecan-8-ol, hexadecanol, hexadecan-2-ol, hexadecan-3-ol, hexadecan-4-ol, hexadecan-5-ol, hexadecan-6-ol, hexadecan-7-ol, hexadecan-8-ol, heptadecanol, heptadecan-2-ol, heptadecan-3-ol, heptadecan-4-ol, heptadecan-5-ol, heptadecan-6-ol, heptadecan-7-ol, heptadecan-8-ol, heptadecan-9-ol, octadecanol, octadecan-2-ol, octadecan-3-ol, octadecan-4-ol, octadecan-5-ol, octadecan-6-ol, octadecan-7-ol, octadecan-8-ol, octadecan-9-ol, nonadecanol, nonadecan-2-ol, nonadecan-3-ol, nonadecan-4-ol, nonadecan-5-ol, nonadecan-6-ol, nonadecan-7-ol, nonadecan-8-ol, nonadecan-9-ol, nonadecan-10-ol, eicosanol, eicosan-2-ol, eicosan-3-ol, eicosan-4-ol, eicosan-5-ol, eicosan-6-ol, eicosan-7-ol, eicosan-8-ol, eicosan-9-ol, eicosan-10-ol, heneicosanol, heneicosan-2-ol, heneicosan-3-ol, heneicosan-4-ol, heneicosan-5-ol, heneicosan-6-ol, heneicosan-7-ol, heneicosan-8-ol, heneicosan-9-ol, heneicosan-10-ol, heneicosan-11-ol, docosanol, docosan-2-ol, docosan-3-ol, docosan-4-ol, docosan-5-ol, docosan-6-ol, docosan-7-ol, docosan-8-ol, docosan-9-ol, docosan-10-ol and docosan-11-ol, and/or any combination and/or derivative of the aforementioned.

The humectant may be at least one selected from, but not limited to, the group comprising: glycerin, glycerol or alkyl ethers thereof, (C₂-C₃₀) alkene glycol, propylene glycol, polypropylene glycol or alkyl ethers thereof, sorbitol, mannitol, dulcitol and/or polyols, alkyl glycoside, straight chain (C₄-C₁₈) alkyl(poly)glycosides, branched chain (C₄-C₁₈) alkyl(poly)glycosides, straight chain (C₄-C₁₈) alkyl(poly)glucosides, branched chain (C₄-C₁₈) alkyl(poly)glucosides, aryl glycosides, and/or any combination and/or derivative of the aforementioned.

The non-ionic may be at least one selected from, but not limited to, the group comprising: natural and/or synthetic (C₈-C₂₂) alkoxylated fatty alcohols, (C₈-C₂₂) ethoxylated fatty alcohols, (C₈-C₂₂) propoxylated fatty alcohols, (C₈-C₂₂) ethoxylated and propoxylated fatty alcohols, (C₆-C₂₂) alkoxylated fatty acids, (C₆-C₂₂) ethoxylated fatty acids, (C₆-C₂₂) propoxylated fatty acids, EO-PO (C₆-C₂₂) ethoxylated and propoxylated fatty acids, straight chain (C₄-C₁₀) alkyl(poly)glycosides, branched chain (C₄-C₁₀) alkyl(poly)glycosides; and alkoxylated sorbitan fatty esters, alkoxylated sorbitol fatty esters, ethoxylated sorbitan fatty esters, ethoxylated sorbitol fatty esters, polyoxyethylene sorbitan monolaurate, polyoxyethylene sorbitan monopalmitate, polyoxyethylene sorbitan monostearate, polyoxyethylene sorbitan monolaurate, polyoxyethylene glycol sorbitan monolaurate, polyoxyethylene glycol sorbitan monopalmitate, polyoxyethylene glycol sorbitan monostearate, N-substituted fatty acid amides, fatty acid glucamides, fatty acid alkanolamides, amine oxides, polymeric surfactants, copolymers of vinylpyrrolidone, vinylalcohols, or vinylacetate, alkoxylated fatty acid esters, glycerol esters or monoglycerides and/or any combination and/or derivative of the aforementioned.

The ethoxylated fatty alcohols of fatty acids may have a degree of ethoxylation of from 1 to 60, more preferably 2 to 40, most preferably 3 to 10.

The anionic may be at least one selected from, but not limited to, the group comprising: (C₆-C₁₈) alkyl benzene sulfonic acid salts, calcium dodecylbenzene sulfonate, sodium dodecylbenzene sulfonate, amine (C₆-C₁₈) alkyl benzene sulfonate, triethanolamine dodecylbenzene sulfonates, (C₆-C₁₈) alkyl ether sulfates, (C₆-C₁₈) alkyl ethoxylated ether sulfates, (C₆-C₁₈) alkyl sulfates, lauryl ether polyethoxylated sodium sulfate, lignosulfonates, phenylsulfonates, naphthalenesulfonates, dibutylnaphthalenesulfonates, (C₆-C₁₈) alkyl phosphate esters, (C₆-C₁₈) alkoxylated sulfates, xylene sulfonate salts, cumene sulfonate salts, lignosulfonates, phenylsulfonates, naphthalenesulfonates, dibutylnaphthalenesulfonates, alkyl polyglycol ether phosphates, polyarylphenyl ether phosphates, alkyl-sulfosuccinates, olefin sulfonates, condensation products of sulfonated naphthalenes with formaldehyde, condensation products of sulfonated naphthalenes with formaldehyde and phenol and optionally urea and condensation products of phenolsulfonic acid with formaldehyde and urea, (C₆-C₁₈) alkoxylated phosphate esters, alkyl phosphates, alkyl aryl phosphates, for example tristyryl phosphates, and polycarboxylates such as for example polyacrylates, aryl glycosides, maleic anhydride/olefin copolymers, including the alkali metal, alkaline earth, ammonium and amine salts of the aforesaid substances and/or any combination and/or derivative of the aforementioned and combinations thereof.

The various elements of the agricultural composition including the (C₂-C₂₆) alkyl lactate and/or derivate thereof, the (C₂-C₂₂) alcohol, the humectant; and the non-ionic and/or an anionic surfactant, may interact chemico-physically to provide an aggregate or stereoscopic structure with sufficient stability to define a syrup and/or gel as an independent molecular species having physico-chemical properties distinct from its individual elements. Chemical interactions experienced among the various elements include at least one of, but not limited to, the following group of interactions: ionic, ion-dipole, covalent, hydrogen bonding, dipole-dipole, van der Waals, dipole-induced-dipole, London dispersion, π-π interactions, cation-π interactions and anion-π interactions. A chemical bond is formed between two atoms or groups of atoms from the various elements such that the forces acting between them are such as to lead to the formation of an aggregate or stereoscopic structure with sufficient stability to define the syrup and/or gel as an independent molecular species have physico-chemical properties distinct from its individual elements.

The agricultural composition may further comprise a carboxylic acid and/or a salt thereof. Preferably, the carboxylic acid may be a (C₂-C₂₂) carboxylic acid and/or a salt thereof.

The (C₂-C₂₂) carboxylic acid and/or a salt thereof may be at least one selected from, but not limited to, the group comprising: ethanoic acid, 2-hydroxyethanoic acid, oxoethanoic acid, ethanedioic acid, propanoic acid, propenoic acid, propynoic acid, 2-hydroxypropanoic acid, 3-hydroxypropanoic acid, 2,3-dihydroxypropanoic acid, 2-oxopropanoic acid, 3-oxopropanoic acid, 2,3-oxopropanoic acid, propanedioic acid, 2-hydroxypropanedioic acid, 2-hydroxy-3-oxopropanoic acid, 2,2-dihydroxypropanedioic acid, oxopropanedioic acid, oxirane-2-carboxylic acid, butanoic acid, 2-methylpropanoic acid, (E)-but-2-enoic acid, (Z)-but-2-enoic acid, 2-methylpropenoic acid, but-3-enoic acid, but-2-yonic acid, 2-hydroxybutanoic acid, 3-hydroxybutanoic acid, 4-hydroxybutanoic acid, 2-oxobutanoic acid, 3-oxobutanoic acid, 4-oxobutanoic acid, butanedioic acid, 2-methylpropanedioic acid, (E)-butenedioic acid, (Z)-butenedioic acid, butynedioic acid, hydroxybutanedioic acid, 2,3-dihydroxybutanedioic acid, oxobutanedioic acid, dioxobutanedioic acid, pentanoic acid, 3-methylbutanoic acid, 2-methylbutanoic acid, 2,2-dimethylpropanoic acid, 3-hydroxypentanoic acid, 4-hydroxypentanoic acid, 3-hydroxy-3-methylbutanoic acid, pentanedioic acid, 2-oxopentanedioic acid, 3-oxopentanedioic acid, furan-2-carboxylic acid, tetrahydrofuran-2-carboxylic acid, hexanoic acid, hexanedioic acid, 2,3-dimethylbutanoic acid, 3,3-dimethylbutanoic acid, 2-hydroxypropane-1,2,3-tricarboxylic acid, prop-1-ene-1,2,3-tricarboxylic acid, 1-hydroxypropane-1,2-3-tricarboxylic acid, (2E, 4E)-hexa-2,4-dienoic acid, heptanoic acid, heptanedioic acid, cyclohexanecarboxylic acid, benzenecarboxylic acid, 2-hydroxybenzoic acid, 2,2-dimethylpentanoic acid, 2,3-dimethylpentanoic acid, 2,4-dimethylpentanoic acid, 3,3-dimethylpentanoic acid, 2-ethylpentanoic acid, 3-ethylpentanoic acid, 2-methylhexanoic acid, 3 -methylhexanoic acid, 2,2,3-trimethylbutanoic acid, 2-ethyl-2-methylbutanoic acid, 2-ethyl-3-methylbutanoic acid, octanoic acid, benzene-1,2-dicarboxylic acid, benzene-1,3-dicarboxylic acid, benzene-1,4-dicarboxylic acid, 2-methylheptanoic acid, 3-methylheptanoic acid, 4-methylheptanoic acid, 5-methylheptanoic acid, 6-methylheptanoic acid, 2,2-dimethylheptanoic acid, 2,3-dimethylheptanoic acid, 2,4-dimethylheptanoic acid, 2,5-dimethylheptanoic acid, 3,3-dimethylheptanoic acid, 3,4-dimethylheptanoic acid, 3,5-dimethylheptanoic acid, 4,4-dimethylheptanoic acid, 4,5-dimethylheptanoic acid, 5,5-dimethylheptanoic acid, 2-ethanhexanoic acid, 3-ethanhexanoic acid, 4-ethanhexanoic acid, 5-ethanhexanoic acid, 2-octenoic acid, 3-octenoic acid, 4-octenoic acid, 5-octenoic acid, 6-octenoic acid, 7-octenoic acid, benzene-1,3,5-tricarboxylic acid, (E)-3-phenylprop-2-enoic acid, decanoic acid, decanedioic acid, undecanoic acid, dodecanoic acid, benzene-1,2,3,4,5,6-hexacarboxylic acid, tridecanoic acid, tetradecanoic acid, pentadecanoic acid, hexadecanoic acid, heptadecanoic acid, octadecanoic acid, (9Z)-octadec-9-enoic acid, (9Z, 12Z)-octadeca-9,12-dienoic acid, (9Z, 12Z, 15Z)-octadeca-9,12,15-trienoic acid, (6Z, 9Z, 12Z)-octadeca-6,9,12-trienoic acid, (6Z, 9Z, 12Z, 15Z)-octadeca-6,9,12,15-tetraenoic acid, nonadecanoic acid, eicosanoic acid, (5Z, 8Z, 11Z)-eicosa-5,8,11-trenoic acid, (5Z, 8Z, 11Z, 14Z)-eicosa-5,8,11,14-tetraenoic acid, (5Z, 8Z, 11Z, 14Z, 17Z)-eicosa-5,8,11,14,17-pentaenoic acid, heneicosanoic acid, docosanoic acid, (4Z, 7Z, 10Z, 13Z, 16Z, 19Z)-docosa-4,7,10,13,16,19-hexaenoic acid, and salt thereof, and/or any combinations thereof.

Additionally, and/or alternatively, the agricultural composition may further comprise a plant hormone, typically a stress related plant hormone. Typically, when in use, said plant hormone stimulates production of defensive secondary plant metabolites in response to biotic and/or abiotic stress.

The plant hormone may be at least one selected from, but not limited to, the group: abscisic acid, auxins, brassinosteroids, cytokinins, ethylene, gibberellins, jasmonate, jasmonic acid, salicylic acid, strigolactones, polyamines, nitric acid, triacontanol, and derivatives thereof.

Additionally, and/or alternatively, the agricultural composition may further comprise a secondary metabolite. The secondary metabolite may be a secondary plant-, bacterial- or fungal metabolite. Secondary plant metabolites may include at least one, but not limited to, the group comprising: phenolics, alkaloids, saponins, terpenes, lipids, carbohydrates and glucosinolates. In a certain embodiment of the disclosure the secondary plant metabolite is salicylic acid. Secondary bacterial metabolites may include at least one, but not limited to, the group comprising: polyketides, nonribosomal peptides, ribosomal peptides, glucosides and alkaloids. Secondary fungal metabolites may include at least one, but not limited to, the group comprising: itaconic acid, polyketides, nonribosomal peptides and terpenes. In a certain embodiment of the disclosure the secondary metabolite may be salicylic acid and/or itaconic acid.

The agricultural composition may further comprise a microorganism.

In a certain embodiment of the disclosure the microorganism may be a spore forming microorganism.

The agricultural composition may further comprise pheromones, amino acids, peptides, RNA, mRNA, siRNA, DNA, protozoa, oomycete and/or yeast.

The microorganism may be selected from, but not limited to, the group: viruses, bacteria and fungi.

Typically, viruses may include at least one selected from, but not limited to, any one in the family of the group comprising: baculoviruses, cypoviruses, and densoviruses.

Typically, viruses may include at least one baculovirus selected from, but not limited to, Cydia pomonella granulovirus and Cryptophlebia peltastica nucleopolyhedrovirus.

Typically, bacteria may include at least one selected from, but not limited to, any of the species in the genera group comprising: Agrobacterium, Bacillus, Burkholderia, Paenibacillus, Pseudomonas, Rhanella, Rhizobium, Saccharopolyspora, Serratia and Streptomyces.

In a certain preferred embodiment the bacteria may be at least one selected from, but not limited to, the group comprising: Bacillus subtilis sp., Bacillus amyloliquefaciens sp., Bacillus firmus sp., Bacillus popilliae sp., Bacillus lontimorbus sp., Bacillus nakamuri sp., Bacillus pumilus sp., Bacillus sphaericus Bacillus thuringiensis sp., Bacillus simplex sp., Bacillus licheniformis sp., Bacillus fastidiosus sp., Bacillus megaterium sp., Bacillus thuringiensis kurstaki sp., Bacillus thuringiensis israelensis sp., Bacillus thuringiensis aizawai sp., Bacillus thuringiensis aegyptii sp., Bacillus velezensis sp., Pseudomonas chlororaphis sp., Pseudomonas fluorescens sp., Pseudomonas protegeans sp., Streptomyces lydicus sp., Streptomyces sp., Lysobacter sp., and/or any combinations thereof.

Fungi may include mycorrhiza. Typically, fungi may include at least one selected from, but not limited to, any of the species in the genera group comprising: Alternaria, Aerobasidium, Ampelomyces, Aschersonia, Aspergillus, Beauveria, Candida, Clonostachys, Coniothyrium, Cordyceps, Entomophaga, Fusarium, Glomus, Hirustella, Isaria, Lecanicillium, Metarhizium, Paecilomyces, Penicillium, Pichia, Pseudozyma, Saccaharomyces, Talaromyces, Trichoderma, and Verticillium.

In certain embodiments the fungi may be at least one selected from, but not limited to, the group comprising: Aerobasidium pullulans sp., Ampelomyces Quisqualis sp., Aschersonia aleyrodis sp., Aspergillus flavus sp., Beauveria bassiana sp., Beauveria brongniartii sp., Candida oleophila sp., Clonostachys rosea sp., Coniothyrium minitans sp., Cordyceps fumosorosea sp., Entomophaga maimaiga sp., Hirustella thompsonii sp., Isaria fumosorosea sp., Metarhizium anisopliae sp., Paecilomyces fumosoroseus sp., Paecilomyces lilacinus sp., Pseudozyma flocculosa sp., Saccharomyces cerevisiae sp., Trichoderma asperellum sp., Trichoderma viride sp., Trichoderma reesei sp., Trichoderma atroviride sp., Trichoderma gamsii sp., Trichoderma harzianum sp., Trichoderma polysporum sp., Trichoderma paucisporum sp., Trichoderma afroharzianu sp., Trichoderma yunnaense sp., Trichoderma evansii sp., Trichoderma hamatum sp., Trichoderma atrobrunneum sp. and Verticillium alboatrum sp., and/or any combination thereof.

Typically, the oomycete may be of the genus Lagenidium and/or Pythium, particularly Lagenidium giganteum sp. and/or Pythium insidiosum.

The agricultural composition may further comprise a binder. The binder may be selected from, but not limited to, the group comprising: polysaccharides, sucrose, fructose, saccharose, pectin, amylopectin, glycosides, glucosides, (C₁-C₃₀) alkyl glycosides, (C₁-C₃₀) alkyl glucosides, gelatin, starch, modified starch, alginates, modified alginates, natural gums, modified gum, gar gums, rosin, tall oil rich in rosin, (C₁-C₃₀) alkyl cellulose, salts of (C₁-C₃₀) alkyl cellulose, carboxymethyl cellulose, salts of carboxymethyl cellulose, sodium carboxymethyl cellulose, microcrystalline cellulose, polyvinyl pyrrolidone, cross-linked polyvinylpyrrolidone, dimethylaminoethyl-methacrylate copolymer, PVP (polyvinyl pyrrolidone)/hexadecene copolymer, (C₁-C₃₀) alkyl acrylates, methyl acrylate, butyl acrylate, ethyl acrylate, 2-ethylhexyl acrylate, poly acrylates, (C₁-C₃₀) alkyl aryl acrylates, styrene derivatives, and combinations thereof.

In a preferred embodiment of the disclosure, the binder may be a styrene acrylic emulsion polymer.

The agricultural composition may further comprise a diluent. The diluent may be water.

The agricultural composition may further comprise an additional diluent, solvent, or a co-solvent. The diluent, solvent, or co-solvent is selected, but not to limited to, the group comprising: alcohols, acids, fatty acids, amines, amides, ethers, esters, diesters, ketones, acetates, terpenes, sulfoxides, phenols, glycols, alkyl glycols, glycol ether esters, paraffins, hydrocarbons, tall oils, tall oil fatty esters, heterocyclics, aromatics, naphthenics, nitrogen compounds, sulfur compounds, halogen hydrocarbons, and combinations thereof. The preferred solvents or co-solvent are alkyl glycols, glycol ether esters, alkyl lactates, propylene carbonate, tall oil fatty acid esters, alkylated seed oil, such as ethylated or butylated seed oils, and combinations thereof.

The agricultural composition may further comprise an additive selected from, but not limited to, the group comprising: preservatives, dispersant, humectant, wetting agents, spreaders, compatibilizers, binders, fillers, adhesives, protective colloids, thickeners, thixotropic agents, penetrants, retention promoters, sequestrants, clarifiers, anti-freezing agents, anti-caking agents, hydrotropes, stabilizers, antioxidants, UV/light protectors, acidifiers, alkaline agents, chelates, complexing agents, dyes, rheology modifiers, antifoams, anti-drift agents, oil, water, solvents or other co-solvents, and combinations thereof.

In a preferred embodiment of the agricultural composition the alkyl lactate is a (C₁₀-C₂₂) alkyl lactate and/or derivate thereof and may be present in an amount of between about 5 wt. % to about 50 wt. % of the total wt. % of a formulated agricultural composition. Preferably, the (C₁₀-C₂₂) alkyl lactate and/or derivate thereof may be present in an amount of between about 7 wt. % to about 35 wt. % of the total wt. % of a formulated agricultural composition, further preferably the (C₁₀-C₂₂) alkyl lactate and/or derivate thereof may be present in an amount of between about 10 wt. % to about 20 wt. % of the total wt. % of a formulated agricultural composition. It is to be understood that the ranges herein include any minimum value or maximum value within said range, and includes any value there between. It is to be understood that wt. % in this disclosure is weight percentage.

In a preferred embodiment of the agricultural composition the (C₂-C₂₂) alcohol may be present in an amount of between about 0.1 wt. % to about 20 wt. % of the total wt. % of a formulated agricultural composition. Preferably, the (C₂-C₂₂) alcohol may be present in an amount of between about 0.5 wt. % to about 10 wt. % of the total wt. % of a formulated agricultural composition, further preferably the (C₂-C₂₂) alcohol may be present in an amount of between about 1 wt. % to about 5 wt. % of the total wt. % of a formulated agricultural composition. It is to be understood that the ranges herein include any minimum value or maximum value within said range, and includes any value there between.

In a preferred embodiment of the agricultural composition the humectant may be present in an amount of between about 1 wt. % to about 30 wt. % of the total wt. % of a formulated agricultural composition. Preferably, the humectant may be present in an amount of between about 5 wt. % to about 20 wt. % of the total wt. % of a formulated agricultural composition, further preferably the humectant may be present in an amount of between about 7 wt. % to about 15 wt. of the total wt. % of a formulated agricultural composition. It is to be understood that the ranges herein include any minimum value or maximum value within said range, and includes any value there between.

In a preferred embodiment of the agricultural composition the non-ionic and/or an anionic surfactant may be present in an amount of between about 1 wt. % to about 50 wt. % of the total wt. % of a formulated agricultural composition. Preferably, the non-ionic and/or an anionic surfactant may be present in an amount of between about 5 wt. % to about 30 wt. % of the total wt. % of a formulated agricultural composition, further preferably the non-ionic and/or an anionic surfactant may be present in an amount of between about 10 wt. % to about 20 wt. % of the total wt. % of a formulated agricultural composition. It is to be understood that the ranges herein include any minimum value or maximum value within said range, and includes any value there between.

In a preferred example embodiment the agricultural composition includes only the nonionic surfactant to the exclusion of the anionic surfactant, and wherein the nonionic surfactant may be present in an amount of between about 1 wt. % to about 50 wt. % of the total wt. % of a formulated agricultural composition. Preferably, the non-ionic surfactant may be present in an amount of between about 5 wt. % to about 30 wt. % of the total wt. % of a formulated agricultural composition, further preferably the non-ionic surfactant may be present in an amount of between about 10 wt. % to about 20 wt. % of the total wt. % of a formulated agricultural composition. It is to be understood that the ranges herein include any minimum value or maximum value within said range, and includes any value there between.

In a preferred embodiment of the agricultural composition the carboxylic acid may be present in an amount of between about 0.1 wt. % to about 20 wt. % of the total wt. % of a formulated agricultural composition. Preferably, the carboxylic acid may be present in an amount of between about 0.5 wt. % to about 10 wt. % of the total wt. % of a formulated agricultural composition, further preferably the carboxylic acid may be present in an amount of between about 0.5 wt. % to about 5 wt. % of the total wt. % of a formulated agricultural composition. It is to be understood that the ranges herein include any minimum value or maximum value within said range, and includes any value there between.

In a preferred embodiment of the agricultural composition the plant hormone may be present in an amount of between about 0.1 wt. % to about 20 wt. % of the total wt. % of a formulated agricultural composition. Preferably, the plant hormone may be present in an amount of between about 0.5 wt. % to about 10 wt. % of the total wt. % of a formulated agricultural composition, further preferably the plant hormone may be present in an amount of between about 0.5 wt. % to about 5 wt. % of the total wt. % of a formulated agricultural composition. It is to be understood that the ranges herein include any minimum value or maximum value within said range, and includes any value there between.

In a preferred embodiment of the agricultural composition the secondary metabolite may be present in an amount of between about 0.1 wt. % to about 20 wt. % of the total wt. % of a formulated agricultural composition. Preferably, the secondary metabolite may be present in an amount of between about 0.5 wt. % to about 10 wt. % of the total wt. % of a formulated agricultural composition, further preferably the secondary metabolite may be present in an amount of between about 0.5 wt. % to about 5 wt. % of the total wt. % of a formulated agricultural composition. It is to be understood that the ranges herein include any minimum value or maximum value within said range, and includes any value there between.

In a preferred embodiment of the agricultural composition the microorganism may be present in an amount of between about 1 wt. % to about 70 wt. % of the total wt. % of a formulated agricultural composition. Preferably, the microorganism may be present in an amount of between about 10 wt. % to about 50 wt. % of the total wt. % of a formulated agricultural composition, further preferably the microorganism may be present in an amount of between about 25 wt. % to about 35 wt. % of the total wt. % of a formulated agricultural composition. It is to be understood that the ranges herein include any minimum value or maximum value within said range, and includes any value there between. It is further to be understood that microorganisms may be formulated in a growth medium and that the percentages may represent dry weight percentages and/or formulated wet weight percentages including the growth medium.

In a preferred embodiment of the agricultural composition the binder may be present in an amount of between about 0.1 wt. % to about 20 wt. % of the total wt. % of a formulated agricultural composition. Preferably, the binder may be present in an amount of between about 1 wt. % to about 15 wt. % of the total wt. % of a formulated agricultural composition, further preferably the binder may be present in an amount of between about 2 wt. % to about 10 wt. % of the total wt. % of a formulated agricultural composition. It is to be understood that the ranges herein include any minimum value or maximum value within said range, and includes any value there between.

In a preferred embodiment of the agricultural composition the additive may be present in an amount of between about 0.1 wt. % to about 20 wt. % of the total wt. % of a formulated agricultural composition. Preferably, the additive may be present in an amount of between about 0.5 wt. % to about 15 wt. % of the total wt. % of a formulated agricultural composition, further preferably the additive may be present in an amount of between about 1 wt. % to about 10 wt. % of the total wt. % of a formulated agricultural composition. It is to be understood that the ranges herein include any minimum value or maximum value within said range, and includes any value there between.

In a preferred embodiment of the agricultural composition the diluent may be present in an amount of between about 1 wt. % to about 80 wt. % of the total wt. % of a formulated agricultural composition. Preferably, the diluent may be present in an amount of between about 10 wt. % to about 50 wt. % of the total wt. % of a formulated agricultural composition, further preferably the diluent may be present in an amount of between about 20 wt. % to about 30 wt. % of the total wt. % of a formulated agricultural composition. It is to be understood that the ranges herein include any minimum value or maximum value within said range, and includes any value there between.

The agricultural composition of this disclosure may be provided as at least one of, but not limited to, the group comprising: plant protection product, adjuvant, soil conditioner, biostimulant, seed treatment means, fertilizer, insect growth regulator, plant growth regulator, and elicitor.

The agricultural composition may further include at least one of, but not limited to, the group comprising: plant protection product, adjuvant, soil conditioner, biostimulant, seed treatment means, fertilizer, insect growth regulator, plant growth regulator and elicitor.

In a preferred embodiment of the disclosure, the agricultural composition of this disclosure is provided as a plant protection product and may be an insecticide, pesticide, miticide, acaricide, ovicide, herbicide, fungicide, viricide, nematicide, and nematistatic, Preferably the plant protection product may be an insecticide and/or a fungicide. Further preferably, the plant protection product may be a nematicide and/or a nematistatic.

In another preferred embodiment of the disclosure, the agricultural composition of this disclosure is provided as an adjuvant, soil conditioner, biostimulant, seed treatment means, fertilizer, insect growth regulator, plant regulator and/or an elicitor.

In a certain example embodiment of the first aspect of this disclosure there is provided an agricultural composition comprising: lauryl lactyl lactate and/or lauryl lactate and/or myristyl lactate and/or cetyl lactate and/or combinations of the aforementioned; and octan-2-ol; and glycerin; and a polyoxyethylene sorbitan monolaurate.

The agricultural composition may further include at least one of the carboxylic acid, plant hormone, secondary metabolite, microorganism, binder, anionic surfactant, and diluent as described according to the first aspect of the disclosure herein above.

In certain examples of the embodiment the secondary metabolite is salicylic acid and/or itaconic acid.

In accordance with a second aspect of this disclosure there is provided an agricultural composition being a carrier composition comprising:
a (C₂-C₂₆) alkyl lactate and/or derivate thereof as described in the first aspect of this disclosure;
a (C₂—. C₂₂) alcohol as described in the first aspect of this disclosure;
a humectant as described in the first aspect of this disclosure;
a non-ionic and/or an anionic surfactant as described in the first aspect of this disclosure; and
a binder as described in the first aspect of this disclosure.

The (C₂-C₂₆) alkyl lactate may be a (C₁₀-C₂₂) alkyl lactate and/or derivative thereof. The various elements of the carrier composition including the (C₁₀-C₂₂) alkyl lactate and/or derivate thereof, the (C₂-C₂₂) alcohol, the humectant; the non-ionic and/or an anionic surfactant and the binder, may interact chemico-physically to provide an aggregate or stereoscopic structure with sufficient stability to define a syrup and/or gel as an independent molecular species having physico-chemical properties distinct from its individual elements. Chemical interactions experienced among the various elements include at least one of, but not limited to, the following group of interactions: ionic, ion-dipole, covalent, hydrogen bonding, dipole-dipole, van der Waals, dipole-induced-dipole, London dispersion, π-π interactions, cation-π interactions and anion-π interactions. A chemical bond is formed between two atoms or groups of atoms from the various elements such that the forces acting between them are such as to lead to the formation of an aggregate or stereoscopic structure with sufficient stability to define the syrup and/or gel as an independent molecular species have physico-chemical properties distinct from its individual elements.

The carrier composition may further comprise a diluent. The diluent may be water and/or a co-solvent.

The carrier composition may further comprise an additive as described in the first aspect of this disclosure.

The carrier composition may be provided as a syrup and/or as a gel.

The carrier composition may be provided as an adjuvant for tank mixture, an adjuvant for seed treatment, as an in-can additive for plant protection products, as an in-can additive for fertilizers, as an in-can additive for soil conditioner, as an in-can additive for biostimulants, as an in-can for seed treatment products, as a soil conditioner product for an in-furrow application, among others agricultural uses.

The carrier composition may be loaded with an active ingredient and/or a biocontrol agent and/or fertilizer agent and/or biostimulant agent and/or an elicitor agent and/or a plant growth regulator and/or an insect repellant, therein providing a loaded agricultural carrier composition.

The biocontrol agent may include a carboxylic acid, a plant hormone, a secondary metabolite, and/or a microorganism.

The active ingredient may be a plant protection product. The plant protection product may include at least one of, but not limited to, the group comprising: insecticide, pesticide, miticide, acaricide, ovicide, herbicide, fungicide, viricide, nematicide, nematistatic, and insect growth regulator.

The biocontrol agent may include a microorganism as described in the first aspect of this disclosure and/or a plant hormone as described in the first aspect of this disclosure and/or a carboxylic acid as described in the first aspect of this disclosure and/or a secondary metabolite as described in the first aspect of the disclosure.

In a preferred embodiment of the agricultural carrier composition the (C₂-C₂₆) alkyl lactate may be a (C₁₀-C₂₂) alkyl lactate and/or derivate thereof may be present in an amount of between about 5 wt. % to about 50 wt. % of the total wt. % of a formulated agricultural carrier composition. Preferably, the (C₁₀-C₂₂) alkyl lactate and/or derivate thereof may be present in an amount of between about 7 wt. % to about 35 wt. % of the total wt. % of a formulated carrier agricultural composition, further preferably the (C₁₀-C₂₂) alkyl lactate and/or derivate thereof may be present in an amount of between about 10 wt. % to about 20 wt. % of the total wt. % of a formulated agricultural carrier composition. It is to be understood that the ranges herein include any minimum value or maximum value within said range, and includes any value there between.

In a preferred embodiment of the agricultural carrier composition the (C₂-C₂₂) alcohol may be present in an amount of between about 0.1 wt. % to about 20 wt. % of the total wt. % of a formulated agricultural carrier composition. Preferably, the (C₂-C₂₂) alcohol may be present in an amount of between about 0.5 wt. % to about 10 wt. % of the total wt. % of a formulated agricultural carrier composition, further preferably the (C₂-C₂₂) alcohol may be present in an amount of between about 1 wt. % to about 5 wt. % of the total wt. % of a formulated agricultural carrier composition. It is to be understood that the ranges herein include any minimum value or maximum value within said range, and includes any value there between.

In a preferred embodiment of the agricultural carrier composition the humectant may be present in an amount of between about 1 wt. % to about 30 wt. % of the total wt. % of a formulated agricultural carrier composition. Preferably, the humectant may be present in an amount of between about 5 wt. % to about 20 wt. % of the total wt. % of a formulated agricultural carrier composition, further preferably the humectant may be present in an amount of between about 7 wt. % to about 15 wt. % of the total wt. % of a formulated agricultural carrier composition. It is to be understood that the ranges herein include any minimum value or maximum value within said range, and includes any value there between.

In a preferred embodiment of the agricultural carrier composition the non-ionic and/or an anionic surfactant may be present in an amount of between about 1 wt. % to about 50 wt. % of the total wt. % of a formulated agricultural carrier composition. Preferably, the non-ionic and/or an anionic surfactant may be present in an amount of between about 5 wt. % to about 30 wt. % of the total wt. % of a formulated agricultural carrier composition, further preferably the non-ionic and/or an anionic surfactant may be present in an amount of between about 10 wt. % to about 20 wt. % of the total wt. % of a formulated agricultural carrier composition. It is to be understood that the ranges herein include any minimum value or maximum value within said range, and includes any value there between.

In a preferred example embodiment, the agricultural carrier composition includes only the nonionic surfactant to the exclusion of the anionic surfactant, and wherein the nonionic surfactant may be present in an amount of between about 1 wt. % to about 50 wt. % of the total wt. % of a formulated agricultural carrier composition. Preferably, the non-ionic surfactant may be present in an amount of between about 5 wt. % to about 30 wt. % of the total wt. % of a formulated agricultural carrier composition, further preferably the non-ionic surfactant may be present in an amount of between about 10 wt. % to about 20 wt. % of the total wt. % of a formulated agricultural carrier composition. It is to be understood that the ranges herein include any minimum value or maximum value within said range, and includes any value there between.

In a preferred embodiment of the agricultural carrier composition the binder may be present in an amount of between about 0.1 wt. % to about 20 wt. % of the total wt. % of a formulated agricultural carrier composition. Preferably, the binder may be present in an amount of between about 1 wt. % to about 15 wt. % of the total wt. % of a formulated agricultural carrier composition, further preferably the binder may be present in an amount of between about 2 wt. % to about 10 wt. % of the total wt. % of a formulated agricultural carrier composition. It is to be understood that the ranges herein include any minimum value or maximum value within said range, and includes any value there between.

In a preferred embodiment of the agricultural carrier composition the diluent may be present in an amount of between about 1 wt. % to about 80 wt. % of the total wt. % of a formulated agricultural carrier composition. Preferably, the diluent may be present in an amount of between about 10 wt. % to about 50 wt. % of the total wt. % of a formulated agricultural carrier composition, further preferably the diluent may be present in an amount of between about 20 wt. % to about 30 wt. % of the total wt. % of a formulated agricultural carrier composition. It is to be understood that the ranges herein include any minimum value or maximum value within said range, and includes any value there between.

In a preferred embodiment of the agricultural carrier composition is loaded with carboxylic acid which may be present in an amount of between about 0.1 wt. % to about 20 wt. % of the total wt. % of a formulated loaded agricultural carrier composition. Preferably, the carboxylic acid may be present in an amount of between about 0.5 wt. % to about 10 wt. % of the total wt. % of a formulated loaded agricultural carrier composition, further preferably the carboxylic acid may be present in an amount of between about 0.5 wt. % to about 5 wt. % of the total wt. % of a formulated loaded agricultural carrier composition. It is to be understood that the ranges herein include any minimum value or maximum value within said range, and includes any value there between.

In a preferred embodiment of the agricultural carrier composition is loaded with plant hormone which may be present in an amount of between about 0.1 wt. % to about 20 wt. % of the total wt. % of a formulated loaded agricultural carrier composition. Preferably, the plant hormone may be present in an amount of between about 0.5 wt. % to about 10 wt. % of the total wt. % of a formulated loaded agricultural carrier composition, further preferably the plant hormone may be present in an amount of between about 0.5 wt. % to about 5 wt. % of the total wt. % of a formulated loaded agricultural carrier composition. It is to be understood that the ranges herein include any minimum value or maximum value within said range, and includes any value there between.

In a preferred embodiment of the agricultural carrier composition is loaded with the secondary metabolite which may be present in an amount of between about 0.1 wt. % to about 20 wt. % of the total wt. % of the formulated loaded agricultural carrier composition. Preferably, the secondary metabolite may be present in an amount of between about 0.5 wt. % to about 10 wt. % of the total wt. % of the formulated loaded agricultural carrier composition, further preferably the secondary metabolite may be present in an amount of between about 0.5 wt. % to about 5 wt. % of the total wt. % of the formulated loaded agricultural carrier composition. It is to be understood that the ranges herein include any minimum value or maximum value within said range, and includes any value there between.

In a preferred embodiment of the agricultural carrier composition is loaded with the microorganism may which be present in an amount of between about 1 wt. % to about 70 wt. % of the total wt. % of a formulated loaded agricultural carrier composition. Preferably, the microorganism may be present in an amount of between about 10 wt. % to about 50 wt. % of the total wt. % of a formulated loaded agricultural carrier composition, further preferably the microorganism may be present in an amount of between about 25 wt. % to about 35 wt. % of the total wt. % of a formulated loaded agricultural carrier composition. It is to be understood that the ranges herein include any minimum value or maximum value within said range, and includes any value there between. It is further to be understood that microorganisms may be formulated in a growth medium and that the percentages may represent dry weight percentages and/or formulated wet weight percentages including the growth medium.

In a preferred embodiment of the agricultural carrier composition (loaded or unloaded), the additive may be present in an amount of between about 0.1 wt. % to about 20 wt. % of the total wt. % of a formulated agricultural carrier composition. Preferably, the additive may be present in an amount of between about 0.5 wt. % to about 15 wt. % of the total wt. % of a formulated agricultural composition, further preferably the additive may be present in an amount of between about 1 wt. % to about 10 wt. % of the total wt. % of a formulated agricultural carrier composition. It is to be understood that the ranges herein include any minimum value or maximum value within said range, and includes any value there between.

Additionally, and/or optionally, the agricultural carrier composition (loaded or unloaded) may further include at least one of, but not limited to, the group comprising: co-solvent, and other additives. The aforementioned may be included to adapt to the desired use as in-can additive, or as a final commercial product.

It is to be understood that the carrier composition can be applied mixed in-can with plant protection products, or it can be applied in tank mixtures with plant protection products or it can be applied next to plant protection products in in-furrow applications to bolster or improve performance of the plant protection product, to accelerate the desirable results of plant protection product, to increase the plant response to the plant protection product against the pest or the disease under controlling.

The compositions according to the first and/or second aspects of this disclosure may be provided as at least one of, but not limited to, the group comprising: plant protection products, adjuvants, soil conditioners, biostimulants, seed treatment means, fertilizers, insect growth regulators, plant growth regulators, and elicitors.

In preferred embodiments of the compositions according to the first and/or second aspects of this disclosure may be plant protection products including but not limited to insecticides, pesticides, miticides, acaricides, ovicides, herbicides, fungicides, viricides, and nematicides.

In accordance with a third aspect of this disclosure there is provided a method of manufacturing the agricultural composition of the first aspect, the method comprising the following steps:
providing together the (C₂-C₂₆) alkyl lactate and/or derivate thereof, the (C₂-C₂₂) alcohol, the humectant; and the non-ionic and/or an anionic surfactant so as to facilitate chemico-physical interaction resulting in an aggregate or stereoscopic structure with sufficient stability which defines a syrup and/or gel.

The syrup and/or gel is an independent molecular species having physico-chemical properties distinct from its individual elements. The syrup and/or gel is facilitated by chemical interactions experienced among the various elements include at least one of, but not limited to, the following group of interactions: ionic, ion-dipole, covalent, hydrogen bonding, dipole-dipole, van der Waals, dipole-induced-dipole, London dispersion, π-π interactions, cation-π interactions and anion-π interactions. A chemical bond is formed between two atoms or groups of atoms from the various elements such that the forces acting between them are such as to lead to the formation of an aggregate or stereoscopic structure with sufficient stability to define the syrup and/or gel as an independent molecular species have physico-chemical properties distinct from its individual elements.

The method may include the additional step of providing carboxylic acid and/or plant hormone and/or secondary metabolite before and/or after the syrup and/or gel has formed.

The method may include the additional step of providing microorganisms before and/or after the syrup and/or gel has formed.

The method may include the additional step of providing a plant protection product before and/or after the syrup and/or gel has formed.

The method may include the additional step of providing binder before and/or after the syrup and/or gel has formed.

The method may include the additional step of providing water or/and a co-solvent before and/or after the syrup and/or gel has formed.

In accordance with a fourth aspect of this disclosure there is provided a method of manufacturing the carrier composition of the second aspect, the method comprising the following steps:
providing together the (C₂-C₂₆) alkyl lactate and/or derivate thereof, the (C₂-C₂₂) alcohol, the humectant; the non-ionic and/or an anionic surfactant and the binder so as to facilitate chemico-physical interaction resulting in an aggregate or stereoscopic structure with sufficient stability which defines a syrup and/or gel.

The syrup and/or gel is an independent molecular species having physico-chemical properties distinct from its individual elements. The syrup and/or gel is facilitated by chemical interactions experienced among the various elements include at least one of, but not limited to, the following group of interactions: ionic, ion-dipole, covalent, hydrogen bonding, dipole-dipole, van der Waals, dipole-induced-dipole, London dispersion, π-π interactions, cation-π interactions and anion-π interactions. A chemical bond is formed between two atoms or groups of atoms from the various elements such that the forces acting between them are such as to lead to the formation of an aggregate or stereoscopic structure with sufficient stability to define the syrup and/or gel as an independent molecular species have physico-chemical properties distinct from its individual elements.

The method may include the additional step of providing water and/or other co-solvent before and/or after the syrup and/or gel has formed.

The method may include the additional step of providing carboxylic acid and/or plant hormone and/or secondary metabolite and/or a microorganism and/or a biocontrol agent and/or a plant protection product before and/or after the syrup and/or gel has formed, therein providing for a loaded agricultural carrier composition.

There is further provided for an agricultural composition according to the first aspect and/or the carrier composition according to the second aspect and/or a method of manufacturing according to the third aspect, and/or a method of manufacturing according to a fourth aspect, all substantially as herein described, illustrated and/or exemplified with reference to any one of the figures and/or examples hereunder.

### BRIEF DESCRIPTION OF THE DRAWINGS

Embodiments of the disclosure will be described below by way of example only and with reference to the accompanying drawings in which:

FIG. 1 shows nematicidal effect of select bacteria when applied as standalone or in mixture with unloaded carrier compositions (UCC) according to this disclosure;

FIG. 2 shows that loading of secondary metabolites inside the UCC has improved overall efficacy when compared to UCC on its own as a nematicide;

FIG. 3 shows a preferred embodiment of the loaded carrier composition (pLCC also referred to as OR-501) according to this disclosure displaying superior nematicidal effects when compared to a commercially available product; and

FIG. 4 shows a number of nematode eggs and second stage juvenile nematodes per gram of roots after potted field trials utilizing the loaded carrier composition (pLCC also referred to as OR-501) according to this disclosure.

FIG. 5 shows a bar plot showing mean (±SEM) mortality of Pratylenchus penetrans in response to different tested compositions—complementary nematicidal lab trials—Portugal.

FIG. 6 shows the percentage of mites that were dead 24 hours after treatment application was made complementary insecticidal lab trials-South Africa.

FIG. 7 shows the percentage of mites that were dead 48 hours after treatment application was made complementary insecticidal lab trials-South Africa.

FIG. 8 shows the bar plot of the root galling severity assessed visually according to a scale 0-10 (0: Complete and healthy root system, no infection—10: All roots severely knotted, no root system and plants usually dead). Nematicide field trial—Spain.

FIG. 9 shows the bar plot of the number of J2/100 cm3 of soil in the different treatments. Nematicide field trial—Spain.

FIG. 10 shows the bar plot of the yield/plot (in Ton/ha) of the different treatment recorded at the end of the trial. Nematicide field trial—Spain.

FIG. 11 shows the bar plot of the average fruit weight (g/fruit) of the different treatment recorded at the end of the trial. Nematicide field trial-Spain.

FIG. 12 shows the bar plot of the number of marketable fruits (gram/fruit) of the different treatment recorded at the end of the trial. Nematicide field trial—Spain

FIG. 13 shows bar plot of the data summary of healthy and infected melons, healthy and infected roots, percentage of healthy and infected melons and roots per different treatment to melon controlling Meloidogyne incognita-data was recorded at the end of the trial during the harvest. Nematicide field trial in commercial greenhouse-Shandong-China.

FIG. 14 shows the picture of healthy and infected roots and exemplars of a healthy and an infected melon after harvest. The harvested melons and roots are referred to the treatment using the composition ORO-501 [also named OR-501 or B-017-001 (Bacillus amyloliquefaciens 20%+UCCa 80%)] versus standard treatment to melon controlling Meloidogyne incognita-Nematicide field trial in commercial greenhouse-Shandong-China.

### DETAILED DESCRIPTION OF THE DISCLOSURE

The Summary of the disclosure, including all aspects of the disclosure is repeated hereunder by way of reference only to avoid repetition. Specific, but non-limiting embodiments of the disclosure will now be described.

In accordance with a first aspect of this disclosure there is provided an agricultural composition comprising: an alkyl lactate, and/or derivate thereof, a (C₂-C₂₂) alcohol, a humectant and a non-ionic and/or an anionic surfactant.

Typically, the (C₂-C₂₆) alkyl lactate is a (C₁₀-C₂₂) alkyl lactate and/or derivative thereof.

The (C₂-C₂₆) alkyl lactate and/or derivate thereof may be at least one selected from, but not limited to, the group comprising: ethyl lactate, propyl lactate, butyl lactate, pentyl lactate, hexyl lactate, heptyl lactate, octyl lactate, nonyl lactate, decyl lactate, undecyl lactate, dodecyl lactate, tridecyl lactate, tetradecyl lactate, pentadecyl lactate, hexadecyl lactate, heptadecyl lactate, octadecyl lactate, nonadecyl lactate, eicosyl lactate, heneicosyl lactate, and docosyl lactate, and/or derivatives of the aforementioned.

The alkyl lactate may be a (C₁₀-C₂₂) alkyl lactate or any combination and/or derivative of the aforementioned and combinations thereof. Preferably the (C₁₀-C₂₂) alkyl lactate and/or derivate thereof may be at least one selected from, but not limited to, the following group comprising: a lauryl lactate (dodecyl lactate), a myristyl lactate (tetradecyl lactate), a cetyl lactate (hexadecyl lactate), and lauryl lactyl lactate.

The (C₂-C₂₆) alkyl lactate and/or derivative thereof may be a (C₂-C₂₆) alkyl lactyl lactate and/or derivative thereof

The (C₂-C₂₆) alkyl lactyl lactate and/or derivate thereof may be at least one selected from, but not limited to, the group comprising: ethyl lactyl lactate, propyl lactyl lactate, butyl lactyl lactate, pentyl lactyl lactate, hexyl lactyl lactate, heptyl lactyl lactate, octyl lactyl lactate, nonyl lactyl lactate, decyl lactyl lactate, undecyl lactyl lactate, dodecyl lactyl lactate, tridecyl lactyl lactate, tetradecyl lactyl lactate, pentadecyl lactyl lactate, hexadecyl lactyl lactate, heptadecyl lactyl lactate, octadecyl lactyl lactate, nonadecyl lactyl lactate, eicosyl lactyl lactate and/or derivatives of the aforementioned.

The (C₂-C₂₆) alkyl lactyl lactate and/or derivative thereof may include a (C₁₀-C₂₂) alkyl lactyl lactate and/or derivative thereof. Preferably the (C₁₀-C₂₀) alkyl lactyl lactate may be lauryl lactyl lactate.

Typically, the (C₂-C₂₂) alcohol includes monoalcohols, diols, triol, tetraol, pentaols, hextaols, alkyl alcohols, alkenols, alkynols, primary-, secondary-, tertiary-, aromatic-, cyclic-, alicyclic-, unbranched-, branched-, saturated-, and unsaturated alcohols, and/or any combination and/or derivative of the aforementioned. In certain embodiments the (C₂-C₂₂) alcohol is at least one selected from, but not limited to, the group comprising: ethanol, propanol, propan-2-ol, butanol, butan-2-ol, pentanol, pentan-2-ol, pentan-3-ol, hexanol, hexan-2-ol, hexan-3-ol, heptanol, heptan-2-ol, heptan-3-ol, heptan-4-ol, octanol, octan-2-ol, octanol-3-ol, octan-4-ol, 2-ethylhexanol, nonanol, nonan-2-ol, nonan-3-ol, nonan-4-ol, nonan-5-ol, decanol, decan-2-ol, decan-3-ol, decan-4-ol, decan-5-ol, undecanol, undecane-2-ol, undecane-3-ol, undecane-4-ol, undecane-5-ol, undecane-6-ol, dodecanol, dodecan-2-ol, dodecan-3-ol, dodecan-4-ol, dodecan-5-ol, dodecan-6-ol, tridecanol, tridecan-2-ol, tridecan-3-ol, tridecan-4-ol, tridecan-5-ol, tridecan-6-ol, tridecan-7-ol, tetradecanol, tretradecan-2-ol, tetradecan-3-ol, tetradecan-4-ol, tetrdecaan-5-ol, tetradecan-6-ol, tetradecan-7-ol, pentadecanol, pentadecan-2-ol, pentadecan-3-ol, pentadecan-4-ol, pentadecan-5-ol, pentadecan-6-ol, pentadecan-7-ol, pentadecan-8-ol, hexadecanol, hexadecan-2-ol, hexadecan-3-ol, hexadecan-4-ol, hexadecan-5-ol, hexadecan-6-ol, hexadecan-7-ol, hexadecan-8-ol, heptadecanol, heptadecan-2-ol, heptadecan-3-ol, heptadecan-4-ol, heptadecan-5-ol, heptadecan-6-ol, heptadecan-7-ol, heptadecan-8-ol, heptadecan-9-ol, octadecanol, octadecan-2-ol, octadecan-3-ol, octadecan-4-ol, octadecan-5-ol, octadecan-6-ol, octadecan-7-ol, octadecan-8-ol, octadecan-9-ol, nonadecanol, nonadecan-2-ol, nonadecan-3-ol, nonadecan-4-ol, nonadecan-5-ol, nonadecan-6-ol, nonadecan-7-ol, nonadecan-8-ol, nonadecan-9-ol, nonadecan-10-ol, eicosanol, eicosan-2-ol, eicosan-3-ol, eicosan-4-ol, eicosan-5-ol, eicosan-6-ol, eicosan-7-ol, eicosan-8-ol, eicosan-9-ol, eicosan-10-ol, heneicosanol, heneicosan-2-ol, heneicosan-3-ol, heneicosan-4-ol, heneicosan-5-ol, heneicosan-6-ol, heneicosan-7-ol, heneicosan-8-ol, heneicosan-9-ol, heneicosan-10-ol, heneicosan-11-ol, docosanol, docosan-2-ol, docosan-3-ol, docosan-4-ol, docosan-5-ol, docosan-6-ol, docosan-7-ol, docosan-8-ol, docosan-9-ol, docosan-10-ol and docosan-11-ol, and/or any combination and/or derivative of the aforementioned.

In a preferred example embodiment of the disclosure the (C₂-C₂₂) alcohol is octan-2-ol.

Typically, the humectant is at least one selected from, but not limited to, the group comprising: glycerin, glycerol or alkyl ethers thereof, (C₂-C₃₀) alkene glycol, propylene glycol, polypropylene glycol or alkyl ethers thereof, sorbitol, mannitol, dulcitol and/or polyols, alkyl glycoside, straight chain (C₄-C₁₈) alkyl(poly)glycosides, branched chain (C₄-C₁₈) alkyl(poly)glycosides, straight chain (C₄-C₁₈) alkyl(poly)glucosides, branched chain (C₄-C₁₈) alkyl(poly)glucosides, aryl glycosides, and/or any combination and/or derivative of the aforementioned.

In a preferred example embodiment of the disclosure the humectant is glycerin.

Typically, the non-ionic may be at least one selected from, but not limited to, the group comprising: natural and/or synthetic (C₈-C₂₂) alkoxylated fatty alcohols, (C₈-C₂₂) ethoxylated fatty alcohols, (C₈-C₂₂) propoxylated fatty alcohols, (C₈-C₂₂) ethoxylated and propoxylated fatty alcohols, (C₆-C₂₂) alkoxylated fatty acids, (C₆-C₂₂) ethoxylated fatty acids, (C₆-C₂₂) propoxylated fatty acids, EO-PO (C₆-C₂₂) ethoxylated and propoxylated fatty acids, straight chain (C₄-C₁₀) alkyl(poly)glycosides, branched chain (C₄-C₁₀) alkyl(poly)glycosides; and alkoxylated sorbitan fatty esters, alkoxylated sorbitol fatty esters, ethoxylated sorbitan fatty esters, ethoxylated sorbitol fatty esters, polyoxyethylene sorbitan monolaurate, polyoxyethylene sorbitan monopalmitate, polyoxyethylene sorbitan monostearate, polyoxyethylene sorbitan monolaurate, polyoxyethylene glycol monolaurate, polyoxyethylene glycol sorbitan monopalmitate, polyoxyethylene glycol sorbitan monostearate, N-substituted fatty acid amides, fatty acid glucamides, fatty acid alkanolamides, amine oxides, polymeric surfactants, copolymers of vinylpyrrolidone, vinylalcohols, or vinylacetate, alkoxylated fatty acid esters, glycerol esters or monoglycerides and/or any combination and/or derivative of the aforementioned.

In a preferred example embodiment of the disclosure the nonionic surfactant is polyoxyethylene sorbitan monolaurate.

Typically, the anionic is at least one selected from, but not limited to, the group comprising: (C₆-C₁₈) alkyl benzene sulfonic acid salts, calcium dodecylbenzene sulfonate, sodium dodecylbenzene sulfonate, amine (C₆-C₁₈) alkyl benzene sulfonate, triethanolamine dodecylbenzene sulfonates, (C₆-C₁₈) alkyl ether sulfates, (C₆-C₁₈) alkyl ethoxylated ether sulfates, (C₆-C₁₈) alkyl sulfates, lauryl ether polyethoxylated sodium sulfate, lignosulfonates, phenylsulfonates, naphthalenesulfonates, dibutylnaphthalenesulfonates, (C₆-C₁₈) alkyl phosphate esters, (C₆-C₁₈) alkoxylated sulfates, xylene sulfonate salts, cumene sulfonate salts, lignosulfonates, phenylsulfonates, naphthalenesulfonates, dibutylnaphthalenesulfonates, alkyl polyglycol ether phosphates, polyarylphenyl ether phosphates, alkyl-sulfosuccinates, olefin sulfonates, condensation products of sulfonated naphthalenes with formaldehyde, condensation products of sulfonated naphthalenes with formaldehyde and phenol and optionally urea and condensation products of phenolsulfonic acid with formaldehyde and urea, (C₆-C₁₈) alkoxylated phosphate esters, alkyl phosphates, alkyl aryl phosphates, for example tristyryl phosphates, and polycarboxylates such as for example polyacrylates, aryl glycosides, maleic anhydride/olefin copolymers, including the alkali metal, alkaline earth, ammonium and amine salts of the aforesaid substances and/or any combination and/or derivative of the aforementioned and combinations thereof.

In a preferred example embodiment of the disclosure the anionic surfactant is a lignosulfonate.

Typically, the agricultural composition further comprises a carboxylic acid and/or a salt thereof. Preferably, the carboxylic acid may be a (C₂-C₂₂) carboxylic acid and/or a salt thereof as described in the Summary.

Additionally, and/or alternatively, the agricultural composition further comprises a plant hormone. The plant hormone is at least one selected from, but not limited to, the group comprising: abscisic acid, auxins, brassinosteroids, cytokinins, ethylene, gibberellins, jasmonate, jasmonic acid, salicylic acid, strigolactones, polyamines, nitric acid, triacontanol, and derivatives thereof.

In a preferred example embodiment of the disclosure the plant hormone is salicylic acid.

Additionally, and/or alternatively, the agricultural composition may further comprise a secondary metabolite. The secondary metabolite may be a secondary plant, bacterial or fungal metabolite. Secondary plant metabolites may include at least one, but not limited to, the group comprising: phenolics, alkaloids, saponins, terpenes, lipids, carbohydrates and glucosinolates. In a certain embodiment of the disclosure the secondary plant metabolite is salicylic acid. Secondary bacterial metabolites may include at least one, but not limited to, the group comprising: polyketides, nonribosomal peptides, ribosomal peptides, glucosides and alkaloids. Secondary fungal metabolites may include at least one, but not limited to, the group comprising: itaconic acid, polyketides, nonribosomal peptides and terpenes. In a certain embodiment of the disclosure the secondary metabolite may be salicylic acid and/or itaconic acid.

Typically, the agricultural composition further comprises a microorganism. In a certain embodiment of the disclosure the microorganism may be a spore forming microorganism.

The agricultural composition may further comprise pheromones, amino acids, peptides, RNA, mRNA, siRNA, DNA, protozoa, oomycete and/or yeast.

The microorganism may be selected from, but not limited to, the group: viruses, bacteria and fungi.

Typically, viruses may include at least one selected from, but not limited to, any one in the family of the group comprising: baculoviruses, cypoviruses, and densoviruses.

Typically, viruses may include at least one baculovirus selected from, but not limited to, Cydia pomonella granulovirus and Cryptophlebia peltastica nucleopolyhedrovirus.

Typically, bacteria may include at least one selected from, but not limited to, any of the species in the genera group comprising: Agrobacterium, Bacillus, Burkholderia, Paenibacillus, Pseudomonas, Rhanella, Rhizobium, Saccharopolyspora, Serratia and Streptomyces.

In a certain preferred embodiment the bacteria may be at least one selected from, but not limited to, the group comprising: Bacillus subtilis sp., Bacillus amyloliquefaciens sp., Bacillus firmus sp., Bacillus popilliae sp., Bacillus lontimorbus sp., Bacillus nakamuri sp., Bacillus pumilus sp., Bacillus sphaericus sp., Bacillus thuringiensis sp., Bacillus simplex sp., Bacillus licheniformis sp., Bacillus fastidiosus sp., Bacillus megaterium sp., Bacillus thuringiensis kurstaki sp., Bacillus thuringiensis israelensis sp., Bacillus thuringiensis aizawai sp., Bacillus thuringiensis aegyptii sp., Bacillus velezensis sp., Pseudomonas chlororaphis sp., Pseudomonas fluorescens sp., Pseudomonas protegeans sp., Pseudomonas sp., Streptomyces lydicus sp., Streptomyces sp., Lysobacter sp., and/or any combination thereof.

Fungi may include mycorrhiza. Typically, fungi may include at least one selected from, but not limited to, any of the species in the genera group comprising: Alternaria, Aerobasidium, Ampelomyces, Aschersonia, Aspergillus, Beauveria, Candida, Clonostachys, Coniothyrium, Cordyceps, Entomophaga, Fusarium, Glomus, Hirustella, Isaria, Lecanicillium, Metarhizium, Paecilomyces, Penicillium, Pichia, Pseudozyma, Saccaharomyces, Talaromyces, Trichoderma, and Verticillium.

In certain embodiments the fungi may be at least one selected from, but not limited to, the group comprising: Aerobasidium pullulans sp., Ampelomyces Quisqualis sp., Aschersonia aleyrodis sp., Aspergillus flavus sp., Beauveria bassiana sp., Beauveria brongniartii sp., Candida oleophila sp., Clonostachys rosea sp., Coniothyrium minitans sp., Cordyceps fumosorosea sp., Entomophaga maimaiga sp., Hirustella thompsonii sp., Isaria fumosorosea sp., Metarhizium anisopliae sp., Paecilomyces fumosoroseus sp., Paecilomyces lilacinus sp., Pseudozyma flocculosa sp., Saccharomyces cerevisiae sp., Trichoderma asperellum sp., Trichoderma viride sp., Trichoderma reesei sp., Trichoderma atroviride sp., Trichoderma gamsii sp., Trichoderma harzianum sp., Trichoderma polysporum sp., Trichoderma paucisporum sp., Trichoderma afroharzianu sp., Trichoderma yunnaense sp., Trichoderma evansii sp., Trichoderma hamatum sp., Trichoderma atrobrunneum sp. and Verticillium alboatrum sp.

Typically, the oomycete may be of the genus Lagenidium and/or Pythium, particularly Lagenidium giganteum sp. and/or Pythium insidiosum.

In a preferred example embodiment of the disclosure the microorganism is a bacteria from the genera Bacillus and/or Pseudomonas. In a certain preferred embodiment the bacteria may be Bacillus subtilis sp., Bacillus amyloliquefaciens sp., Bacillus firmus sp., Bacillus thuringiensis sp., Bacillus simplex sp., Bacillus licheniformis sp., Bacillus megaterium sp., Bacillus velezensis sp., and/or Pseudomonas fluorescens sp., Pseudomonas protegeans sp., the species in an isolated standalone form or combinations of species or strains thereof.

In certain embodiments the fungi may be Tricoderma harzianum sp., Tricoderma asperellum sp., Trichoderma viride sp., Trichoderma reesei sp., and/or Paecilomyces lilacinus sp, wherein the species may be in an isolated standalone form or combinations of species thereof.

In certain embodiments of the disclosure, the agricultural composition further comprises a binder. The binder may be selected from, but not limited to, the group comprising: polysaccharides, sucrose, fructose, saccharose, pectin, amylopectin, glycosides, glucosides, (C₁-C₃₀) alkyl glycosides, (C₁-C₃₀) alkyl glucosides, gelatin, starch, modified starch, alginates, modified alginates, natural gums, modified gum, gar gums, rosin, tall oil rich in rosin, (C₁-C₃₀) alkyl cellulose, salts of (C₁-C₃₀) alkyl cellulose, carboxymethyl cellulose, salts of carboxymethyl cellulose, sodium carboxymethyl cellulose, microcrystalline cellulose, polyvinyl pyrrolidone, cross-linked polyvinylpyrrolidone, dimethylaminoethyl-methacrylate copolymer, PVP/hexadecene copolymer, (C₁-C₃₀) alkyl acrylates, methyl acrylate, butyl acrylate, ethyl acrylate, 2-ethylhexyl acrylate, poly acrylates, (C₁-C₃₀) alkyl aryl acrylates, and styrene derivatives, and combinations thereof.

In a preferred embodiment of the disclosure, the binder is styrene acrylic emulsion polymer.

In certain embodiments of the disclosure, the agricultural composition further comprises a diluent. The diluent may be water.

There is provided that the agricultural composition may further comprise an additive selected from, but not limited to, the group comprising: preservatives, clarifiers, anti-freezing agents, hydrotropes, stabilizers, antioxidants, acidifiers, chelates, complexing agents, dyes, rheology modifiers, antifoams, anti-drift, oil or other solvents, and combinations thereof.

In a preferred embodiment of the agricultural composition the (C₂-C₂₆) alkyl lactate, including a (C₁₀-C₂₀) alkyl lactate, and/or derivative thereof may be present in an amount of between about 5 wt. % to about 50 wt. % of the total wt. % of a formulated agricultural composition. It is to be understood that the ranges herein include any minimum value or maximum value within said range, and includes any value there between.

In a preferred embodiment of the agricultural composition the (C₂-C₂₂) alcohol may be present in an amount of between about 0.1 wt. % to about 20 wt. % of the total wt. % of a formulated agricultural composition. It is to be understood that the ranges herein include any minimum value or maximum value within said range, and includes any value there between.

In a preferred embodiment of the agricultural composition the humectant may be present in an amount of between about 1 wt. % to about 30 wt. % of the total wt. % of a formulated agricultural composition. It is to be understood that the ranges herein include any minimum value or maximum value within said range, and includes any value there between.

In a preferred embodiment of the agricultural composition the non-ionic and/or an anionic surfactant may be present in an amount of between about 1 wt. % to about 50 wt. % of the total wt. % of a formulated agricultural composition. It is to be understood that the ranges herein include any minimum value or maximum value within said range, and includes any value there between.

In a preferred example embodiment the agricultural composition includes only the nonionic surfactant to the exclusion of the anionic surfactant, and wherein the nonionic surfactant may be present in an amount of between about 1 wt. % to about 50 wt. % of the total wt. % of a formulated agricultural composition. It is to be understood that the ranges herein include any minimum value or maximum value within said range, and includes any value there between.

In a preferred embodiment of the agricultural composition the carboxylic acid may be present in an amount of between about 0.1 wt. % to about 20 wt. % of the total wt. % of a formulated agricultural composition. It is to be understood that the ranges herein include any minimum value or maximum value within said range, and includes any value there between.

In a preferred embodiment of the agricultural composition the plant hormone may be present in an amount of between about 0.1 wt. % to about 20 wt. % of the total wt. % of a formulated agricultural composition. It is to be understood that the ranges herein include any minimum value or maximum value within said range, and includes any value there between.

In a preferred embodiment of the agricultural carrier composition is loaded with the secondary metabolite which may be present in an amount of between about 0.1 wt. % to about 20 wt. % of the total wt. % of the formulated loaded agricultural composition. It is to be understood that the ranges herein include any minimum value or maximum value within said range, and includes any value there between.

In a preferred embodiment of the agricultural composition the microorganism may be present in an amount of between about 1 wt. % to about 70 wt. % of the total wt. % of a formulated agricultural composition. It is to be understood that the ranges herein include any minimum value or maximum value within said range, and includes any value there between. It is further to be understood that microorganisms may be formulated in a growth medium and that the percentages may represent dry weight percentages and/or formulated wet weight percentages including the growth medium.

In a preferred embodiment of the agricultural composition the binder may be present in an amount of between about 0.1 wt. % to about 20 wt. % of the total wt. % of a formulated agricultural composition. It is to be understood that the ranges herein include any minimum value or maximum value within said range, and includes any value there between.

In a preferred embodiment of the agricultural composition the additive may be present in an amount of between about 0.1 wt. % to about 20 wt. % of the total wt. % of a formulated agricultural composition. It is to be understood that the ranges herein include any minimum value or maximum value within said range, and includes any value there between.

In a preferred embodiment of the agricultural composition the diluent may be present in an amount of between about 1 wt. % to about 80 wt. % of the total wt. % of a formulated agricultural composition. It is to be understood that the ranges herein include any minimum value or maximum value within said range, and includes any value there between.

In a preferred example embodiment the agricultural composition comprises lauryl lactyl lactate, octan-2-ol, glycerin, and polyoxyethylene sorbitan monolaurate. The agricultural composition may further include at least one of the carboxylic acid, secondary plant metabolite, plant hormone, microorganism, binder and diluent as according to the first aspect of the disclosure herein above.

The agricultural composition may further comprise be at least one of, but not limited to, the group comprising: plant protection product, adjuvant, soil conditioner, biostimulant, seed treatment means and fertilizer.

In a preferred embodiment of the disclosure, the plant protection product may be an insecticide, pesticide, miticide, acaricide, ovicide, herbicide, fungicide, viricide, nematicide, and nematistatic, Further preferably, the plant protection product may be a nematicide and/or a nematistatic. In a preferred embodiment of the disclosure, the agricultural composition of this disclosure is provided as a plant protection product and may be an insecticide, pesticide, miticide, acaricide, ovicide, herbicide, fungicide, viricide, nematicide, and nematistatic, Preferably the plant protection product may be an insecticide and/or a fungicide. Further preferably, the plant protection product may be a nematicide and/or a nematistatic.

In another preferred embodiment of the disclosure, the agricultural composition of this disclosure is provided as an adjuvant, soil conditioner, biostimulant, seed treatment means, fertilizer, insect growth regulator, plant regulator and/or an elicitor.

In accordance with a second aspect of this disclosure there is provided an agricultural composition being a carrier composition comprising: an alkyl lactate and/or derivate thereof as described in the first aspect of this disclosure, a (C₂-C₂₂) alcohol as described in the first aspect of this disclosure, a humectant as described in the first aspect of this disclosure, a non-ionic and/or an anionic surfactant as described in the first aspect of this disclosure and a binder as described in the first aspect of this disclosure.

The carrier composition typically is provided as a syrup and/or as a gel.

The carrier composition typically further comprise a diluent. The diluent is typically water.

Optionally and/or additionally, the agricultural composition may further comprise an additional diluent, solvent, or a co-solvent. The diluent, solvent, or co-solvent is selected preferably from the group comprising: alcohols, ethers, esters, diesters, terpenes, glycols, alkyl glycols, glycol ether esters, tall oils, tall oil fatty esters, alkylated seed oil, nitrogen compounds, sulfur compounds, halogen hydrocarbons, and combinations thereof. The preferred solvents or co-solvent are alkyl glycols, glycol ether esters, alkyl lactates, propylene carbonate, tall oil fatty acid esters, alkylated seed oil, such as ethylated or butylated seed oils, and combinations thereof.

The carrier composition is typically loaded with an active ingredient and/or a biocontrol agent and/or fertilizer agent and/or biostimulant agent and/or an elicitor agent and/or a plant growth regulator and/or an insect repellant, therein providing a loaded agricultural carrier composition therein providing a loaded agricultural carrier composition.

It is to be understood that the loaded agricultural carrier composition may include a plurality of plant protection products such that in use providing a multipronged mode of action intervention in the treatment and/or control of plant pathogens.

The active ingredient is typically a plant protection product. The plant protection product may include at least one of, but not limited to, the group comprising: insecticide, pesticide, miticide, acaricide, ovicide, herbicide, fungicide, viricide, nematicide, and nematistatic.

The biocontrol agent may include a microorganism as described in the first aspect of this disclosure and/or a plant hormone as described in the first aspect of this disclosure and/or a carboxylic acid as described in the first aspect of this disclosure and/or a secondary metabolite as described in the first aspect of the disclosure.

When the carrier composition is loaded with an active ingredient and biocontrol agent, the Applicant provides for a multitiered approach at combatting pest control. As described above, a multitiered approach that concomitantly provides active ingredients and biocontrol agents to a plant or soil is fraught with difficulties.

The Applicant was surprised that the preferred embodiment of the loaded agricultural carrier composition wherein the biocontrol agents comprise a microorganism and a secondary plant metabolite, that microorganism and plant hormone were kept intact and/or uncompromised and/or stable when loaded into the carrier composition. This was particularly surprising where the microorganism is a bacterium and the secondary metabolite is salicylic acid and/or itaconic acid, since it is known in the art that the salicylic acid and/or itaconic acid destroys and/or impairs bacteria.

Without being limited to theory, the Applicant submits that the (C₁₀-C₂₂) alkyl lactate provides an effective solvent medium for the salicylic acid and/or itaconic acid whilst concomitantly providing an excellent delivery medium for the microorganism without impacting on the viability of said microorganism.

This unexpected and unique protective behavior showed by the unloaded agricultural composition brings to the loaded agricultural composition an unexpected improved shelf-life, even in room temperatures, and mainly when comparing with benchmarked products, allied with a consistent and improved viability of all microorganisms and embodiment compositions tested in this disclosure.

Without being limited to theory, the unloaded agricultural carrier composition hinders germination of microbial spores, therein extending shelf-life.

The unloaded agricultural carrier composition stops and/or prevents and/or slows spore forming microorganisms from germinating, wherein the unloaded agricultural carrier composition envelopes the spore forming microorganisms such that the spore forming microorganisms are dispersed within the unloaded agricultural carrier composition.

The unloaded agricultural carrier composition is typically provided as a gel having dispersed within it spore forming microorganisms. The unloaded agricultural carrier composition when loaded with spore forming microorganism provides the loaded agricultural carrier composition. Only after the loaded agricultural carrier composition is applied to soil, plants, roots, insects, or the like, will the spore forming microorganism egress away from the gel carrier composition and into a surrounding environment whereafter germination of the microorganism spores will take place.

Furthermore, as shown in the Examples below, the unloaded agricultural carrier composition in itself shows some initial antipathogenic activity. This is advantageous in that upon initial application to soil there is dual action, firstly initial antipathogenic activity of the unloaded agricultural carrier composition, and secondly (later), antipathogenic activity of the microbial (particularly after the spores germinate into an active state). Therefore, the loaded agricultural carrier composition provides for a two-pronged anti-pathogenic treatment regime over a prolonged period of time. This allows enhanced efficacy whilst reducing compaction on soil, and reducing water spray volumes, and reducing application intervals of plant protection products within a multilayered approach. This was surprising and unexpected.

Another unexpected and surprising behavior showed by the unloaded carrier composition was the capability to improve performance when the UCC is added to a tank mixture with microorganisms. This improved performance occurs when the microorganisms are spore forming (Bacillus sp. as an example) or also when they are non spore-forming species (Pseudomonas sp, as an example). It was observed in the Examples below when the UCC was added to the tank mixture with products from prior art and the performance with the prior art product plus the loaded agricultural carrier composition was consistency better than the performance of prior art product standalone.

In a preferred embodiment of the agricultural carrier composition the (C₁₀-C₂₂) alkyl lactate and/or derivate thereof may be present in an amount of between about 5 wt. % to about 50 wt. % of the total wt. % of a formulated agricultural carrier composition.

In a preferred embodiment of the agricultural carrier composition the (C₂-C₂₂) alcohol may be present in an amount of between about 0.1 wt. % to about 20 wt. % of the total wt. % of a formulated agricultural carrier composition.

In a preferred embodiment of the agricultural carrier composition the humectant may be present in an amount of between about 1 wt. % to about 30 wt. % of the total wt. % of a formulated agricultural carrier composition.

In a preferred embodiment of the agricultural carrier composition the non-ionic and/or an anionic surfactant may be present in an amount of between about 1 wt. % to about 50 wt. % of the total wt. % of a formulated agricultural carrier composition.

In a preferred example embodiment the agricultural carrier composition includes only the nonionic surfactant to the exclusion of the anionic surfactant, and wherein the nonionic surfactant may be present in an amount of between about 1 wt. % to about 50 wt. % of the total wt. % of a formulated agricultural carrier composition.

In a preferred embodiment of the agricultural carrier composition the binder may be present in an amount of between about 0.1 wt. % to about 20 wt. % of the total wt. % of a formulated agricultural carrier composition.

In a preferred embodiment of the agricultural carrier composition the diluent may be present in an amount of between about 1 wt. % to about 80 wt. % of the total wt. % of a formulated agricultural carrier composition.

In a preferred embodiment of the agricultural carrier composition is loaded with carboxylic acid which may be present in an amount of between about 0.1 wt. % to about 20 wt. % of the total wt. % of a formulated loaded agricultural carrier composition.

In a preferred embodiment of the agricultural carrier composition is loaded with plant hormone which may be present in an amount of between about 0.1 wt. % to about 20 wt. % of the total wt. % of a formulated loaded agricultural composition.

In a preferred embodiment of the agricultural carrier composition is loaded with the secondary metabolite which may be present in an amount of between about 0.1 wt. % to about 20 wt. % of the total wt. % of the formulated loaded agricultural composition.

In a preferred embodiment of the agricultural carrier composition is loaded with the microorganism may which be present in an amount of between about 1 wt. % to about 70 wt. % of the total wt. % of a formulated agricultural composition.

In a preferred embodiment of the agricultural carrier composition (loaded or unloaded), the additive may be present in an amount of between about 0.1 wt. % to about 20 wt. % of the total wt. % of a formulated agricultural carrier composition.

In a preferred example embodiment the agricultural carrier composition comprises lauryl lactyl lactate, octan-2-ol, glycerin, polyoxyethylene sorbitan monolaurate, and styrene acrylic polymer. The agricultural carrier composition may further include water and/or other co-solvent. The agricultural carrier composition is typically loaded with at least one of the carboxylic acid, plant hormone, microorganism, secondary metabolite, a plant protection product and/or a biocontrol agent, as according to the first and/or second aspect of the disclosure herein above.

The compositions according to the first and/or second aspects of this disclosure may be provided as at least one of, but not limited to, the group comprising: plant protection products, adjuvants, soil conditioners, biostimulants, seed treatment means, fertilizers, insect growth regulators, plant growth regulators, and elicitors.

The Applicant is investigating various methods of manufacturing the first and second aspects of the disclosure.

### Definitions of Certain Terms Used Throughout this Disclosure

The term “adjuvant” as used herein is a broad term, and is to be given its ordinary and customary meaning to a person of ordinary skill in the art (and is not to be limited to a special or customized meaning), and refers without limitation to an agent that modifies the effect of other agents and more particularly used to enhance the effectiveness of pesticides such as herbicides, insecticides, fungicides and other agents.

The term “stable” as used herein is a broad term, combined or related with the term “accelerated storage stability”, means that the formulation keep similar performance in terms of physical-chemical properties after samples be stored during 15 days in at least 3 conditions: room temperature (around 20° C.); cold temperature (0° C. or 5° C.); hot temperature (54° C.). Storage stability tests were conducted according to method CIPAC MT 46.

The term “stable” as used herein is a broad term, combined or related with the term “shelf-life”, means that the formulation keeps similar performance in terms of physical-chemical properties and microbial activity after samples be stored during a certain period of time at room temperature (around 23° C.+−3° C.) in a real storage stability test or also called shelf-life test.

The term “stable” as used herein is a broad term, combined or related with the term “emulsion”, and is to be given its ordinary and customary meaning to a person of ordinary skill in the art (and is not to be limited to a special or customized meaning), and refers without limitation to the emulsion stability, i.e. the ability of an emulsion to resist change in its properties over time so that the size of the droplets in emulsion does not change significantly with time, more specifically during the time of an application to the targets mixed with water, it is thus to be given its ordinary meaning that is customary to a person skilled in the art. Emulsion stability tests can be conducted according to method CIPAC MT 36.

The term “solvents” or “co-solvents” as used herein is a broad term, and is to be given its ordinary and customary meaning to a person of ordinary skill in the art (and is not to be limited to a special or customized meaning), and refers without limitation to compounds with some characteristics of solvency for other compounds or means, that can be polar or non-polar, linear or branched, cyclic or aliphatic, aprotic or amphiprotic, and that includes but is no limited to: alcohols, acids, amines, ethers, esters, diesters, ketones, acetates, terpenes, sulfoxides, phenols, glycols, alkyl glycols, glycol ether esters, paraffins, hydrocarbons, heterocyclics, aromatics, naphthenics, nitrogen compounds, sulfur compounds, halogen hydrocarbons, mixture or combination of solvents, among others.

Whenever a group is described as being “optionally substituted” that group may be unsubstituted or substituted with one or more of the indicated substituents. Likewise, when a group is described as being “unsubstituted or substituted” if substituted, the substituent(s) may be selected from one or more the indicated substituents. If no substituents are indicated, it is meant that the indicated “optionally substituted” or “substituted” group may be substituted with one or more group(s) individually and independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl) alkyl, hydroxy, protected hydroxyl, alkoxy, aryloxy, acyl, mercapto, alkylthio, 32rylthiol, cyano, halogen, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, sulfenyl, sulfinyl, sulfonyl, haloalkyl, haloalkoxy, trihalomethanesulfonyl, trihalomethanesulfonamido, an amino, a mono-substituted amino and a di-substituted amino group, and protected derivatives thereof.

The term “alkyl” as used herein is a broad term, and is to be given its ordinary and customary meaning to a person of ordinary skill in the art (and is not to be limited to a special or customized meaning), and refers without limitation to a straight chain or branched, acyclic or cyclic, unsaturated or saturated aliphatic hydrocarbon containing 1, 2, 3, 4, 5, 6, 7, 8, 9, 10, 11, 12, 13, 14, 15, 16, 17, 18, 19, 20, 21, 22, 23, 24, 25, 26, 27, 28, 29,30, 31, 32, 33, 34, 35, 36 or more carbon atoms, while the term “lower alkyl” has the same meaning as alkyl but contains 1, 2, 3, 4, 5, or 6 carbon atoms. Representative saturated straight chain alkyls include methyl, ethyl, n-propyl, n-butyl, n-pentyl, n-hexyl, and the like; while saturated branched alkyls include isopropyl, sec-butyl, isobutyl, tert-butyl, isopentyl, and the like. Unsaturated alkyls contain at least one double or triple bond between adjacent carbon atoms (referred to as an “alkenyl” or “alkynyl,” respectively). Representative straight chain and branched alkenyls include ethylenyl, propylenyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like; while representative straight chain and branched alkynyls include acetylenyl, propynyl, 1-butynyl, 2-butynyl, 1-pentynyl, 2-pentynyl, 3-methyl-1 butynyl, and the like. Typical alkyl groups include, but are in no way limited to, methyl, ethyl, propyl, isopropyl, butyl, isobutyl, tertiary butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, hexacosyl, heptacosyl, octacosyl, nonacosyl, triacontyl, henatriacontyl, dotriacontyl, tritriacontyl, tetratriacontyl, pentatriacontanyl, and hexatriacontanoic. The alkyl group may be substituted or unsubstituted.

The term “alkoxy” as used herein is a broad term, and is to be given its ordinary and customary meaning to a person of ordinary skill in the art (and is not to be limited to a special or customized meaning), and refers without limitation to an alkyl moiety attached through an oxygen bridge (i.e., —O-alkyl) such as methoxy, ethoxy, and the like.

The term “alcohol” as used herein is a broad term, and is to be given its ordinary and customary meaning to a person of ordinary skill in the art (and is not to be limited to a special or customized meaning), and refers without limitation to any compound as described herein incorporating one or more hydroxy groups, or being substituted by or functionalized to include one or more hydroxy groups.

The term “ester” as used herein is a broad term, and is to be given its ordinary and customary meaning to a person of ordinary skill in the art (and is not to be limited to a special or customized meaning), and refers without limitation to any compound as described herein incorporating one or more ester groups, e.g., monoester, diester, triester, or polyester, or being substituted by or functionalized to include one or more ester groups. Esters include but are not limited to fatty acid esters.

The term “glycols” as used herein is a broad term, and is to be given its ordinary and customary meaning to a person of ordinary skill in the art (and is not to be limited to a special or customized meaning), and can include diols, e.g., polyalkylene glycols such as polyethylene glycols polymers having the formula H (OCH₂CH₂)nOH where n is greater than three), polypropylene glycols, or glycols incorporating monomers comprising longer hydrocarbon chains.

### NON-LIMITING EXAMPLES

The examples of the disclosure should not be interpreted as limiting. The Applicant envisages expanding uses within agriculture.

The compositions as described in the first and second aspects of the disclosure were tested as plant protection products, preferably nematicides and/or nematistatics. The preferred embodiment includes a biocontrol agent.

TABLE 1.1
shows an example embodiment of the composition according to disclosure being
an unloaded carrier composition (UCC) (The UCC was provided as a gel)

| Item | Description | Compound | Weight of Total (%) |
|---|---|---|---|
| 1. | an alkyl | (C₂-C₂₆) alkyl lactate and/or derivative thereof, | between about 5 wt. % to |
| | lactate and/or | including lauryl lactyl lactate, lauryl lactate, | about 50 wt. % (preferred |
| | derivate | myristyl lactate, cetyl lactate and/or mixtures | between about 10 wt. % to |
| | thereof | thereof | about 20 wt. %) |
| 2. | a (C₂-C₂₂) | butanol, pentanol, hexanol, octanol, 2-ethylhexanol, | between about 0.1 wt. % to |
| | alcohol | nonanol, decanol, undecanol, dodecanol and/or | about 20 wt. % (preferred |
| | | derivatives thereof | between about 1 wt. % to |
| | | | about 5 wt %) |
| 3. | a humectant | glycerin, glycerol or alkyl ethers thereof, (C₂-C₃₀) | between about 1 wt. % to |
| | | alkene glycol, propylene glycol, polypropylene | about 30 wt. % (between |
| | | glycol or alkyl ethers thereof, sorbitol, mannitol, | about 7 wt. % to about 15 |
| | | dulcitol and/or polyols, straight chain (C₄-C₁₈) | wt. %) |
| | | alkyl(poly)glycosides, branched chain (C₄-C₁₈) | |
| | | alkyl(poly) glycosides, straight chain (C₄-C₁₈) | |
| | | alkyl(poly)glucosides, branched chain (C₄-C₁₈) | |
| | | alkyl(poly)glucosides, and/or derivatives thereof | |
| 4. | a non-ionic | alkoxylated sorbitan fatty esters, alkoxylated | between about 1 wt. % to |
| | surfactant | sorbitol fatty esters, ethoxylated sorbitan fatty | about 50 wt. % (preferably |
| | and/or | esters, ethoxylated sorbitol fatty esters, | between about 10 wt. % to |
| | an anionic | polyoxyethylene sorbitan monolaurate, | about 20 wt. %) |
| | surfactant | polyoxyethylene sorbitan monopalmitate, | |
| | | polyoxyethylene sorbitan monostearate, | |
| | | polyoxyethylene sorbitan monolaurate, | |
| | | and/orcombinations thereof; | |
| | | (C₆-C₁₈) alkyl benzene sulfonic acid salts, (C₆-C₁₈) | |
| | | alkyl ether sulfates, (C₆-C₁₈) alkyl ethoxylated | |
| | | ether sulfates, alkyl polyglycol ether phosphates, | |
| | | (C₆-C₁₈) alkyl phosphate esters, (C₆-C₁₈) alkoxylated | |
| | | sulfates, xylene sulfonate salts, cumene sulfonate | |
| | | salts, lignosulfonates, naphthalenesulfonates, and/or | |
| | | combinations thereof. | |
| 5. | Binder | methyl acrylate, butyl acrylate, ethyl acrylate, | between about 0.1 wt. % to |
| | | and/or 2-ethylhexyl acrylate | about 20 wt. % (preferably |
| | | | between about 2 wt. % to |
| | | | about 10 wt. %) |
| 6. | diluent | Water | between about 1 wt. % to |
| | | | about 80 wt. % (preferably |
| | | | between about 20 wt. % to |
| | | | about 30 wt. %) |
| Total: | | | 100 |

TABLE 1.2
shows an example embodiment of the composition according
to disclosure being a loaded carrier composition (LCC)

| Item | Description | Compound | Weight of Total (%) |
|---|---|---|---|
| 1. | a (C₂-C₂₆) alkyl | (C₂-C₂₆) alkyl lactate and/or derivative thereof, | between about 5 wt. % to |
| | lactate and/or | including lauryl lactyl lactate, lauryl lactate, | about 50 wt. % (preferred |
| | derivate thereof | myristyl lactate, cetyl lactate and/or mixtures | between about 10 wt. % to |
| | | thereof | about 20 wt. %) |
| 2. | a (C₂-C₂₂) | butanol, pentanol, hexanol, octanol, 2-ethylhexanol, | between about 0.1 wt. % to |
| | alcohol | nonanol, decanol, undecanol, dodecanol and/or | about 20 wt. % (preferred |
| | | derivatives thereof | between about 1 wt. % to |
| | | | about 5 wt %) |
| 3. | a humectant | glycerin, glycerol or alkyl ethers thereof, (C₂-C₃₀) | between about 1 wt. % to |
| | | alkene glycol, propylene glycol, polypropylene | about 30 wt. % (preferably |
| | | glycol or alkyl ethers thereof, sorbitol, mannitol, | between about 7 wt. % to |
| | | dulcitol and/or polyols, straight chain (C₄-C₁₈) | about 15 wt. %) |
| | | alkyl(poly)glycosides, branched chain (C₄-C₁₈) | |
| | | alkyl(poly) glycosides, straight chain (C₄-C₁₈) | |
| | | alkyl(poly)glucosides, branched chain (C₄-C₁₈) | |
| | | alkyl(poly)glucosides, and/or derivatives thereof | |
| 4. | a non-ionic | alkoxylated sorbitan fatty esters, alkoxylated | between about 1 wt. % to |
| | surfactant | sorbitol fatty esters, ethoxylated sorbitan fatty | about 50 wt. % (preferably |
| | and/or | esters, ethoxylated sorbitol fatty esters, | between about 10 wt. % to |
| | an anionic | polyoxyethylene sorbitan monolaurate, | about 20 wt. %) |
| | surfactant | polyoxyethylene sorbitan monopalmitate, | |
| | | polyoxyethylene sorbitan monostearate, | |
| | | polyoxyethylene sorbitan monolaurate, and/or | |
| | | combinations thereof; | |
| | | (C₆-C₁₈) alkyl benzene sulfonic acid salts, (C₆-C₁₈) | |
| | | alkyl ether sulfates, (C₆-C₁₈) alkyl ethoxylated | |
| | | ether sulfates, alkyl polyglycol ether phosphates, | |
| | | (C₆-C₁₈) alkyl phosphate esters, (C₆-C₁₈) alkoxylated | |
| | | sulfates, xylene sulfonate salts, cumene sulfonate | |
| | | salts, lignosulfonates, naphthalenesulfonates, | |
| | | and/orcombinations thereof. | |
| 5. | Binder | methyl acrylate, butyl acrylate, ethyl acrylate, | between about 0.1 wt. % to |
| | | and/or 2-ethylhexyl acrylate | about 20 wt. % (preferably |
| | | | between about 2 wt. % to |
| | | | about 10 wt. %) |
| 6. | Diluent | Water | between about 1 wt. % to |
| | | | about 80 wt. % (preferably |
| | | | between about 20 wt. % to |
| | | | about 30 wt. %) |
| 7. | Carboxylic acid | abscisic acid, auxins, brassinosteroids, cytokinins, | between about 0.1 wt. % to |
| | and/or plant | ethylene, gibberellins, jasmonate, jasmonic acid, | about 20 wt. % (preferably |
| | hormone and/or | salicylic acid, itaconic acid, strigolactones, | between about 0.5 wt. % to |
| | secondary | polyamines, nitric acid, triacontanol, | about 10 wt. % of the total |
| | metabolite | and/orderivatives thereof | wt. %) |
| 8. | microorganism | bacteria, virus, fungi | between about 1 wt. % to |
| | (biocontrol | | about 70 wt. % (preferably |
| | agent) | | between about 25 wt. % to |
| | | | about 35 wt. %) |
| Total: | | | 100 |

TABLE 1.3
shows an example embodiment of the composition according
to disclosure being a preferred embodiment of the loaded
carrier composition (pLLC also referred to as OR-501)

| Item | Description | Compound | Weight of Total (%) |
|---|---|---|---|
| 1. | a (C₁₀-C₂₂) | lauryl lactyl lactate | between about 10 wt. % |
| | alkyl lactate | | to about 20 wt. %) |
| | and/or derivate | | |
| | thereof | | |
| 2. | a (C₂-C₂₂) | octan-2-ol | between about 1 wt. % |
| | alcohol | | to about 5 wt. % |
| 3. | a humectant | Glycerin | between about 7 wt. % |
| | | | to about 15 wt. % |
| 4. | a non-ionic | polyoxyethylene | between about 10 wt. % |
| | surfactant | sorbitan monolaurate | to about 20 wt. % |
| 5. | Binder | styrene acrylic | between about 2 wt. % |
| | | emulsion polymer | to about 10 wt. % |
| 6. | Diluent | Water | between about 20 wt. % |
| | | | to about 30 wt. % |
| 7. | Carboxylic acid | salicylic acid | between about 0.5 wt. % |
| | and/or plant | | to about 5 wt. % |
| | hormone and/or | | |
| | secondary | | |
| | metabolite | | |
| 8. | microorganism | Bacillus spp. | between about 25 wt. % |
| | (biocontrol | | to about 35 wt. % |
| | agent) | | |
| Total: | | | 100 |

Method of Preparation of the Loaded Agricultural Carrier Composition According to this Disclosure

For the purpose of illustration, the method for preparing the loaded agricultural carrier composition (LCC) as used in the non-limiting examples is outlined below.

The production and use of a loaded agricultural carrier composition (LCC) is provided. Typically, the loaded agricultural carrier composition is manufactured as concentrates containing at least an antipathogenic agricultural compound, and/or an antipathogenic agricultural microorganism and/or antipathogenic agricultural mixture of microorganisms dispersed or dissolved in the unloaded agricultural carrier (UCC). The antipathogenic loaded agricultural carrier composition is stable and can be storage during at least one year in room temperature (around 20° C.) or even in refrigerated conditions (around 5° C.) and may be diluted prior to use. Alternatively, the antipathogenic agricultural compound and the unloaded agricultural carrier may be admixed and diluted thereafter. The loaded agricultural carrier composition is typically diluted with water or other mean providing a stable tank mix of diluted agricultural composition prior to use and application onto, or adjacent to, agricultural crops or soil of agricultural crops to control pathogen populations and/or control and/or treat disease related to said pathogens. The disclosure extends to application of the agricultural composition to, or adjacent to, soil, substrates, plants, part of plants, animals, buildings, equipment and the like. The loaded agricultural carrier composition according to this disclosure is stable prior to and when in use.

The antipathogenic loaded agricultural carrier composition according to this disclosure typically is in a liquid and/or syrup and/or gel form having an active ingredient and/or a biocontrol agent dissolved or dispersed in the agricultural carrier and it is stable as a concentrate and it is stable in a tank mixture. The antipathogenic loaded agricultural carrier composition is provided as a composition including more than one chemical compound. The concentrated stable antipathogenic loaded agricultural carrier composition may comprise: (C₂-C₂₆) alkyl lactate and/or derivate thereof in an amount of between 5.0 to 50.0 wt. %; (C₂-C₂₂) alcohol in an amount of between 0.1 to 20.0 wt. %; humectant in an amount of between 1.0 to 30.0 wt. %; non-ionic and/or an anionic surfactant in an amount of between 1.0 to 50.0 wt. %; optionally a binder in an amount of between 0.1 to 20.0 wt. %; diluent, preferably water, in an amount of between 1.0 to 80.0 wt. %; and one or more biocontrol agents, preferably one or more species of bacteria or fungi, in an amount of between 1.0 to 70.0 wt. %; wherein the antipathogenic loaded agricultural carrier composition is stable in a concentrate form and having a shelf-life at a room temperature (around 20° C.) of at least one year.

The antipathogenic agricultural compound, and/or an antipathogenic agricultural microorganism and/or antipathogenic agricultural mixture of microorganisms referred here can be an insecticide, pesticide, miticide, acaricide, ovicide, herbicide, fungicide, viricide, nematicide, nematistatic, an insect grow regulator.

The unloaded agricultural carrier (UCC) may alternatively and/or additionally be loaded with a plant growth regulator, an elicitor, a biostimulant and/or a fertilizer.

The Applicant was surprised at the longevity of the shelf-life of the compositions according to this disclosure. Furthermore, the compositions did not show phase separation and remained stable for prolonged periods of time.

It is to be understood that the antipathogenic agricultural composition and an unloaded agricultural carrier composition (UCC) may be admixed and diluted thereafter. The antipathogenic agricultural composition can be at least an antipathogenic agricultural compound/composition, and/or an antipathogenic agricultural microorganism and/or antipathogenic agricultural mixture of microorganisms. In a preferred embodiment, the unloaded agricultural carrier composition (UCC) is added first into the tank mixture giving a stable solution of the unloaded agricultural carrier, and in a second step the antipathogenic agricultural composition (preferably a microorganism) is added to the agricultural carrier solution giving the antipathogenic agricultural composition dispersed or diluted into the agricultural carrier solution. This mixed antipathogenic agricultural diluted or dispersed composition is stable and able for application onto, or adjacent to, agricultural crops or soil of agricultural crops to control pathogen populations and/or control and/or treat disease related to said pathogens. The disclosure extends to application of the agricultural composition to, or adjacent to, soil, substrates, plants, parts of plants, animals, buildings, equipment and the like. The unloaded agricultural carrier composition (UCC) according to this disclosure is stable prior to and when in use.

The unloaded agricultural carrier composition (UCC) is provided as a liquid and/or syrup and/or a gel composition including more than one chemical compound. The concentrated stable unloaded agricultural carrier composition (UCC) may comprise: (C₂-C₂₆) alkyl lactyl lactate and/or derivate thereof in an amount of between 5.0 to 50.0 wt. %; (C₂-C₂₂) alcohol in an amount of between 0.1 to 20.0 wt. %; humectant in an amount of between 1.0 to 30.0 wt. %; non-ionic and/or an anionic surfactant, preferably one nonionic surfactant, in an amount of between 1.0 to 50.0 wt. %; optionally binder in an amount of between 0.1 to 20.0 wt. %; and a diluent, preferably water and/or other co-solvent, in an amount of between 1.0 to 80.0 wt. %; wherein the unloaded agricultural carrier composition (UCC) is stable and having a shelf-life at a room temperature (around 20° C.) of at least two years.

The antipathogenic agricultural compound, and/or an antipathogenic agricultural microorganism and/or antipathogenic agricultural mixture of microorganisms referred here can be an insecticide, pesticide, miticide, acaricide, ovicide, herbicide, fungicide, viricide, nematicide, nematistatic, an insect grow regulator.

Testing the Loaded Agricultural Carrier Composition According to this Disclosure (OR-501) as a Nematicide and/or Nematistatic.

The Applicant tested a series of compositions according to this disclosure including: unloaded carrier compositions (UCC), preferred embodiments of loaded carrier compositions (pLCC also referred to as OR-501), OR-501 further loaded with other actives and/or biocontrol agents, bacterial biocontrol agent standalone compositions, commercially available compositions, water, and a control. All compositions were against for activity in killing and/or immobilizing nematodes.

In broad terms, compositions according to this disclosure showed nematicidal and/or nematistatic properties superior to those of chemical standard oxamyl. Oxamyl is systematically be phased out of use as being potentially harmful to the environment. There is a need for more environmentally friendly nematicides that show efficacy similar or better than conventional chemical standards such as oxamyl.

Particularly, the Applicant was surprised that the preferred embodiment of the loaded agricultural carrier composition (pLCC also referred to as OR-501) wherein the biocontrol agents comprise a microorganism and a plant hormone, that microorganism and plant hormone were kept intact and/or uncompromised and/or stable when loaded into the carrier composition. This was particularly surprising where the microorganism is a bacteria and the plant hormone is salicylic acid, since it is known in the art that the salicylic acid destroys and/or impairs bacteria.

### Example 1

### Nematicide Laboratory Trials

Various compositions were prepared and tested as nematicides and/or nematistatics in vitro as set out in Table 2.

The unloaded carrier composition (UCC) consisted of: an alkyl lactate and/or derivate (alkyl lactyl lactate), a (C₂-C₂₂) alcohol (octan-2-ol), a humectant (glycerin), a non-ionic surfactant (polyoxyethylene sorbitan monolaurate), and a binder (styrene acrylic polymer).

The preferred loaded carrier composition (pLCC also referred to as OR-501) consisted of: a (C₁₀-C₂₂) alkyl lactate and/or derivate (lauryl lactyl lactate), a C₂-C₂₂ alcohol (octan-2-ol), a humectant (glycerin), a non-ionic surfactant (polyoxyethylene sorbitan monolaurate), and a binder (styrene acrylic polymer), a microorganism (Bacillus amyloliquefaciens spp, particularly CM5; ATCC PTA-12138) and a secondary metabolite (salicylic acid).

TABLE 2
shows formulations that were tested
as nematicides and/or nematistatics.

| | | Tested |
|---|---|---|
| Formulation | | dose |
| code | Content | (% w/v) |
| OR-N-1 | Bacillus subtilis standalone | 1.5% |
| OR-N-3 | Bacillus amyloliquefaciens standalone | 1.5% |
| OR-N-4 | Bacillus subtilis (20%) + UCC (80%) | 5% |
| OR-N-5 | Bacillus firmus (20%) + UCC (80%) | 5% |
| OR-N-6 | OR-501/pLCC (20% | 5% |
| | B. amyloliquefaciens + 20% UCC) | |
| OR-N-7 | UCC (90%) + secondary metabolites (10%) | 5% |
| OR-N-8 | Bacillus subtilis Furatrop ® (commercial | 1.5% |
| | microbial nematicide) | |
| OR-N-9 | Commercial microbial nematicide (branded | 1.5% |
| | Profix ®) B. subitilis + B. licheniformis + | |
| | Paecilomyces lilacinus | |
| OR-N-10 | Koppert ® (commercially available | 1.5% |
| | microbial nematicide branded Veraneio ® | |
| | in Brazil) | |
| OR-N-11 | Furatrop ® (20%) + UCC (80%) | 5% |
| OR-N-12 | OR-N-9 (20%) + UCC (80%) | 5% |
| OR-N-13 | Koppert ® Veraneio ® | 5% |
| | (20%) + UCC (80%) | |
| OR-N-14 | OR-454 (experimental product based on | 1.5% |
| | zinc and cobalt) | |
| OR-N-15 | UCC | 5% |
| OR-N-20 | OR-501/pLCC + 8% maltodextrin | 5% |
| OR-N-21 | Pseudomonas fluorescens standalone | 1.5% |
| OR-N-22 | Pseudomonas fluorescens | 5% |
| | (20%) + UCC (80%) | |
| OR-N-23 | OR-329 (experimental product based | 1.5% |
| | on flavonoids) | |
| Oxamyl | Afromyl ®/Oxamyl (industry | 1% |
| | standard nematicide) | |
| Negative | Distilled water | 5% |
| control | | |

### Experimental Setup and Bioassay Methodology:

Bioassays were designed to determine the efficacy of tested formulations, and included the following steps:
1. nematode extraction from carrot disks using the mesh extraction method;
2. counting of extracted nematodes in a sample of 100 μL of water;
3. preferably, nematode count in such a sample is between 40-80 nematodes;
4. determining efficacy in ELISA plates;
5. preparing a stock solution that is 10 times more diluted than the main formulation for all treatments;
6. for treatments tested at 5% or 1.5%, aliquots of 50 μL or 15 μL of the corresponding stock solution were introduced to a well, respectively. Volume was completed with 50 μL of the nematode extract, except for treatments tested at 1.5%, an additional 35 μL of distilled water was introduced to reach a total volume of 100 μL. Content of the well was sufficiently mixed with a pipette, to ensure proper distribution of both nematodes and treatment components;
7. performing at least 6 replicates of every treatment. The flask containing the nematode colony was mixed by manual shaking every time before nematodes were introduced to the well. This way we ensure a somewhat homogenous nematode count and avoid nematodes settling at the bottom of the flask;
8. keeping the whole ELISA plate in dark conditions for 24 hours after introduction of the treatment; and
9. assessing nematode mortality 24 hours after treatment under stereoscope. Nematodes that were moving were considered alive. Nematodes that were not moving were poked with a fine brush, if they respond to the poking with slight movements, they were considered alive. If not, they were considered dead.

The only validity criterium was that nematode mortality in the negative controls should not exceed 10%.

### Statistical Analysis:

The raw mortality data was analyzed using RStudio (version 1.4.1717). The data sets were subjected to Shapiro-Wilk test for normality (α=0.05). Data was not normally distributed; therefore, a Kruskal-Wallis test was applied. Where there was significance, a Wilcoxon rank sum t-test was performed for pairwise comparisons between treatment groups.

### Results

TABLE 3
shows raw data collected from the experimental protocols

| | | | | | | | | | | | Mortality |
|---|---|---|---|---|---|---|---|---|---|---|---|
| | | | | | | | | | Total | | (%) 24 h |
| Formulation | | | | | total | mean | total | mean | of the | mean | post |
| code | replicates | Dead | alive | Total | dead | dead | alive | alive | total | total | exposure |
| OR-N-1 | Rep. 1 | 1 | 26 | 27 | 8 | 1.33 | 206 | 34.33 | 214 | 35.67 | 3.74 |
| | Rep. 2 | 1 | 23 | 24 | | | | | | | |
| | Rep. 3 | 1 | 35 | 36 | | | | | | | |
| | Rep. 4 | 1 | 38 | 39 | | | | | | | |
| | Rep. 5 | 2 | 39 | 41 | | | | | | | |
| | Rep. 6 | 2 | 45 | 47 | | | | | | | |
| OR-N-3 | Rep. 1 | 1 | 30 | 31 | 9 | 1.50 | 207 | 34.50 | 216 | 36.00 | 4.17 |
| | Rep. 2 | 1 | 33 | 34 | | | | | | | |
| | Rep. 3 | 0 | 29 | 29 | | | | | | | |
| | Rep. 4 | 1 | 44 | 45 | | | | | | | |
| | Rep. 5 | 4 | 35 | 39 | | | | | | | |
| | Rep. 6 | 2 | 36 | 38 | | | | | | | |
| OR-N-4 | Rep. 1 | 34 | 10 | 44 | 179 | 29.83 | 73 | 12.17 | 252 | 42.00 | 71.03 |
| | Rep. 2 | 18 | 13 | 31 | | | | | | | |
| | Rep. 3 | 28 | 15 | 43 | | | | | | | |
| | Rep. 4 | 27 | 21 | 48 | | | | | | | |
| | Rep. 5 | 37 | 4 | 41 | | | | | | | |
| | Rep. 6 | 35 | 10 | 45 | | | | | | | |
| OR-N-5 | Rep. 1 | 36 | 20 | 56 | 235 | 39.17 | 126 | 21.00 | 361 | 60.17 | 65.10 |
| | Rep. 2 | 49 | 34 | 83 | | | | | | | |
| | Rep. 3 | 40 | 23 | 63 | | | | | | | |
| | Rep. 4 | 32 | 8 | 40 | | | | | | | |
| | Rep. 5 | 38 | 19 | 57 | | | | | | | |
| | Rep. 6 | 40 | 22 | 62 | | | | | | | |
| OR-N-6 | Rep. 1 | 28 | 5 | 33 | 410 | 34.17 | 51 | 4.25 | 461 | 38.42 | 88.94 |
| | Rep. 2 | 27 | 10 | 37 | | | | | | | |
| | Rep. 3 | 34 | 5 | 39 | | | | | | | |
| | Rep. 4 | 32 | 11 | 43 | | | | | | | |
| | Rep. 5 | 33 | 9 | 42 | | | | | | | |
| | Rep. 6 | 29 | 9 | 38 | | | | | | | |
| | Rep. 7 | 39 | 0 | 39 | | | | | | | |
| | Rep. 8 | 29 | 0 | 29 | | | | | | | |
| | Rep. 9 | 29 | 1 | 30 | | | | | | | |
| | Rep. 10 | 36 | 0 | 36 | | | | | | | |
| | Rep. 11 | 43 | 1 | 44 | | | | | | | |
| | Rep. 12 | 51 | 0 | 51 | | | | | | | |
| OR-N-7 | Rep. 1 | 40 | 8 | 48 | 268 | 44.67 | 94 | 15.67 | 362 | 60.33 | 74.03 |
| | Rep. 2 | 53 | 11 | 64 | | | | | | | |
| | Rep. 3 | 35 | 18 | 53 | | | | | | | |
| | Rep. 4 | 42 | 21 | 63 | | | | | | | |
| | Rep. 5 | 33 | 19 | 52 | | | | | | | |
| | Rep. 6 | 65 | 17 | 82 | | | | | | | |
| OR-N-8 | Rep. 1 | 38 | 4 | 42 | 292 | 48.67 | 16 | 2.67 | 308 | 51.33 | 94.81 |
| | Rep. 2 | 53 | 2 | 55 | | | | | | | |
| | Rep. 3 | 42 | 7 | 49 | | | | | | | |
| | Rep. 4 | 57 | 2 | 59 | | | | | | | |
| | Rep. 5 | 50 | 0 | 50 | | | | | | | |
| | Rep. 6 | 52 | 1 | 53 | | | | | | | |
| OR-N-9 | Rep. 1 | 44 | 0 | 44 | 359 | 59.83 | 10 | 1.67 | 369 | 61.50 | 97.29 |
| | Rep. 2 | 48 | 2 | 50 | | | | | | | |
| | Rep. 3 | 60 | 2 | 62 | | | | | | | |
| | Rep. 4 | 42 | 2 | 44 | | | | | | | |
| | Rep. 5 | 75 | 1 | 76 | | | | | | | |
| | Rep. 6 | 90 | 3 | 93 | | | | | | | |
| OR-N-10 | Rep. 1 | 1 | 37 | 38 | 27 | 2.25 | 447 | 37.25 | 474 | 39.50 | 5.70 |
| | Rep. 2 | 1 | 32 | 33 | | | | | | | |
| | Rep. 3 | 3 | 48 | 51 | | | | | | | |
| | Rep. 4 | 4 | 42 | 46 | | | | | | | |
| | Rep. 5 | 2 | 41 | 43 | | | | | | | |
| | Rep. 6 | 1 | 38 | 39 | | | | | | | |
| | Rep. 7 | 3 | 32 | 35 | | | | | | | |
| | Rep. 8 | 4 | 33 | 37 | | | | | | | |
| | Rep. 9 | 3 | 35 | 38 | | | | | | | |
| | Rep. 10 | 1 | 38 | 39 | | | | | | | |
| | Rep. 11 | 2 | 37 | 39 | | | | | | | |
| | Rep. 12 | 2 | 34 | 36 | | | | | | | |
| OR-N-11 | Rep. 1 | 29 | 9 | 38 | 254 | 42.33 | 51 | 8.50 | 305 | 50.83 | 83.28 |
| | Rep. 2 | 47 | 5 | 52 | | | | | | | |
| | Rep. 3 | 54 | 10 | 64 | | | | | | | |
| | Rep. 4 | 47 | 8 | 55 | | | | | | | |
| | Rep. 5 | 33 | 13 | 46 | | | | | | | |
| | Rep. 6 | 44 | 6 | 50 | | | | | | | |
| OR-N-12 | Rep. 1 | 33 | 23 | 56 | 226 | 37.67 | 91 | 15.17 | 317 | 52.83 | 71.29 |
| | Rep. 2 | 35 | 13 | 48 | | | | | | | |
| | Rep. 3 | 43 | 12 | 55 | | | | | | | |
| | Rep. 4 | 38 | 13 | 51 | | | | | | | |
| | Rep. 5 | 37 | 15 | 52 | | | | | | | |
| | Rep. 6 | 40 | 15 | 55 | | | | | | | |
| OR-N-13 | Rep. 1 | 48 | 16 | 64 | 442 | 36.83 | 151 | 12.58 | 593 | 49.42 | 74.54 |
| | Rep. 2 | 32 | 25 | 57 | | | | | | | |
| | Rep. 3 | 40 | 16 | 56 | | | | | | | |
| | Rep. 4 | 35 | 16 | 51 | | | | | | | |
| | Rep. 5 | 27 | 14 | 41 | | | | | | | |
| | Rep. 6 | 51 | 17 | 68 | | | | | | | |
| | Rep. 7 | 25 | 2 | 27 | | | | | | | |
| | Rep. 8 | 40 | 9 | 49 | | | | | | | |
| | Rep. 9 | 31 | 5 | 36 | | | | | | | |
| | Rep. 10 | 36 | 9 | 45 | | | | | | | |
| | Rep. 11 | 35 | 12 | 47 | | | | | | | |
| | Rep. 12 | 42 | 10 | 52 | | | | | | | |
| OR-N-14 | Rep. 1 | 13 | 35 | 48 | 267 | 22.25 | 282 | 23.50 | 549 | 45.75 | 48.63 |
| | Rep. 2 | 10 | 25 | 35 | | | | | | | |
| | Rep. 3 | 14 | 24 | 38 | | | | | | | |
| | Rep. 4 | 13 | 29 | 42 | | | | | | | |
| | Rep. 5 | 7 | 34 | 41 | | | | | | | |
| | Rep. 6 | 13 | 36 | 49 | | | | | | | |
| | Rep. 7 | 29 | 8 | 37 | | | | | | | |
| | Rep. 8 | 38 | 15 | 53 | | | | | | | |
| | Rep. 9 | 28 | 6 | 34 | | | | | | | |
| | Rep. 10 | 41 | 16 | 57 | | | | | | | |
| | Rep. 11 | 36 | 18 | 54 | | | | | | | |
| | Rep. 12 | 25 | 36 | 61 | | | | | | | |
| OR-N-15 | Rep. 1 | 10 | 41 | 51 | 57 | 9.50 | 285 | 47.50 | 342 | 57.00 | 16.67 |
| | Rep. 2 | 8 | 37 | 45 | | | | | | | |
| | Rep. 3 | 9 | 42 | 51 | | | | | | | |
| | Rep. 4 | 12 | 50 | 62 | | | | | | | |
| | Rep. 5 | 10 | 59 | 69 | | | | | | | |
| | Rep. 6 | 8 | 56 | 64 | | | | | | | |
| OR-N-20 | Rep. 1 | 24 | 4 | 28 | 191 | 31.83 | 29 | 4.83 | 220 | 36.67 | 86.82 |
| | Rep. 2 | 21 | 2 | 23 | | | | | | | |
| | Rep. 3 | 27 | 3 | 30 | | | | | | | |
| | Rep. 4 | 37 | 2 | 39 | | | | | | | |
| | Rep. 5 | 43 | 13 | 56 | | | | | | | |
| | Rep. 6 | 39 | 5 | 44 | | | | | | | |
| OR-N-21 | Rep. 1 | 37 | 22 | 59 | 221 | 36.83 | 211 | 35.17 | 432 | 72.00 | 51.16 |
| | Rep. 2 | 54 | 32 | 86 | | | | | | | |
| | Rep. 3 | 35 | 21 | 56 | | | | | | | |
| | Rep. 4 | 47 | 17 | 64 | | | | | | | |
| | Rep. 5 | 21 | 64 | 85 | | | | | | | |
| | Rep. 6 | 27 | 55 | 82 | | | | | | | |
| OR-N-22 | Rep. 1 | 109 | 15 | 124 | 480 | 80.00 | 96 | 16.00 | 576 | 96.00 | 83.33 |
| | Rep. 2 | 81 | 16 | 97 | | | | | | | |
| | Rep. 3 | 66 | 15 | 81 | | | | | | | |
| | Rep. 4 | 65 | 20 | 85 | | | | | | | |
| | Rep. 5 | 80 | 13 | 93 | | | | | | | |
| | Rep. 6 | 79 | 17 | 96 | | | | | | | |
| OR-N-23 | Rep. 1 | 73 | 0 | 73 | 351 | 58.50 | 0 | 0.00 | 351 | 58.50 | 100.00 |
| | Rep. 2 | 67 | 0 | 67 | | | | | | | |
| | Rep. 3 | 74 | 0 | 74 | | | | | | | |
| | Rep. 4 | 39 | 0 | 39 | | | | | | | |
| | Rep. 5 | 45 | 0 | 45 | | | | | | | |
| | Rep. 6 | 53 | 0 | 53 | | | | | | | |
| Oxamyl | Rep. 1 | 24 | 22 | 55 | 266 | 22.17 | 246 | 20.50 | 524 | 43.67 | 50.76 |
| | Rep. 2 | 34 | 20 | 57 | | | | | | | |
| | Rep. 3 | 29 | 25 | 54 | | | | | | | |
| | Rep. 4 | 20 | 17 | 37 | | | | | | | |
| | Rep. 5 | 31 | 24 | 55 | | | | | | | |
| | Rep. 6 | 39 | 18 | 57 | | | | | | | |
| | Rep. 7 | 15 | 7 | 22 | | | | | | | |
| | Rep. 8 | 4 | 27 | 31 | | | | | | | |
| | Rep. 9 | 18 | 5 | 23 | | | | | | | |
| | Rep. 10 | 5 | 34 | 39 | | | | | | | |
| | Rep. 11 | 22 | 21 | 43 | | | | | | | |
| | Rep. 12 | 25 | 26 | 51 | | | | | | | |
| Control | Rep. 1 | 0 | 40 | 40 | 20 | 0.67 | 980 | 32.67 | 1000 | 33.33 | 2.00 |
| | Rep. 2 | 0 | 14 | 14 | | | | | | | |
| | Rep. 3 | 0 | 34 | 34 | | | | | | | |
| | Rep. 4 | 0 | 17 | 17 | | | | | | | |
| | Rep. 5 | 1 | 37 | 38 | | | | | | | |
| | Rep. 6 | 1 | 39 | 40 | | | | | | | |
| | Rep. 7 | 0 | 23 | 23 | | | | | | | |
| | Rep. 8 | 0 | 17 | 17 | | | | | | | |
| | Rep. 9 | 2 | 40 | 42 | | | | | | | |
| | Rep. 10 | 0 | 52 | 52 | | | | | | | |
| | Rep. 11 | 1 | 37 | 38 | | | | | | | |
| | Rep. 12 | 1 | 45 | 46 | | | | | | | |
| | Rep. 13 | 2 | 36 | 38 | | | | | | | |
| | Rep. 14 | 1 | 16 | 17 | | | | | | | |
| | Rep. 15 | 1 | 23 | 24 | | | | | | | |
| | Rep. 16 | 1 | 39 | 40 | | | | | | | |
| | Rep. 17 | 1 | 35 | 36 | | | | | | | |
| | Rep. 18 | 0 | 42 | 42 | | | | | | | |
| | Rep. 19 | 0 | 24 | 24 | | | | | | | |
| | Rep. 20 | 0 | 34 | 34 | | | | | | | |
| | Rep. 21 | 1 | 30 | 31 | | | | | | | |
| | Rep. 22 | 1 | 28 | 29 | | | | | | | |
| | Rep. 23 | 2 | 38 | 40 | | | | | | | |
| | Rep. 24 | 1 | 44 | 45 | | | | | | | |
| | Rep. 25 | 0 | 18 | 18 | | | | | | | |
| | Rep. 26 | 0 | 28 | 28 | | | | | | | |
| | Rep. 27 | 0 | 27 | 27 | | | | | | | |
| | Rep. 28 | 2 | 45 | 47 | | | | | | | |
| | Rep. 29 | 1 | 48 | 49 | | | | | | | |
| | Rep. 30 | 0 | 30 | 30 | | | | | | | |

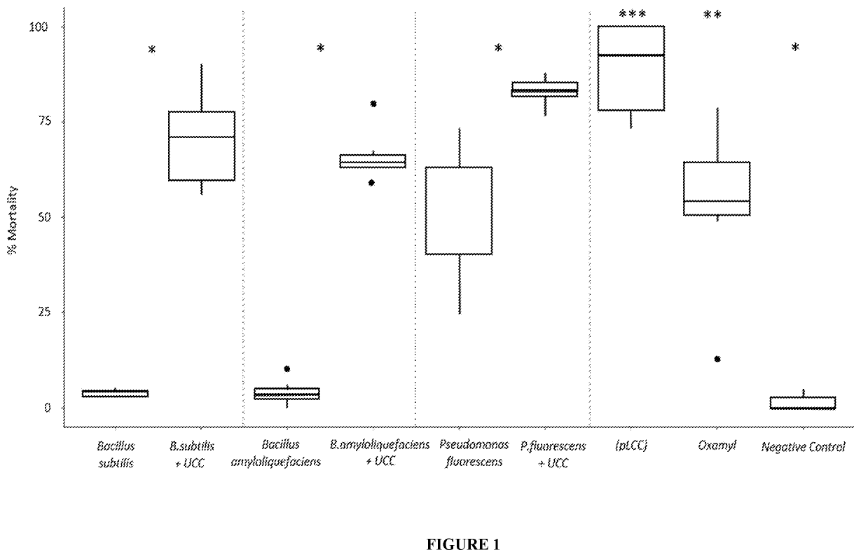

FIG. 1 shows the nematicidal effect of select bacteria when applied as standalone or in mixture with unloaded carrier compositions (UCC). Nematode mortality increases significantly when Bacillus subtilis, Bacillus amyloliquefaciens and Pseudomonas fluorescens are applied in mixture with unloaded carrier compositions. Our trials also showed that OR-501/pLCC exhibited the highest nematicidal effect among showcased treatments and interestingly caused significantly higher mortality compared with the synthetic standard, oxamyl.

FIG. 1 shows box plots showing interquartile range with horizontal bar as median. Whiskers indicate SEM. Dots represent the outliers. Asterisks represent statistically significant difference between treatments.

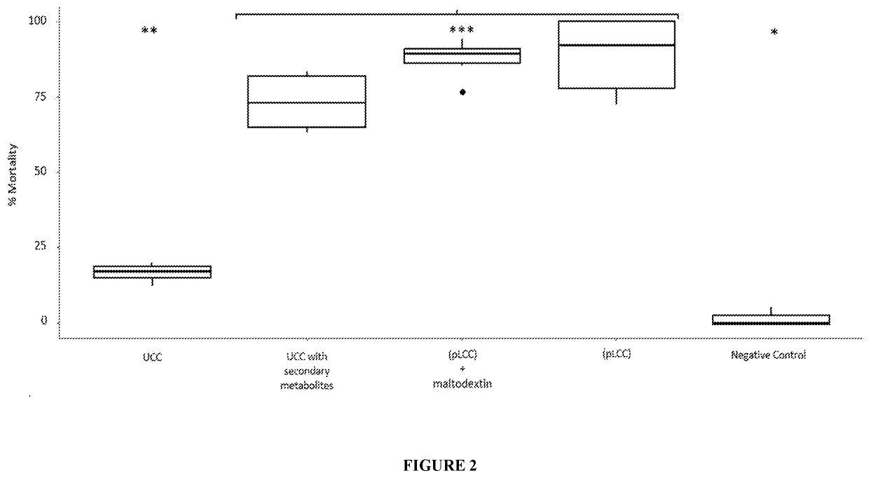

FIG. 2 shows box plots showing interquartile range with horizontal bar as median. Whiskers indicate SEM. Dots represent the outliers. Asterisks represent statistically significant difference between treatments.

From FIG. 2 it can be said that the inclusion of plant secondary metabolites inside the formulation has improved overall efficacy when compared to UCC. Furthermore, adding maltodextrin to UCC did not have any significant outcome on nematode mortality.

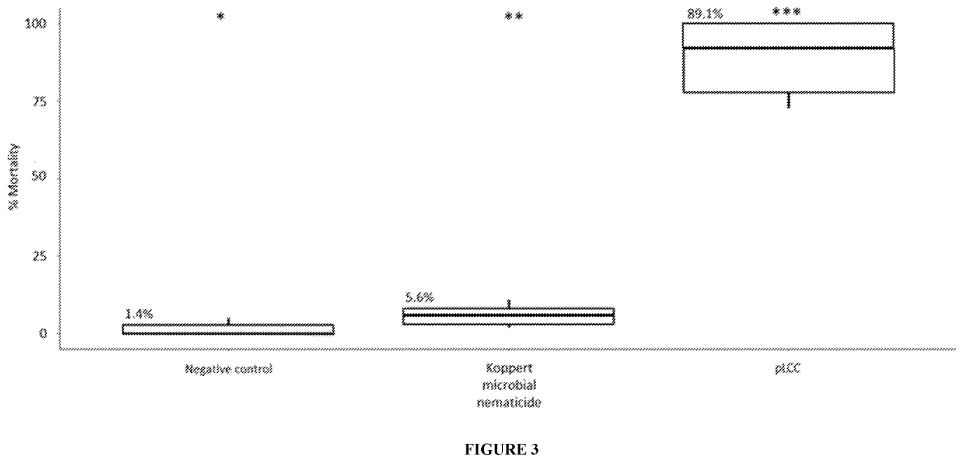

A microbial nematicide from Koppert® (branded Veraneio® in Brazil) was also tested to compare efficacy with pLLC. Results are shown in FIG. 3. FIG. 3 shows box plots showing interquartile range with horizontal bar as median. Whiskers indicate SEM. Dots represent the outliers. Asterisks represent statistically significant difference between treatments.

pLLC clearly performed significantly better compared with a competitor's product, achieving almost 90% of nematode mortality, compared with 5.6% of Koppert®'s microbial nematicide.

The unloaded agricultural carrier composition (UCC) in itself shows some initial antipathogenic activity (see FIG. 2). This is advantageous in that upon initial application to soil there is dual action, firstly initial antipathogenic activity of the unloaded agricultural carrier composition, and secondly (later), antipathogenic activity of the microbial (particularly after the spores germinate into an active state). Therefore, the loaded agricultural carrier composition provides for a two-pronged anti-pathogenic treatment regime over a prolonged period of time. This allows enhanced efficacy whilst reducing compaction on soil, and reducing water spray volumes, and reducing application intervals of plant protection products within a multilayered approach. This was surprising and unexpected.

### Complementary Nematicidal Lab Trials

The purpose of this study is to better understand the effect of (C₂-C₂₆) alkyl lactate derivatives on the nematicidal effect of the compositions made according to this application. All tested compositions are summarized in Table 4.

Four unloaded carrier composition (UCCa, UCCb, UCCc, UCCd) were prepared including: (i) a (C₁₀-C₂₂) alkyl lactate [lauryl lactyl lactate (in UCCa), lauryl lactate (in UCCb), cetyl lactate (in UCCc) and a mixture of lauryl lactate, myristyl lactate and cetyl lactate (in UCCd))]; (ii) a (C₂-C₂₂) alcohol (octan-2-ol); (iii) a humectant (glycerin); (iv) a non-ionic surfactant (polyoxyethylene sorbitan monolaurate); (v) a binder (styrene acrylic polymer), and (vi) a secondary metabolite (salicylic acid).

A fifth unloaded carrier composition (UCCe) was prepared including: (i) a (C₁₀-C₂₂) alkyl lactate (lauryl lactyl lactate); (ii) a (C₂-C₂₂) alcohol (octan-2-ol); (iii) a humectant (glycerin); (iv) a non-ionic surfactant (polyoxyethylene sorbitan monolaurate); (v) a binder (styrene acrylic polymer); and (vi) secondary metabolite (itaconic acid).

TABLE 4
Tested compositions and their content.

| Composition code | |
|---|---|
| (dose % w/v) | Content |
| B-017-03 (5%) | Bacillus amyloliquefaciens (20%) + UCCb (80%) |
| B-017-04 (5%) | Bacillus amyloliquefaciens (20%) + UCCc (80%) |
| B-017-05 (5%) | Bacillus amyloliquefaciens (20%) + UCCd (80%) |
| B-017-05 (1%) | Bacillus amyloliquefaciens (20%) + UCCd (80%) |
| B-017-05 (0.5%) | Bacillus amyloliquefaciens (20%) + UCCd (80%) |
| B-017-06 (5%) | Bacillus subtilis BS03 (20%) + UCCa (80%) |
| B-017-07 (2%) | Bacillus amyloliquefaciens (20%) + UCCe (80%) |
| Untreated control | Distilled water |
| Afromyl ® (2%) | Oxamyl 100 g/L |

### Experimental Setup and Bioassays Methodology

The nematicide efficacy protocol consisted of the following steps:
1—Nematode extraction from carrot disks using the mesh extraction method.
2—Counting of extracted nematodes in a sample of 100 μL of water.
3—It is preferable if nematode count in such a sample is between 60-80 nematodes.
4—Efficacy was tested in ELISA plates.
5—The whole ELISA plate was kept in dark conditions for 24 hours after introduction of the treatment.
6-Nematode mortality was assessed 24 hours after treatment under stereoscope. Nematodes that were moving were considered alive. Nematodes that were not moving were poked with a fine brush, if they respond to the poking with slight movements, they were considered alive. If not, they were considered dead.
7—The only validity criterium was that nematode mortality in the untreated controls should not exceed 10%.

### Results

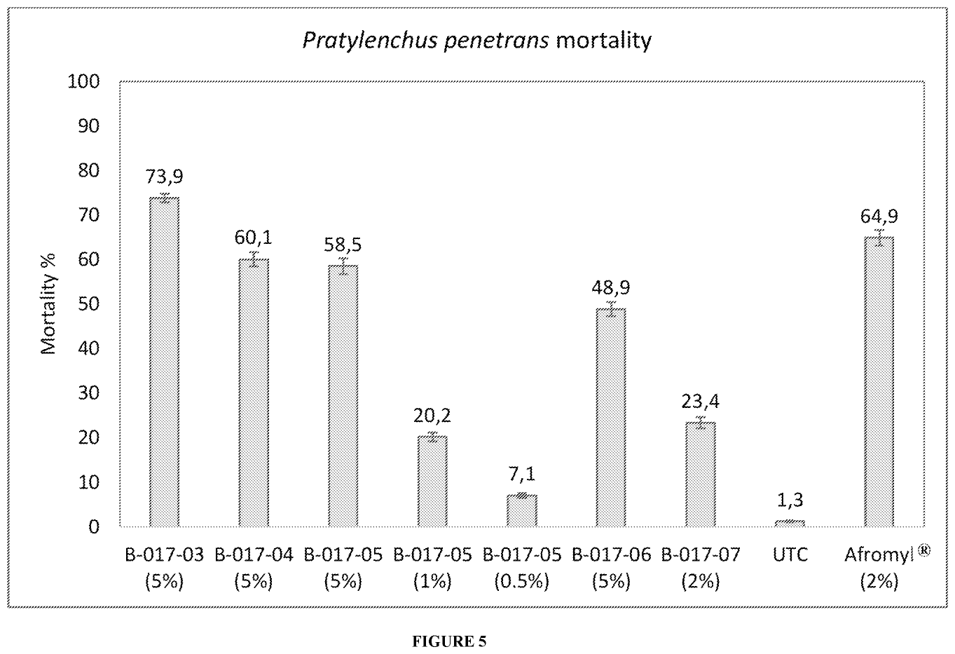

FIG. 5 shows the nematicidal effect of the various tested compositions. Pratylenchus penetrans mortality was highest at 73.9% in response to B-017-03, which contains UCCb made with lauryl lactate. B-017-04 which contains UCCc made with cetyl lactate and B-017-05 which contains UCCd (made with the mixture of lauryl lactate, cetyl lactate and myristyl lactate) caused a mortality of 60.1% and 58.5%, respectively. Reducing the concentration of B-017-05 to 1% and 0.5% resulted in significantly lower nematode mortality, as illustrated in FIG. 5, which characterizes a dose response effect.

B-017-06, contains a bacterial agent, Bacillus subtilis BS03 (GAT) that is different from the microbial used in the other compositions (Bacillus amyloliquefaciens). The efficacy of B-017-06 (48.9%) was significantly lower than all B. amyloliquefaciens compositions. Other strains of Bacillus subtilis and other species will be included in nematicidal tests in future.

Substituting salicylic acid with itaconic acid the efficacy was compromised in nematicidal control, as nematode mortality for B-017-07 was 23.4%. It is clear that the reduction in dosage from 5% to 2% affected the nematicidal control of composition B-017-07, even that the control of 23.4% can be considered promising considering the dosage used. Another set of trials is on going including similar dosages of itaconic acid and salicylic acid to evaluate both metabolites in same percentage and dosages.

The trial is considered valid as nematode mortality in the untreated control did not exceed 10%.

### Conclusions—

All (C₁₀-C₂₂) alkyl lactates tested demonstrate unique interactions with the other components forming a very well structured gel that keeps the microorganisms alive even in room temperatures, which is surprising and demonstrating a promising capability to increase shelf-life and performance of agronomical compositions such as insecticide, miticide, acaricide, ovicide, herbicide, fungicide, viricide, nematicide, nematistatic, insect growth regulator, plant grow regulator, elicitor or biostimulant, where the agronomical composition includes biological species or stand alone as an adjuvant.

### Complementary Fungicide Laboratory Trials

### Fungicide Disease Bio-Efficacy Screening

The work was conducted to evaluate the efficacy of the compositions of this disclosure as fungicide by testing its ability to inhibit the growth of selected fungus, namely Botrytis cinerea, Alternaria alternata, Monolinia fructicula and Fusarium graminearum. In a first set of tests the efficacy was evaluated using fungicide of different compositions made according to the present disclosure using different kinds of alkyl lactates, and also prior art product for a comparison and a negative control.

The different fungi were selected based on their spread and capability to induce diseases in crops.

Description of the work: Different dilutions of different variants of the composition according to the disclosure (specifically UCCa and UCCb loaded with microbial agents) were prepared and inoculated in the appropriate culture medium (potato dextrose agar) and exposed to the different fungus in their exponential growth phase in sterilized Petri dishes. After the incubation period, it was assessed the impact of each substance/concentration combination in the growth of fungus.

### Equipment:

Scale—The compositions, culture medium and necessary dilutions were prepared using a calibrated scale, brand Sartorius, model Quintix3102-1S.

Autoclave-All culture medium, prior to use, and biological waste generated was sterilized by autoclave, brand AJCosta, model UNICLVE 88.

Biological Safety Cabinet-All work that required sterilized conditions was performed inside a biological safety cabinet, brand EuroClone, model Safemate EZ 1.2.

Incubator—All plates were incubated at 25° C. in an incubator, brand Raypa, model DOD-90.

Samples tested: Different compositions made according to the present disclosure using different kind of alkyl lactates, prior art products and a negative control, as described in the table below.

TABLE 5
Samples identification

| code | Description of the samples |
|---|---|
| 0 | Water - negative control |
| 1 | Bacillus amyloliquefaciens (20%) and UCCa (80%) |
| 2 | Bacillus amyloliquefaciens (20%) and UCCb (80%) |
| 3 | Bacillus subtilis BS03 (20%) and UCCa (80%) |
| 4 | Competitor product Furatrop ® - a fungicide and/or nematicide |
| | product including Bacillus subtilis as its active |

The compositions above were diluted at 0.5% (w/w), 1% (w/w) and 5% (w/w) in water.

Disks were impregnated with each dilution of each composition and inserted, in triplicate on a petri dish with Potato Dextrose Agar (PDA).

PDA was the selected medium as it is a rich culture medium, that promotes the general growth of fungus, so that the fungus would not be subject to any other constrain in growing other than the exposure to the compositions in test.

Once dried, a cube of each of the fungus selected to perform this trial (Botrytis cinerea, Alternaria alternata, Monolinia fructicula and Fusarium graminearum), in its exponential growth phase, was inserted in the middle of the plate. The plates were incubated at 25° C., for 7 days.

After the incubation period the growth inhibition diameter, in millimeters, was measured in each plate.

### Results

The obtained results, in millimeters, for the growth inhibition diameter of Alternaria alternata, after incubation are demonstrated in Table 6, below.

TABLE 6
shows results of the growth inhibition diameter of Alternaria alternata,
after incubation, in mm, for each composition, at the concentrations tested.

| Composition | 0.5% w/w (mm) | | | | 1% w/w (mm) | | | | 5% w/w (mm) | | | |
|---|---|---|---|---|---|---|---|---|---|---|---|---|
| number | A* | B* | C* | Average | A* | B* | C* | Average | A* | B* | C* | Average |
| Control | 0 | | | | | | | | | | | |
| 1 | 20 | 18 | 20 | 19.3 | 23 | 20 | 20 | 21.0 | 22 | 22 | 20 | 21.3 |
| 2 | 22 | 18 | 18 | 19.3 | 21 | 22 | 21 | 21.3 | 20 | 23 | 22 | 21.7 |
| 3 | 19 | 19 | 17 | 18.3 | 20 | 21 | 21 | 20.7 | 23 | 19 | 22 | 21.3 |
| 4 | 20 | 17 | 18 | 18.3 | 21 | 22 | 21 | 21.3 | 23 | 19 | 23 | 21.7 |

* = A, B and C are replicates of each sample tested.

The obtained results, in millimeters, for the growth inhibition diameter of Botrytis cinerea, after incubation are demonstrated in Table 7, below.

TABLE 7
shows results of the growth inhibition diameter of Botrytis cinerea, after
incubation, in mm, for each composition, at the concentrations tested.

| Composition | 0.5% w/w (mm) | | | | 1% w/w (mm) | | | | 5% w/w (mm) | | | |
|---|---|---|---|---|---|---|---|---|---|---|---|---|
| number | A* | B* | C* | Average | A* | B* | C* | Average | A* | B* | C* | Average |
| Control | 0 | | | | | | | | | | | |
| 1 | 25 | 23 | 26 | 24.7 | 27 | 28 | 23 | 26.0 | 28 | 27 | 28 | 27.7 |
| 2 | 24 | 26 | 26 | 25.3 | 26 | 27 | 26 | 26.3 | 26 | 25 | 28 | 26.3 |
| 3 | 23 | 25 | 27 | 25.0 | 24 | 27 | 26 | 25.7 | 26 | 24 | 28 | 26.0 |
| 4 | 24 | 26 | 24 | 24.7 | 26 | 23 | 25 | 24.7 | 28 | 26 | 26 | 26.7 |

* = A, B and C are replicates of each sample tested.

The obtained results, in millimeters, for the growth inhibition diameter of Monolinia fructicula, after incubation are demonstrated in Table 8, below.

TABLE 8
shows results of the growth inhibition diameter of Monolinia fructicula,
after incubation, in mm, for each composition, at the concentrations tested.

| Composition | 0.5% w/w (mm) | | | | 1% w/w (mm) | | | | 5% w/w (mm) | | | |
|---|---|---|---|---|---|---|---|---|---|---|---|---|
| number | A* | B* | C* | Average | A* | B* | C* | Average | A | B* | C* | Average |
| Control | 0 | | | | | | | | | | | |
| 1 | 16 | 15 | 16 | 15.7 | 17 | 16 | 16 | 16.3 | 16 | 18 | 18 | 17.3 |
| 2 | 14 | 14 | 15 | 14.3 | 16 | 14 | 16 | 15.3 | 16 | 16 | 18 | 16.7 |
| 3 | 17 | 17 | 15 | 16.3 | 17 | 18 | 18 | 17.7 | 19 | 19 | 21 | 19.7 |
| 4 | 17 | 18 | 15 | 16.7 | 18 | 18 | 16 | 17.3 | 20 | 19 | 18 | 19.0 |

* = A, B and C are replicates of each sample tested.

The obtained results, in millimeters, for the growth inhibition diameter of Fusarium graminearum, after incubation are demonstrated in Table 9, below.

TABLE 9
shows results of the growth inhibition diameter of Fusarium graminearum,
after incubation, in mm, for each composition, at the concentrations tested.

| Composition | 0.5% w/w (mm) | | | | 1% w/w (mm) | | | | 5% w/w (mm) | | | |
|---|---|---|---|---|---|---|---|---|---|---|---|---|
| number | A* | B* | C* | Average | A* | B* | C* | Average | A* | B* | C* | Average |
| Control | 0 | | | | | | | | | | | |
| 1 | 33 | 36 | 32 | 33.7 | 34 | 36 | 36 | 35.3 | 36 | 38 | 38 | 37.3 |
| 2 | 36 | 33 | 34 | 34.3 | 33 | 33 | 36 | 34.0 | 36 | 32 | 36 | 34.7 |
| 3 | 31 | 31 | 32 | 31.3 | 33 | 32 | 34 | 33.0 | 34 | 34 | 34 | 34 |
| 4 | 32 | 32 | 35 | 33.0 | 35 | 34 | 31 | 33.3 | 35 | 35 | 33 | 34.3 |

* = A, B and C are replicates of each sample tested.

### Interpretation of Results

With the negative control (composition identified as 0) there was no obstacle for the fungus growth after the incubation so there was no growth inhibition for all the fungus tested.

For all the fungus tested, all the compositions presented significant inhibition of the fungus growth when compared with the negative control.

Table 10 presents the percentage of efficacy of each composition with relation to a registered biological product from the prior art (composition identified as 4) product based on Bacillus subtilis. The grade of dosage started in a low dosage of 0.5% to a higher concentration of 5%, for each composition and applied to each fungus in evaluation.

The average value obtained for the inhibition of growth for the standard reference of the prior art the higher tested dosage (at 5% w/w) was assumed as 100% the relative control (efficacy), and all other compositions averages were considered using the referred percentage of 100% from the standard reference applied at 5% w/w.

The average results for the remaining compositions tested at the different dosages and species are showed in Table 10.

TABLE 10
show relative % of efficacy of compositions made according to the present invention
using Bacillus amyloliquefaciens and Bacillus subtilis versus a registered
fungicide based on Bacillus subtilis in control of 4 agronomical fungi.

| | Fungi | | | | | | | | | | | |
|---|---|---|---|---|---|---|---|---|---|---|---|---|
| | Alternaria | | | Botrytis | | | Monolinia | | | Fusarium | | |
| | alternata | | | cinerea | | | fructicula | | | graminearum | | |
| Composition | 0.5% | 1% | 5% | 0.5% | 1% | 5% | 0.5% | 1% | 5% | 0.5% | 1% | 5% |
| number | w/w | w/w | w/w | w/W | w/w | w/w | w/w | w/w | w/w | w/w | w/w | w/w |
| 0 | 0 | | | | | | | | | | | |
| 1 | 89.2 | 96.9 | 98.5 | 92.5 | 97.5 | 103.8 | 82.5 | 86.0 | 91.2 | 98.1 | 102.9 | 108.7 |
| 2 | 89.2 | 98.5 | 100.0 | 95.0 | 98.8 | 98.8 | 75.4 | 80.7 | 87.7 | 100.0 | 99.0 | 101.0 |
| 3 | 84.6 | 95.4 | 98.5 | 93.8 | 96.3 | 97.5 | 86.0 | 93.0 | 103.5 | 91.3 | 96.1 | 99.0 |
| 4 | 84.6 | 98.5 | 100.0 | 92.5 | 92.5 | 100.0 | 83.3 | 91.2 | 100.0 | 96.1 | 97.1 | 100.0 |

### Considerations

Under the conditions used in this experiment, all compositions tested (1 to 4), excluding the negative control, showed similar efficacy in the inhibition of growth of the fungi Alternaria alternata, Botrytis cinerea, Fusarium graminearum and Monolinia Fructicula. Also, it was difficult to stablish a clear dose-response for the fungi tested, even using the low dosage 10 times less concentrate than the high dosage.

Despite the different species used in the composition 1 and 2 based on Bacillus amyloliquefaciens and the different alkyl lactate used in each of the three composition—the screening test clearly demonstrate that compositions 1 and 2 based on Bacillus amyloliquefaciens showed a slightly higher to similar performance against a commercial fungicide based on Bacillus subtilis.

In the case of control of Monolinia fructiculata there's a relative higher efficacy with the compositions 3 and 4 versus the compositions 1 and 2. It seems that Bacillus subtilis has a better efficacy versus Bacillus amyloliquefaciens controlling Monolinia fructiculata.

### Conclusion:

Under the conditions used in this in-vitro screening test, at all concentrations tested, all compositions presented inhibition of the fungus growth when compared with the negative control.

For the fungi Alternaria alternata, Botrytis cinerea and Fusarium graminearum the observed results were statistically similar for all four compositions tested, with a slightly better performance for the composition 1.

For the fungus Monolinia fructicula the observed results can suggest that Bacillus subtilis perform better than Bacillus amyloliquefaciens to control Monolinia fructicula. Composition 3 and 4 performed statistically better than composition 1 and 2. Composition 3 shows a slightly superior performance than composition 4 controlling Monolinia fructicula.

### Complementary Insecticidal Laboratory Trials

Evaluation of the contact toxicity of several Bacillus amyloliquefaciens compositions against red spider mite. Tetranychus urticae (Trombidiformes)
Location: Strand, South Africa
Pest: Red spider mite, Tetranychus urticae
Life stage: Adult females
Application method: Potter spray tower
Number of applications: 1
Objective: To test the efficacy of several Bacillus amyloliquefaciens compositions as a contact insecticide.

TABLE 11
Treatment list for laboratory bioassay trials.

| | | | Concentration |
|---|---|---|---|
| No. | Treatment | Product description | (L/100 L) |
| 1 | Untreated Control | — | — |
| 2 | Chemical standard: | Abamectin 18 g/L | 0.03 L/100 L + |
| | Agromectin ® + | D-limonene 60 g/L | 0.1 L/100 L |
| | Prev-aM ® | | |
| 3 | B-017-001 | Bacillus | 5 L/100 L |
| | | amyloliquefaciens | |
| | | (20%) + UCCa (80%) | |
| 4 | B-017-003 | Bacillus | 5 L/100 L |
| | | amyloliquefaciens | |
| | | (20%) + UCCb (80%) | |
| 5 | B-017-004 | Bacillus | 5 L/100 L |
| | | amyloliquefaciens | |
| | | (20%) + UCCc (80%) | |
| 6 | B-017-005 | Bacillus | 5 L/100 L |
| | | amyloliquefaciens | |
| | | (20%) + UCCd (80%) | |

Materials: Pipettes, Pipette tips, 50 mL glass beakers, 250 mL glass beakers, plastic droppers, deionised water, mixing spoons, weighing boats, marker pens, modified Petri dishes, cotton pads, 5 mL plastic syringes, 6 mL plastic syringes, tape, and cork borer.

### Study Animals & Maintenance

Adult females of T. urticae (Trombidiformes: Tetranychidae) were obtained from a laboratory colony maintained at Oro Agri SA, Strand, South Africa. The colony is reared on runner beans and kept at a constant temperature of 25° C. and 12:12 L:D photoperiod.

### Laboratory Bioassays

Petri dishes with modified lids were used to house the mites during applications and for the duration of the trial. The lids were modified to include a square of mesh to lower the relative humidity in the Petri dish. One cotton pad was placed in each Petri dish and wetted with 10 mL water. Leaf disks (2.2 cm diameter) were cut from bean plants using a cork borer and placed on the wet cotton pads to keep them turgid. Two leaf disks were placed on each cotton pad to serve as a food source for the mites. Disks were placed with the underside facing upwards, as the mites mostly feed on the underside of leaves. Five adult female mites were placed on each leaf disk, and five Petri dishes were used per treatment (i.e. 50 mites per treatment). After treatment applications, individuals were left in their respective Petri dishes for mortality and morbidity assessment for the duration of the trial.

TABLE 12
Product volumes for pipetting.

| | | Concentration | Water | Product | |
|---|---|---|---|---|---|
| Number | Treatment | (% v/v) | volume | volume (mL) | |
| 2 | Chemical standard: | 0.03% + | 250 mL | 0.075 | mL |
| | Agromectin ® + | 0.1% | | 0.25 | mL |
| | Prev-aM ® | | | | |
| 3 | B-017-001 | 5% | 250 mL | 12.5 | mL |
| 4 | B-017-003 | 5% | 250 mL | 12.5 | mL |
| 5 | B-017-004 | 5% | 250 mL | 12.5 | mL |
| 6 | B-017-005 | 5% | 250 mL | 12.5 | mL |

### Treatment Application

A Potter spray tower (Potter Precision Laboratory Spray Tower, Burkard Scientific) was used for all treatment applications. The Potter tower was calibrated to 5 mL solution, equivalent to 415 L/ha (see ZA 2015 Potter Tower Spray Volume). To apply the treatments, the Petri dish with the mites was placed on the Potter tower's platform and sprayed once with 5 mL of the desired treatment (at a pressure of 0.6 Bar). After application the Petri dishes were stored in a temperature-controlled room at a constant temperature of 25° C.

### Mortality & Morbidity Assessment

Mortality and morbidity were assessed 24 and 48 hours post application. Mites were considered dead if there was no movement of the legs after 10 seconds when prodded with a fine paint brush. Morbidity was defined as when you can see that an individual is no longer healthy, but not yet dead (i.e. movement of the legs is still visible).

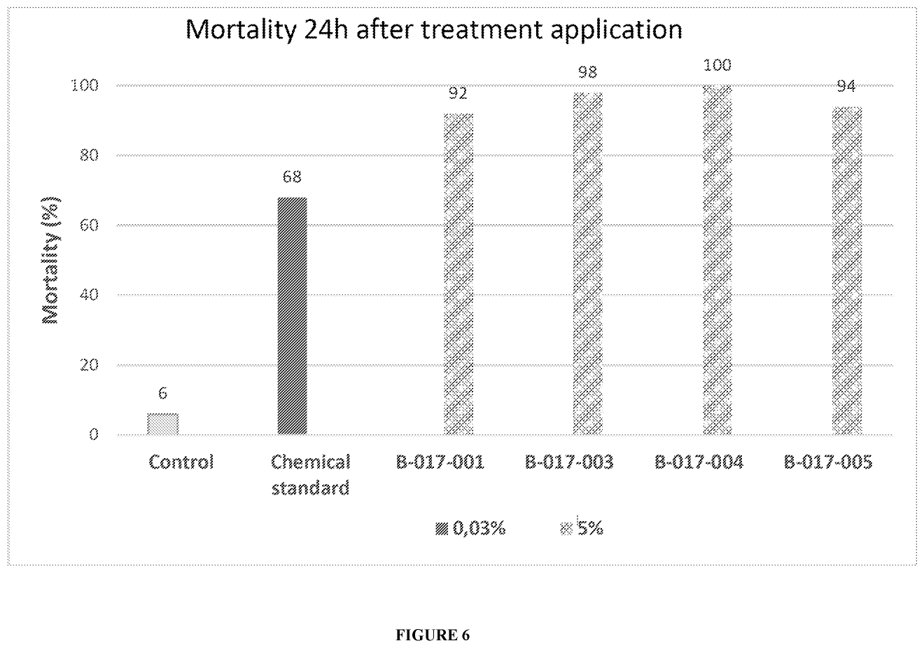

FIG. 6 shows the percentage of mites that were dead 24 hours after treatment application was made.

Statistical Analyses—Mortality 24 h after Treatment Application

The statistical package PAST was used for all statistical analyses.

A Shapiro-Wilk test was run and indicated that the data are not normally distributed (p<0.05). Therefore, rather than using an ANOVA to analyze the data, a Kruskal-Wallis test was run. This test indicated that there are significant differences between the treatments (p<0.0001).

A post-hoc Mann-Whitney comparison was then run to distinguish which of the treatments differ significantly from each other. The test showed that all treatments were significantly better than the control group (i.e. resulting in significantly higher mortality) (see Table 13 and FIG. 6). The following treatments were also significantly better than the chemical standard, resulting in higher mortality: B-017-003, B-017-004 and B-017-005 (see Table 13 and FIG. 6).

TABLE 13
shows results from the Mann-Whitney test for the mortality
data 24 hours after treatment application. Significant differences
(p < 0.05) are indicated in red font and bold type.

| | | Chemical | B-017- | B-017- | B-017- | B-017- |
|---|---|---|---|---|---|---|
| | Control | standard | 001 | 003 | 004 | 005 |
| Control | | 0.010910 | 0.010180 | 0.008784 | 0.006694 | 0.009937 |
| Chemical | 0.010910 | | 0.054700 | 0.012610 | 0.007290 | 0.022740 |
| standard | | | | | | |
| B-017-001 | 0.010180 | 0.054700 | | 0.518600 | 0.179700 | 0.908100 |
| B-017-003 | 0.008784 | 0.012610 | 0.518600 | | 0.423700 | 0.270300 |
| B-017-004 | 0.006694 | 0.007290 | 0.179700 | 0.423700 | | 0.066800 |
| B-017-005 | 0.009937 | 0.022740 | 0.908100 | 0.270300 | 0.066800 | |

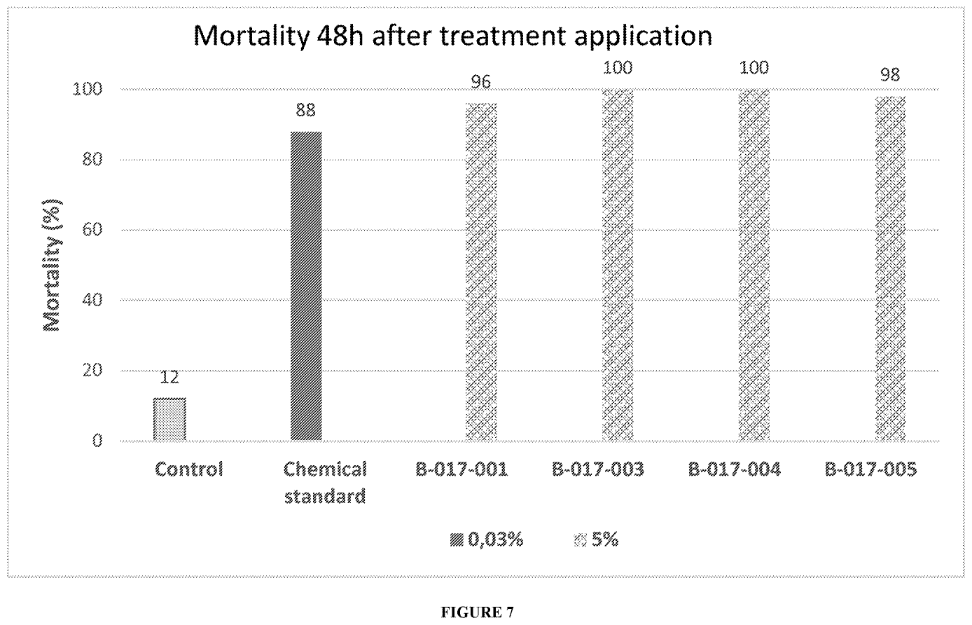

FIG. 7 shows the percentage of mites that were dead 48 hours after treatment application was made.

Statistical Analyses—Mortality 48 h after Treatment Application

The statistical package PAST was used for all statistical analyses.

A Shapiro-Wilk test was run and indicated that the data are not normally distributed (p<0.05). Therefore, rather than using an ANOVA to analyse the data, a Kruskal-Wallis test was run. This test indicated that there are significant differences between the treatments (p<0.001).

A post-hoc Mann-Whitney comparison was then run to distinguish which of the treatments differ significantly from each other. The test showed that all treatments were significantly better than the control group (i.e. resulting in significantly higher mortality) (see table 4).

TABLE 14
shows results from the Mann-Whitney test for the mortality
data 48 hours after treatment application. Significant differences
(p < 0.05) are indicated in red font and bold type.

| | | Chemical | B-017- | B-017- | B-017- | B-017- |
|---|---|---|---|---|---|---|
| | Control | standard | 001 | 003 | 004 | 005 |
| Control | | 0.010420 | 0.008562 | 0.006502 | 0.006502 | 0.008562 |
| Chemical | 0.010420 | | 0.344700 | 0.070700 | 0.070700 | 0.232000 |
| standard | | | | | | |
| B-017-001 | 0.008562 | 0.344700 | | 0.423700 | 0.423700 | 1.000000 |
| B-017-003 | 0.006502 | 0.070700 | 0.423700 | | 1.000000 | 0.423700 |
| B-017-004 | 0.006502 | 0.070700 | 0.423700 | 1.000000 | | 0.423700 |
| B-017-005 | 0.008562 | 0.232000 | 1.000000 | 0.423700 | 0.423700 | |

### Discussion & Conclusions

The results showed that the four different compositions that were tested (see Table 14: B-017-001; B-017-003; B-017-004; B-017-005) for efficacy against red spider mite, all resulted in significantly higher mortality when compared to the control group, both 24 and 48 hours after the treatment applications were made (see Tables 13 & 14 and FIGS. 6 and 7).

It can be concluded that all four tested compositions (B-017-001, B-017-003, B-017-004 and B-017-005) do have a significant effect on mites when applied as a contact insecticide/acaricide. All four compositions were effective against red spider mite, resulting in significantly higher mortality compared to the control group.

There is a need to confirm use of the agricultural carrier composition of the disclosure together with other species of bacteria to provide loaded agricultural carrier compositions provided as an insecticide and/or an acaricide. The use of entomopathogenic fungi in different specialized gel bases (UCC and/or UCCa and/or UCCb and/or UCCc and/or UCCd and/or UCCe) to enhance efficacy will be tested using a series of trials on various insects. Insect pests used as model organisms for efficacy screening will be used at the Oro Agri facility in South Africa and also in Portugal. The elected pest are at least a) Tetranychus urticae (Trombidiformes)—Red spider mite; b) Planococcus ficus—Vine mealybug; c) Bathycoelia distincta (Hemiptera)—Two-spotted Stinkbug. For each target at least one trial will be carried out for each of the entomopathogenic fungi: Beauvaria bassiana and Metarhizium anisopilae. Chemical standard and biological standard will be used as comparison of efficacy and control.

### Example 2

### Nematicide Field Trials

Pot trials were carried out under controlled conditions in the Grow Rooms at the Oro Agri South Africa facility in Strand, South Africa. All trials in the grow rooms are equipped with artificial lighting suited for plant growth, air-conditioning systems and irrigation systems.

TABLE 15
Field trial - Location, crop variety and details of treatment

| | |
|---|---|
| Crop: | Tomatoes |
| Variety: | Floradade |
| Irrigation: | Hand irrigation - daily irrigation |
| Growing media: | Fumigated (Telopic) Malmesbury sand |

### Materials and Methods

### Description of the Experimental Design and Trial Layout

The trial consists of six treatments with five replicates each. All the pots were filled with the same soil mixture and tomato plants were planted; one plant per pot. Nematodes for inoculating the soil were obtained from the ARC in Stellenbosch. The nematodes were Meloidogyne javanica and they were applied as a drench (100 mL) to each pot around the base of the plants at 3555 egg/J2's per pot. Product treatments were applied four days later also as a soil drench treatment.

### Pruning of Tomatoes

Plants will be pruned according to Laboratory method M059. Pruning of tomato plants will be done when plants are at least 15 cm in height. Pruning shears will be used to cut the main stems 1 cm above the second or third true leaves of each plant to stimulate the growth of lateral buds.

### Microbial Inoculation

As the products being applied in this trial as treatments are mainly nematistats the soil needs to have a microbial population in order to simulate the microbe nematode interactions.

An application of a microbial inoculant was therefore applied to all the treatments to simulate this effect. The microbial inoculant is a consortium of 21 microbe species with some species having multiple strains, making a total of 31 strains. This is a commercial product with a 2 L/ha field application rate. The microbial inoculant was applied four days before inoculation with the nematodes.

### Nematode Inoculation

Nematode inoculation was done four days before product treatment at 3555 egg/J2's per pot. This is a slightly lower inoculation rate than desired as the nematode population was not adequate. Three holes with a diameter of 5 mm and 3.5 cm deep were made around the plant in which the 5 mL of inoculum solution was applied. The holes were closed immediately. Soil was sufficiently moist before inoculation.

### Parameters Measured

TABLE 16
indicates measured parameters

| | | Replications/ | |
|---|---|---|---|
| | Method/equipment | number | |
| Parameter | used | of samples | Sampling Time |
| Root biomass | Weighing (wet mass) | 5 | At termination |
| Root galling | Galling Index | 5 | At termination |
| Nematode root | Extraction of eggs | 5 | At termination |
| extraction | and J2 from roots* | | |
| Soil extraction | Sieving 150micron | 5 | At termination |
| | extraction* | | |

*and Sugar Flotatio

TABLE 17
Treatment table

| | | | | | | | | mL of |
|---|---|---|---|---|---|---|---|---|
| | | | | | | | | product in |
| | | | | | | | | application |
| | | | | | Nematode | Microbial | | solution of |
| | | | | | inoculum | inoculum | Rate of | 1 L (apply |
| | | | | | (eggs/J2's | (mL | product | 100 mL of |
| | | Application | | Product | per 5 | product | per pot | this solution |
| Treatment | Product | Rate | | description | mL)/pot | per pot) | (mL) | per pot) |
| A | Untreated (+) | — | — | — | 3555 | — | — | — |
| B | Untreated (−) | — | — | — | — | — | — | — |
| E | OR-501x | 0.1 | % | Bacillus | 3555 | 0.0088 | 0.351 | 3.51 |
| | | | | amyloliquefaciens + | | | | |
| | | | | UCCa | | | | |
| F | OR-501y | 0.01 | % | Bacillus | 3555 | 0.0088 | 0.0351 | 0.351 |
| | | | | amyloliquefaciens + | | | | |
| | | | | UCCa | | | | |
| G | OR-454 | 0.1 | % | Experimental - | 3555 | 0.0088 | 0.351 | 3.51 |
| | | | | based on zinc | | | | |
| | | | | and cobalt | | | | |
| H | GT | 0.1 | % | Experimental - | 3555 | 0.0088 | 0.351 | 3.51 |
| | | | | based on | | | | |
| | | | | terpenoids | | | | |

### Results

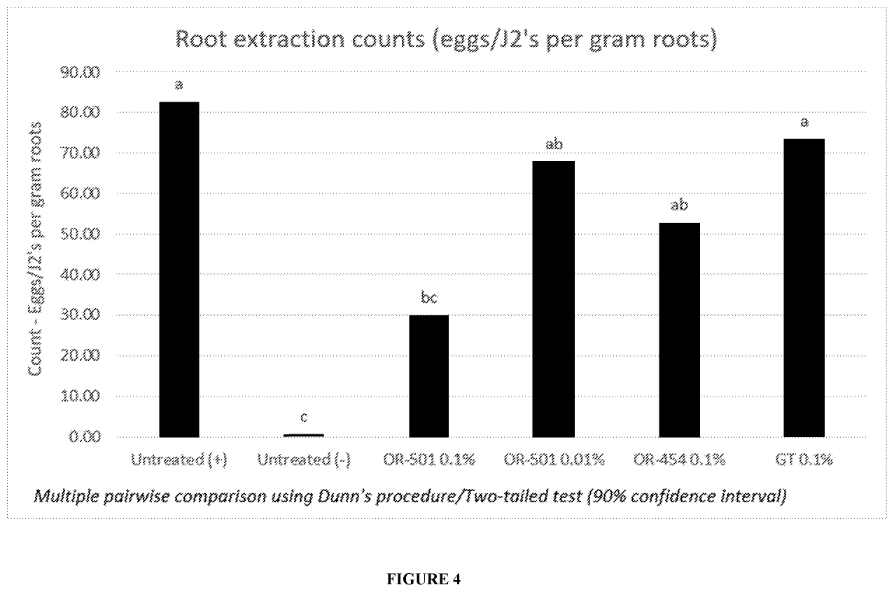

FIG. 4 Root extraction counts-number of eggs and second stage juveniles per gram of roots.

### Discussion and Conclusion

The results for the Root extraction are shown in FIG. 4. The data shows that the OR-501x and OR-501y at 0.1% was significantly lower than the (+) Untreated; nematode incidence in the roots was significantly lower as a result of the treatment. The OR-501x and OR-501y at the lower rate of 0.01% was less effective than at 0.1% concentration. All other treatments were numerically lower than the Untreated. There was a very low level of contamination in the (−) Untreated.

These results are promising as this is a significant reduction in nematode numbers considering that the product is not a direct nematicide but only an antagonist. More trials are needed to establish efficacy and to examine ideal application rates.

Examples 1 and 2 show the compositions according to this disclosure being effective nematicides, insecticides and fungicides. The Applicant envisages conducting further detailed experiments to show that the compositions are effective plant protection products in general terms.

The Applicant submits that the agricultural compositions and/or agricultural carrier compositions (loaded/unloaded) ameliorate at least one disadvantage known in the prior art.

### Example 3

### Direct Method for Bacterial Quantification-Shelf-Life Test

### Equipment

Scale—The compositions, culture medium and necessary dilutions should be prepared using a calibrated scale. The brand of the one used at Palmela facilities is Sartorius, model Quintix3102-1S.

Autoclave—All culture medium, prior to use, and biological waste generated should be sterilized by autoclave. The brand of the one used at Palmela facilities is AJCosta, model UNICLVE 88.

Biological Safety Cabinet—All work that required sterilized conditions should be performed inside a biological safety cabinet. The brand of the one used at Palmela facilities is AJCosta EuroClone, model Safemate EZ 1.2.

Incubator—All plates should be incubated at proper temperatures based on the microorganism of interest in the quantification. As of a general rule, 35° C. is the selected temperature for the most common bacteria. The brand of the incubator used at Palmela facilities is Raypa, model DOD-90.

### Method

The direct method of quantification of bacteria by plating a predetermined quantity of sample has the advantage of its high sensitivity. This method is based on the principle that every viable microorganism will reproduce and yield a visible colony. It is believed that each single bacteria cell in a sample, once spread, will develop one visible colony.

Serial dilutions of the sample of interest should be performed based on the expected value of CFUs of the original sample, to have between 30 and 300 colonies per plate.

In case of a sample with a theoretical value of 2×10⁹ CFU/mL the serial dilutions should be performed up to 10-7 and 100 μL of the relevant dilutions is spread in petri dish with a non-selective agar medium, such as Tryptic Soy Agar (TSA).

At least two independent serial dilutions should be performed. The spread into petri dishes of each relevant dilution of each independent preparation should be performed in triplicate.

Based on the expected amount of CFU/mL in the original, non-diluted samples, the relevant dilutions (in triplicate) to spread into petri dishes are the ideal one which is the one that would retrieve an amount between 30 to 300 colonies per plate, and the ones just above and below, to account for any variation in the actual number versus the theoretical one.

Taking into consideration the case of the 2×10⁹ CFU/mL and the fact 100 μL of the relevant dilution is spread in the petri dish, the ideal dilution to spread in the petri dishes is 10-6, which would theoretically, after the incubation period present 200 CFU/plate. The other two dilutions to spread into petri dishes should be 100 μL of the dilution 10-5 (in triplicate) and 100 μL of the dilution 10-7.

After plating, the petri dishes should be incubated for 24 h at the more suitable incubation period and the number of colonies in each plate counted.

### Samples Identification:

TABLE 18
Treatment list for laboratory shelf-life trials.

| | | | | Initial |
|---|---|---|---|---|
| | | | | Concentration |
| Code | Product description | Batch number | Production date | (CFU/g or mL |
| OR-501 | Bacillus amyloliquefaciens | 50120210709 | 7 Sep. 2021 | 2.10 × 10⁹ |
| (also B-017-001 | (20%) + UCCa (80%) | | | |
| or ORO-501) | | | | |
| OR-501 | Bacillus amyloliquefaciens | 50120221011 | 11 Oct. 2022 | 2.20 × 10⁹ |
| (also B-017-001 | (20%) + UCCa (80%) | | | |
| or ORO-501) | | | | |
| B-017-002 | Pseudomonas fluorescens | 22072601700201 | 26 Jul. 2022 | 2.05 × 10⁸ |
| | (20%) + UCCa (80%) | | | |
| B-017-003 | Bacillus amyloliquefaciens | 2211300170301 | 30 Nov. 2022 | 2.06 × 10⁹ |
| | (20%) + UCCb (80%) | | | |
| B-017-004 | Bacillus amyloliquefaciens | 2211300170401 | 30 Nov. 2022 | 2.04 × 10⁹ |
| | (20%) + UCCc (80%) | | | |
| B-017-005 | Bacillus amyloliquefaciens | 2211300170501 | 30 Nov. 2022 | 2.04 × 10⁹ |
| | (20%) + UCCd (80%) | | | |
| B-017-006 | Bacillus subtilis (20%) + | 2211300170601 | 30 Nov. 2022 | 2.16 × 10⁹ |
| | UCCa (80%) | | | |
| B-017-007 | Bacillus amyloliquefaciens | 2302030170701 | 2 Mar. 2023 | 2.06 × 10⁹ |
| | (20%) + UCCe (80%) | | | |
| B-017-008 | B. amyloliquefaciens (10%) + | 2302030170801 | 2 Mar. 2023 | 2.07 × 10⁹ |
| | B, thuringiensis (10%) + UCCa | | | |
| | (80%) | | | |
| B-017-009 | (B. subtilis + B. megaterium + | 2302030170901 | 2 Mar. 2023 | 2.06 × 10⁹ |
| | B. amyloliquefaciens) | | | |
| | 20% + UCCa (80%) | | | |
| B-017-010 | Trichoderma harzianum | 2302030171001 | 2 Mar. 2023 | 2.12 × 10⁹ |
| | (10%) + B. amyloliquefaciens | | | |
| | (10%) + UCCd (80%) | | | |

Shelf-life tests are ongoing in several labs of the company, in Palmela—Portugal, in Valencia—Spain, in Strand—South Africa, in São Paulo—Brazil and Fresno—USA, including third part laboratories, using the gel based on alkyl lactates as a carrier for biologicals and the like.

### Results

TABLE 19
shows results of number of bacterium or colonies alive in CFU/mL per
strain of microorganism per time expressed as CFUs reduction (in %)

| | | | | | | | | | CFUs |
|---|---|---|---|---|---|---|---|---|---|
| | Production | Analysis | | | pH | | | | reduction |
| Batch | Date | Date | Aspect | Colour | (direct) | density | viscosity | CFU/mL | (%) |
| 50120210709 | 9 Jul. 2021 | 9 Jul. 2021 | Turbid | Brown | 4.56 | 1.001 | 20.67 P | — | — |
| 50120210709 | 9 Jul. 2021 | 11 Jul. 2021 | Turbid | Brown | 4.56 | 1.001 | 20.67 P | 2.10 × 10⁹ | 100% |
| 50120210709 | 9 Jul. 2021 | 1 Jun. 2022 | Turbid | Brown | 4.57 | 1.002 | 20.69 P | 1.96 × 10⁹ | 93.3% |
| 50120210709 | 9 Jul. 2021 | 26 Jul. 2022 | Turbid | Brown | 4.57 | 1.002 | 20.70 P | 2.06 × 10⁹ | 98.1% |
| 50120210709 | 9 Jul. 2021 | 22 Feb. 2023 | Turbid | Brown | 4.57 | 1.001 | 20.71 P | 1.93 × 10⁹ | 91.9% |
| 50120221011 | 11 Oct. 2022 | 11 Oct. 2022 | Turbid | Brown | 4.63 | 1.004 | 20.83 P | — | — |
| 50120221011 | 11 Oct. 2022 | 13 Oct. 2022 | Turbid | Brown | 4.63 | 1.004 | 20.85 P | 2.20 × 10⁹ | 100% |
| 50120221011 | 11 Oct. 2022 | 22 Feb. 2023 | Turbid | Brown | 4.62 | 1.003 | 20.83 P | 2.15 × 10⁹ | 97.7% |
| 22072601700201 | 26 Jul. 2022 | 28 Jul. 2022 | Turbid | Brown | 4.48 | 1.002 | 18.52 P | 2.05 × 10⁸ | 100% |
| 22072601700201 | 26 Jul. 2022 | 22 Feb. 2023 | Turbid | Brown | 4.5 | 1.002 | 18.55 P | 1.92 × 10⁸ | 93.7% |
| 2211300170301 | 30 Nov. 2022 | 30 Nov. 2022 | Turbid | beige | 4.76 | 1.006 | 63.55 P | 2.06 × 10⁹ | 100% |
| 2211300170301 | 30 Nov. 2022 | 22 Feb. 2023 | Turbid | beige | 4.78 | 1.008 | 63.61 P | 2.08 × 10⁹ | 101% |
| 2211300170401 | 30 Nov. 2022 | 30 Nov. 2022 | Turbid | light | 4.32 | 1.003 | 16.53 P | 2.04 × 10⁹ | 100% |
| | | | | brown | | | | | |
| 2211300170401 | 30 Nov. 2022 | 22 Feb. 2023 | Turbid | light | 4.33 | 1.003 | 16.57 P | 2.01 × 10⁹ | 98.5% |
| | | | | brown | | | | | |
| 2211300170501 | 30 Nov. 2022 | 30 Nov. 2022 | Turbid | light | 4.45 | 1.005 | 18.26 P | 2.04 × 10⁹ | 100% |
| | | | | brown | | | | | |
| 2211300170501 | 30 Nov. 2022 | 22 Feb. 2023 | Turbid | light | 4.45 | 1.005 | 18.27 P | 2.03 × 10⁹ | 99.5% |
| | | | | brown | | | | | |
| 22121201700601 | 12 Dec. 2022 | 12 Dec. 2022 | Turbid | beige | 4.61 | 1.006 | 19.81 P | 2.16 × 10⁹ | 100% |
| | | | | to light | | | | | |
| | | | | brown | | | | | |
| 22121201700601 | 12 Dec. 2022 | 22 Feb. 2023 | Turbid | beige | 4.63 | 1.006 | 19.84 P | 2.10 × 10⁹ | 97.2% |
| | | | | to light | | | | | |
| | | | | brown | | | | | |
| 23020301700701 | 2 Mar. 2023 | 2 Mar. 2023 | Turbid | Brown | 4.81 | 1.003 | 17.41 P | 2.06 × 10⁹ | 100% |
| 23020301700701 | 2 Mar. 2023 | 2 Mar. 2023 | Turbid | Brown | 4.81 | 1.003 | 17.62 P | 2.02 × 10⁹ | 98.0% |
| 23020301700801 | 2 Mar. 2023 | 2 Mar. 2023 | Turbid | brown | 4.71 | 1.004 | 20.44 P | 2.07 × 10⁹ | 100% |
| 23020301700801 | 2 Mar. 2023 | 17 Mar. 2023 | Turbid | brown | 4.75 | 1.004 | 20.70 P | 2.07 × 10⁹ | 100% |
| 23020301700901 | 2 Mar. 2023 | 2 Mar. 2023 | Turbid | brown | 4.88 | 1.007 | 18.66 P | 2.06 × 10⁹ | 100% |
| 23020301700901 | 2 Mar. 2023 | 17 Mar. 2023 | Turbid | brown | 4.84 | 1.007 | 18.90 P | 2.07 × 10⁹ | 100.5% |
| 23020301701001 | 2 Mar. 2023 | 2 Mar. 2023 | Turbid | light | 4.94 | 1.004 | 20.55 P | 2.12 × 10⁹ | 100% |
| | | | | brown | | | | | |
| 23020301701001 | 2 Mar. 2023 | 17 Mar. 2023 | Turbid | light | 4.96 | 1.004 | 20.82 P | 2.14 × 10⁹ | 100.9% |
| | | | | brown | | | | | |

### Comments

The batch 50120210709, is already 19 months old, and as can be observed from the results the CFU/mL of the bacteria remained stable over time in room temperature (23° C.+−3° C.). The other batches, although more recent, also show a bacterium or colony counting stable over time in room temperature.

The desirable time for a stable bacterium or colony counting stable is at least 30 months but the test will be performed until 36 months as an outstanding goal, if the counting keep inside the range of +−20% of the initial number of bacterium or colony.

Other batches of compositions made according to the present application are also running the shelf-life test at room temperature, the compositions were made with isolated species and also with mixtures with at least the following microorganisms: Bacillus subtilis sp., Bacillus amyloliquefaciens sp., Bacillus firmus sp., Bacillus thuringiensis sp., Bacillus simplex sp., Bacillus licheniformis sp., Bacillus velezensis sp., Pseudomonas fluorescens sp., Pseudomonas protegeans sp., Tricoderma harzianum sp., Tricoderma asperellum sp., Paecilomyces lilacinus sp, and Beauveria bassiana sp.

It is known that current plant protection products and/or biocontrol agents that include microorganism often have a limited shelf-life. The Applicant was surprised that the compositions according to this disclosure showed prolonged shelf-life such that the microorganisms did not die and rot within a typical period known in the art.

The Applicant was also surprised at the longevity of the shelf-life of the compositions according to this disclosure. Furthermore, the compositions did not show phase separation and remained stable for prolonged periods of time.

### Example 4

Embodiments of the disclosure for use as a nematicidal and/or nematistatic agrochemical product.

OR-501 (pLCC also OR-N-6) was applied through the drip irrigation system in the root zone on tomato plants cultivated under greenhouse. The trial was conducted on tomato cultivated in a soil artificially inoculated with Meloidogyne incognita eggs and J2 to ensure a homogenous target nematode population and reliability of the results.

Treatments under test are summarized in Table 20 and application timing, date and method in table 21.

TABLE 20
shows a table of treatments

| Treatment | A.I. - Concentration - | Dose | Application |
|---|---|---|---|
| name | Composition type | rate | code |
| Untreated | — | — | — |
| control | | | |
| (UTC) | | | |
| OLREDY | Oxamyl - 10% - SL | 10 L/ha | ACE |
| OR-501 | pLCC [Bacillus | 10 L/ha | ABC |
| | amyloliquefaciens + UCCa] | | |

TABLE 21
shows timing of applications

| Application | | Application | Application |
|---|---|---|---|
| code | Application timing | date | method |
| A | 3 days after | 8 Nov. 2022 | Drip irrigation |
| | transplant - BBCH 13 | | |
| B | BBCH 13 | 15 Nov. 2022 | Drip irrigation |
| C | BBCH 15 | 25 Nov. 2022 | Drip irrigation |
| E | BBCH 22 | 15 Dec. 2022 | Drip irrigation |

### Experimental Setup and Trial Methodology

The trial was implemented using a Randomized Complete Block design with 4 replications and individual plot size of 12 m² (6 m×2 m) including 24 plants (2 rows).

The days before transplanting tomato plants, the soil was artificially inoculated with 42163 eggs+J2 of Meloidogyne incognita per plant.

The applications of all products under test were conducted through the drip irrigation system on the planting row (products applied directly to the root zone). The total irrigation water volume used to perform the applications was 20000 L/ha, in practice, the application was performed according to the following sequence:
1. 8000 L/ha of water were applied to moist the soil to ensure an adequate placement of the products through the area of the future root system
2. Products were diluted into 10000 L/ha of water to ensure homogeneous distribution in the future root zone
3. 8000 L/ha of water were applied to clean the irrigation lines and seal the irrigation bulb

The following assessments were performed throughout the trial:
Evaluation of the root galling severity by visual assessment of the plant root systems according to the Bridge and Page 1980, modified Root-knot index (0-10):

TABLE 22
shows a scale of evaluation of the root system damaged

| code | Description - evaluation of root system |
|---|---|
| 0. | Complete and healthy root system, no infection |
| 1. | Very few small galls can only be detected upon close |
| | examination |
| 2. | Small galls/knot only but clearly visible main root clean |
| 3. | Some larger knot visible, main root clean |
| 4. | Larger knot predominate but main root clean |
| 5. | 50% of roots infected, knotting on some main roots, |
| | reduced root system |
| 6. | Knotting on main roots |
| 7. | Majority of main roots knotted |
| 8. | All main roots, including tap root, knotted, and few |
| | clean root visible |
| 9. | All roots severely knotted, and plant usually dying |
| 10. | All roots severely knotted, no root system, and |
| | plants usually dead |

Nematode counts in soil: number of Meloidogyne incognita J2 in 100 cc of soil

Yield was measured at several consecutive harvests and the total fruit production (from all harvests) was calculated and expressed in:
a Total yield in T/ha
b Total number of fruits/ha
c Mean fruit weight (g/fruit)
d Phytotoxicity was assessed visually according to % of severity

### Results

The results obtained with each of the main variables recorded in the trial are presented hereunder.

### Root Galling Severity:

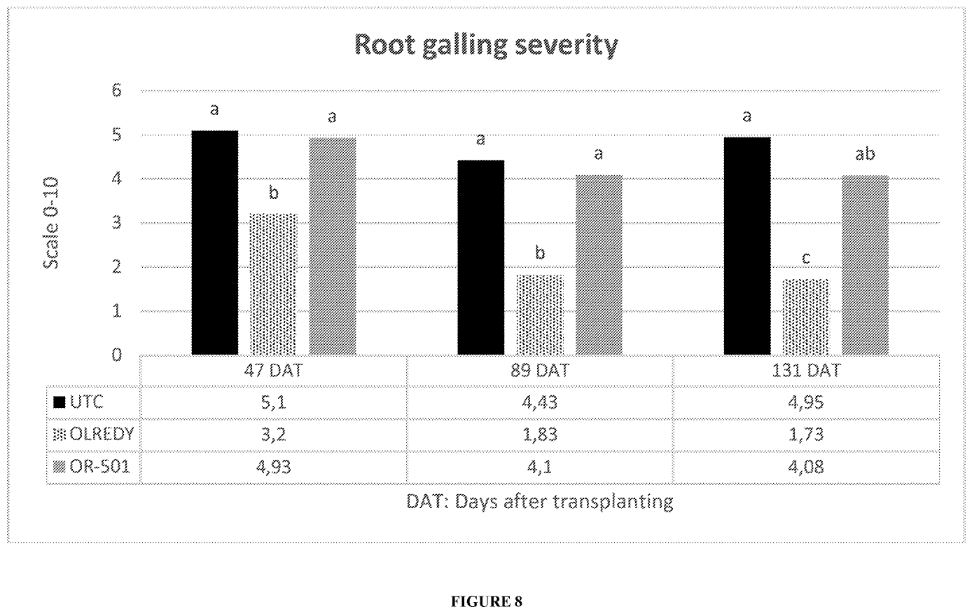

FIG. 8 shows the root galling severity assessed visually throughout the trial (at 47, 89 and 131 days after transplanting) in the different treatments.

The untreated plants presented a moderate knotting severity with values ranging from 4.43 (89 DAT) to 5.1 (47 DAT) depending on the assessment date. The standard reference OLREDY significantly reduced the knotting severity compared to the control at all 3 assessment dates. OR-501 achieved a numerical reduction of the knotting severity in comparison to the control.

### Nematode Population in Soil:

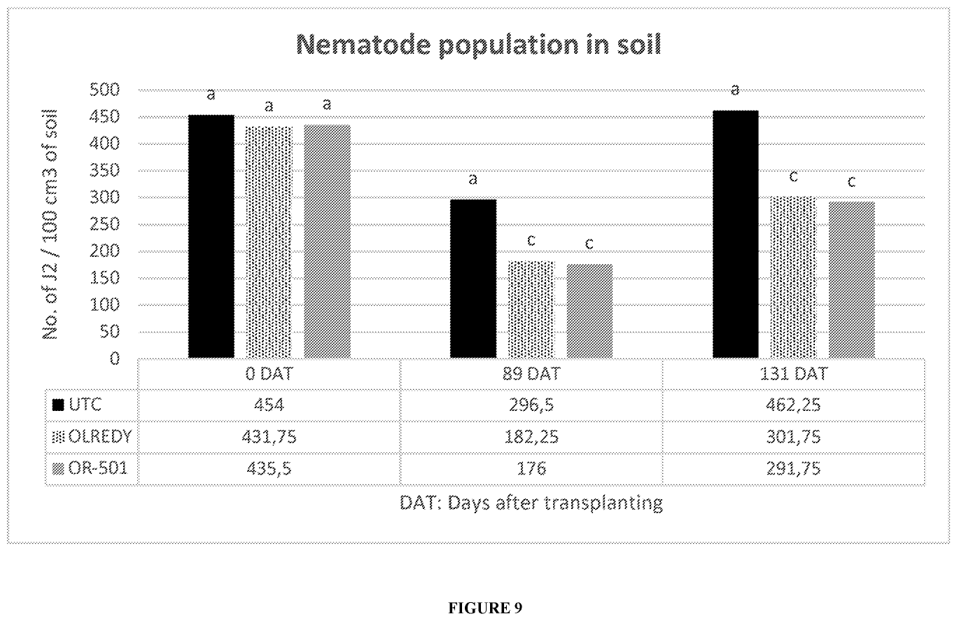

FIG. 9 shows the nematode population (number of J2/100 cm3 of soil) counted in the soil samples collected throughout the trial. Soil samples were collected at 3 different timings:
0 DAT: to check the sufficient and homogeneous nematode population before the 1st application
89 and 131 DAT: to assess the evolution of the number of nematodes in the soil following the application of the products

At the start of the trial, before the 1st application all treatments showed statistically equivalent nematode populations in soil with values ranging from 431 to 454 J2/100 cm3 of soil depending on the treatment.

Both the standard reference OLREDY and OR-501 significantly reduced the nematode population compared to the control at both assessment dates (89 and 131 DAT). OLREDY and OR-501 presented statistically and numerically equivalent results.

### Fruit Production:

At the end of the trial, the total tomato production was recorded for each treatment.

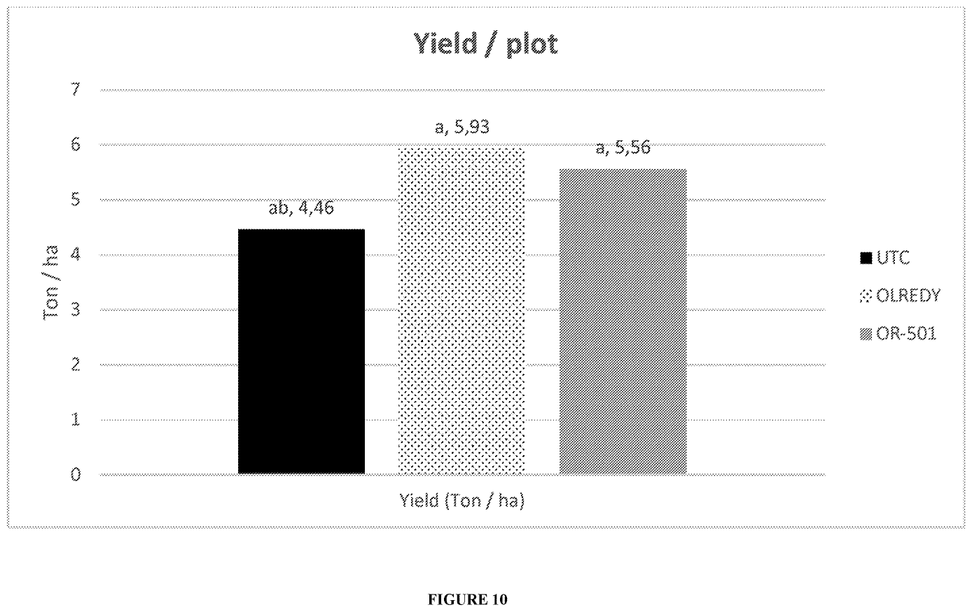

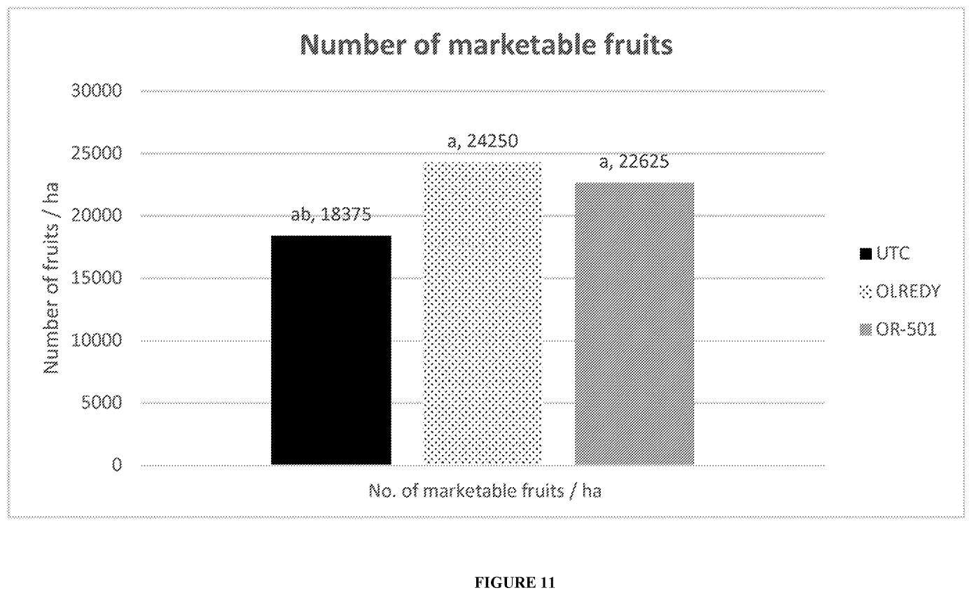

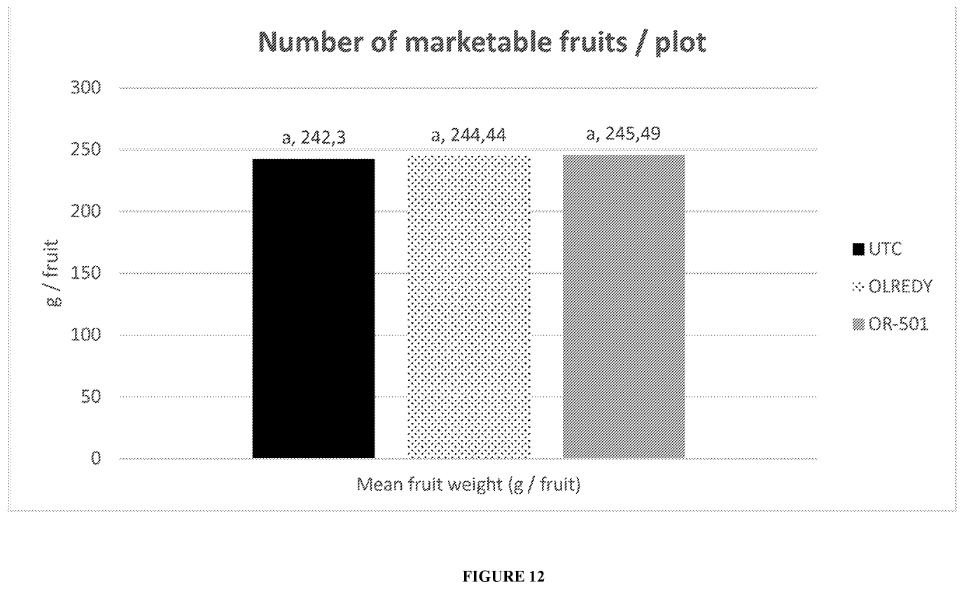

FIGS. 10, 11 and 12 show the different parameters recorded to evaluate the tomato production:
FIG. 10 presents the total production (Yield) of the different treatments in Ton/ha
FIG. 11 presents the total number of marketable fruits harvested in different treatments (expressed in Number of marketable fruits/ha)
FIG. 12 presents the mean fruit weight (g/fruit) of the different treatments

Regarding the yield, OLREDY and OR-501 presented a numerically higher fruit production (in Ton/ha) compared to the untreated control. Although not significant, substantial gains of yield of 33 and 25 points were respectively recorded for OLREDY and OR-501 in relation to the control treatment (forced to 100%).

Regarding the total number of marketable fruits, OLREDY and OR-501 presented a numerically number of marketable fruits compared to the untreated control. Although not significant, substantial gains of number of marketable fruits of 32 and 23 points were respectively recorded for OLREDY and OR-501 in relation to the control treatment (forced to 100%).

Regarding the mean fruit weight (g/fruit), all treatments presented very similar values. This result confirms the positive effect of OLREDY and OR-501 on the total fruit production as no reductions of the mean fruit weight were observed despite the substantially higher number of marketable fruits and yield recorded in the treated objects in relation to the control.

### Conclusions

This trial conducted under commercial conditions of tomato production confirmed the nematicide activity of ORO-501 against Meloidogyne incognita and its associated benefits on the tomato production.

Three applications of ORO-501 through the drip irrigation system at the beginning of the crop cycle resulted in:
A numerical reduction of the root galling intensity compared to the control
A significant reduction of the nematode population (Number of J2) compared to the control throughout the trial
A numerical increase of the total tomato production in quantity (Ton of tomato/ha) and number of marketable fruits without any alteration of the mean fruit weight

Applications of ORO-501 at 10 L/ha were safe to the crop and did not induce any kind of phytotoxicity and also reduce the uses of traditional pesticides reducing the level of pesticides residues in soil and in crops (food or non-food crops).

Other important characteristics praised by the researchers of OR-501 and common to all formulation made according to this invention is the easy storage at room temperature and for at least 2 years. It is much more realistic for farmers and end users than biologicals that are 3 or 6 months of shelf-life and/or storage at 5° C. to −18° C. (refrigerated or ultra refrigerated).

The high stability and prolonged shelf-life of composition made according to this invention give to the end users the confidence to get the same rate and performance of biologicals during the validity of a biological commercial product.

The Applicant was surprised that the carrier composition including alkyl lactates (and/or derivatives thereof) and carboxylic acids, when loaded with a microbial biocontrol agent, did not damage and/or destroy said microbial biocontrol agent since it is well known from the prior art at that alkyl lactates and carboxylic acids are antimicrobial as per the teachings of EP 1898900B1. This is particularly true for ORO-501 (pLCC also OR-N-6).

### Example 5

Field efficacy of ORO-501 also named B-017-001 [Bacillus amyloliquefaciens (20%)+UCCa (80%)] to Melon controlling Meloidogyne incognita. Shandong—China (September 2022)

TABLE 23
trial identification and location

| | |
|---|---|
| Target | Field Efficacy of ORO-501 versus standard treatment |
| | to melon controlling Meloidogyne incognita |
| Crop | Melon (Xizhoumi) |
| Treatment | Dipping root on the day of transplanting |
| | irrigating 23 days after transplanting |
| Location | Shouguang Shandong China |
| Trial date | Dipping on July 25^{th}, irrigating on August 17^{th} |
| Investigating | Sep. 17^{th}, 2022 |
| date | |

### Trial and Treatment Details

1. Dipping root on the day of transplanting with the rate of 1% (10 ml/1 L)+metalaxyl-M+hymexazol, irrigating 23 days after transplanting with dosage of 9 L/ha.
2. Dipping root on the day of transplanting with the rate of 1% (10 ml/1 L)+metalaxyl-M+hymexazol, irrigating 23 days after transplanting with abamectin 3% CS 15 L/ha.
3. Dipping root on the day of transplanting with metalaxyl-M+hymexazol, irrigating abamectin 3% CS+3 billion/g Bacillus amyloliquefaciens (ORO-501 (also named B-017-001-Bacillus amyloliquefaciens+UCCa). Reference—commercial Paecilomyces lilacinus with the dosage of 15 kg/ha.+15 kg/ha., irrigating 23 days after transplanting with abamectin 3% CS 15 L/ha.

### Results

The field trial was made in a third part facility greenhouse farm. After harvest of the melons were collected and evaluated. The roots of plants that was irrigated with ORO-501dripping+irrigating treatment were pulled out by hand by the farmer and other treatments were collected by spade (roots more affected by the nematodes).

The number of healthy and infected roots, healthy and infected melons and all evaluation and statistic are included in Table 24 below.

It is notice that because the roots in abamectin treatments are affected by nematodes, even they were pulled out by spade, they were still shorter than roots treated using ORO-501dipping+abamectin.

TABLE 24
shows a summary of results after harvest

| | | | | | Rate of | Rate of |
|---|---|---|---|---|---|---|
| | Total | Health | Nematode | Root rot | nematode | root rot |
| Treatment | melon | melon | melon | melon | melon | melon |
| ORO-501 dipping and | 168 | 150 | 18 | 0 | 10.70% | 0 |
| irrigating | | | | | | |
| ORO-501 dipping + | 27 | 19 | 7 | 1 | 25.90% | 3.70% |
| abamectin irrigating | | | | | | |
| abamectin + Paecilomyces | 60 | 37 | 23 | 0 | 38.30% | 0 |
| lilacinus irrigating and | | | | | | |
| abamectin irrigating alone | | | | | | |

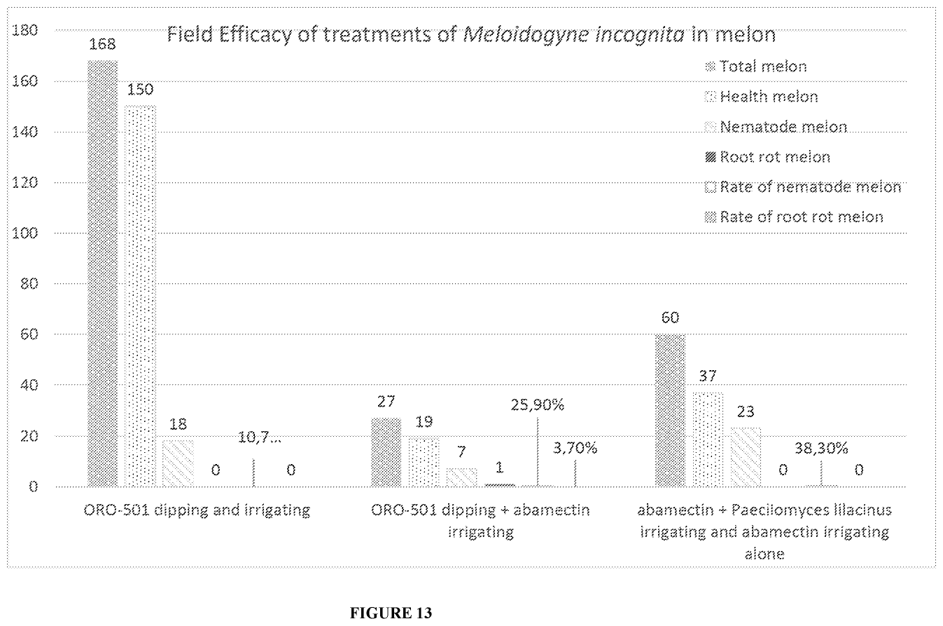

FIG. 13 shows the bar plot of the data summary of healthy and infected melons, healthy and infected roots, percentage of healthy and infected melons and roots per treatment to melon controlling Meloidogyne incognita data was recorded at the end of the trial during the harvest.

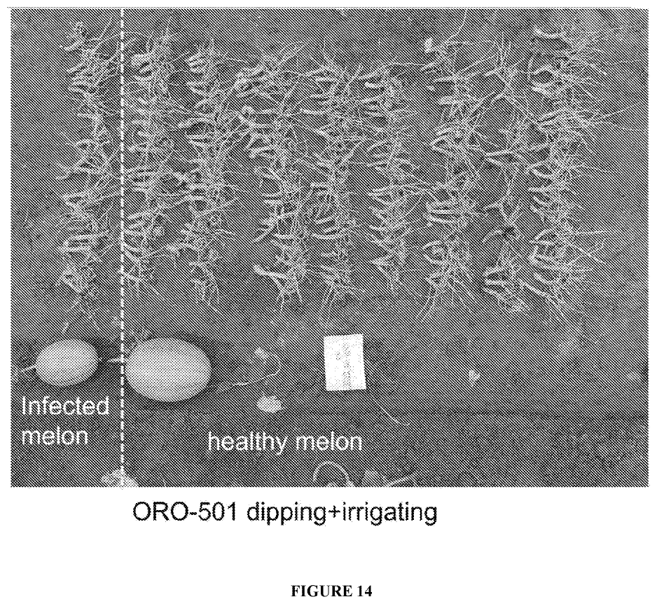

FIG. 14 shows the picture of healthy and infected roots and exemplars of a healthy and an infected melon after harvest. The harvested melons and roots are referred to the treatment using the composition ORO-501 also named B-017-001 (Bacillus amyloliquefaciens 20%+UCCa 80%) versus standard treatment to melon controlling Meloidogyne incognita.

### Conclusions

1. ORO-501 has good efficacy to nematodes with dipping on the day of transplanting at the rate of 1% and irrigating 23 days later at the dosage of 9 L/ha., its efficacy is estimated to last for about 15-20 days in this dosage.
2. ORO-501 can mix with fungicides in dipping.
3. The melon infected rate by nematodes of ORO-501 is 10.7%, which is much lower than abamectin+Paecilomyces, where the rate of melon infected by nematodes is 38.3%.

4. ORO-501 can be used to prevent melon nematodes by irrigating on the day of transplanting and irrigating again 15-20 days later, because the infection of melon in ORO-501 treatment with rate of 10.7%, therefore, it will be evaluate changing the application method from dipping to irrigating on the day of transplanting.
5. It was clear for all involved in the trial that the composition ORO-501 delivered much more than only a control of nematodes. It is clear evaluating the size of fruits, healthy, time of harvest, architecture of the plants and the fruits that ORO-501 has characteristics of a biostimulant and/or a plant grow regulator. Its mode of action will be investigated during the next seasons in field trials, in laboratory phenotyping system and in greenhouse trials.
6. Other field trials and laboratory trials for register are on-going in China and other location for generate data and knowledge for future reference.

### On-Going Tests and Trials

### Disease Bio-Efficacy Screening-Fungicides

Samples of the agricultural compositions of certain embodiments are under evaluation regarding disease bio-efficacy and are being evaluated in comparison with other products and samples to evaluate viability, shelf-life, synergistic and antagonist effects and efficacy against most common or applicable plant pathogens in vitro.

Growth inhibition was measured using potato dextrose agar (PDA) amended with the test compounds to compare colony growth of several fungi, employing plain (unamended) PDA plates served as controls. Cultures of Aspergillus niger, Botrytis cinerea, Colletotrichum fioriniae, Fusarium moniliforme, F. oxysporum, Macrophomina phaseolina, Verticillium dahlia, and Xanthomonas arboricola pv. Juglandis, Botrytis cinerea, Fusarium graminearum, Macrophomina faseolina, Alternaria alternata, Monolinia fructigena, Phytophthora infestans strain EU_6_A1, Phytophthora infestans strain EU_13_A2, Phytophthora infestans strain EU_36_A2, Phytophthora infestans strain EU_37_A2, Phytophthora infestans strain EU_41_A2, among other agricultural available species are or they will be grown on acidified potato dextrose agar and/or in specifics means other than PDA. The amended and control plates will be inoculated with mycelial plugs (5 mm diameter), then incubated at 25° C. until the colonies in the controls neared the edge of the plates for each species. Colony radius will be measured and percent inhibition are calculated for each test compound in relation to the radius of control plates.

### Greenhouse Trials and Plot Tests

Samples of the agricultural compositions of certain embodiments are under evaluation in a disease bio-efficacy screening protocol and are being evaluated in comparison with other products and samples to evaluate performance, viability, shelf-life, synergistic and antagonist effects and efficacy against most common or applicable plant pathogens in greenhouse and in plot tests.

Field trials are designed to test the most viable agricultural compositions in comparison with commercial benchmark products in several countries and regions such as Europe, Brazil, United States, South Africa, Australia, China and India.

Disease Bio-Efficacy Screening-Insecticidal, Pesticidal, Miticidal, Acaricidal, Ovicidal, Herbicidal, Fungicidal. Viricidal, Nematicidal Tests:

Samples of the agricultural compositions of certain embodiments are under evaluation regarding disease bio-efficacy and are being evaluated in comparison with other products and samples to evaluate viability, shelf-life, synergistic and antagonist effects and efficacy against most common or applicable plant pathogens in vitro. Modes of action are also being investigated. The Applicant envisages that the compositions according to the first and second aspects of this disclosure and/or as provided herein may provide effective solutions to plant pathogens and/or biostimulation of plants.

In conclusion, the Applicant believes that the disclosures according to the first to fourth aspects of this disclosure at least partially ameliorates one of the disadvantages known in the prior art.

While the invention has been described in detail with respect to specific embodiments and/or examples thereof, it will be appreciated that those skilled in the art, upon attaining an understanding of the foregoing may readily conceive of alterations to, variations of and equivalents to these embodiments. Accordingly, the scope of the present invention should be assessed as that of the claims and any equivalents thereto, which claims are appended hereto.

1. An agricultural composition comprising:
a (C₁₀-C₂₂) alkyl lactate;
at least one (C₂-C₂₂) alcohol selected from the group consisting of: butanol, butan-2-ol, pentanol, pentan-2-ol, pentan-3-ol, hexanol, hexan-2-ol, hexan-3-ol, heptanol, heptan-2-ol, heptan-3-ol, heptan-4-ol, octanol, octan-2-ol, octanol-3-ol, octan-4-ol, 2-ethylhexanol, nonanol, nonan-2-ol, nonan-3-ol, nonan-4-ol, nonan-5-ol, decanol, decan-2-ol, decan-3-ol, decan-4-ol, decan-5-ol, undecanol, undecane-2-ol, undecane-3-ol, undecane-4-ol, undecane-5-ol, and undecane-6-ol;
at least one humectant selected from the group consisting of: glycerin or alkyl ethers thereof, (C₂-C₃₀) alkylene glycol, propylene glycol, polypropylene glycol or alkyl ethers thereof, sorbitol, mannitol, dulcitol and/or polyols, and/or any combination thereof;
at least one non-ionic surfactant selected from the group consisting of: natural and/or synthetic (C₈-C₂₂) alkoxylated fatty alcohols, (C₈-C₂₂) ethoxylated fatty alcohols, (C₈-C₂₂) propoxylated fatty alcohols, (C₈-C₂₂) ethoxylated and propoxylated fatty alcohols, (C₆-C₂₂) alkoxylated fatty acids, (C₆-C₂₂) ethoxylated fatty acids, (C₆-C₂₂) propoxylated fatty acids, EO-PO (C₆-C₂₂) ethoxylated and propoxylated fatty acids, straight chain (C₄-C₁₀) alkyl(poly)glycosides, branched chain (C₄-C₁₀) alkyl(poly)glycosides; and alkoxylated sorbitan fatty esters, alkoxylated sorbitol fatty esters, ethoxylated sorbitan fatty esters, ethoxylated sorbitol fatty esters, polyoxyethylene sorbitan monolaurate, polyoxyethylene sorbitan monopalmitate, polyoxyethylene sorbitan monostearate, polyoxyethylene sorbitan monolaurate, polyoxyethylene glycol sorbitan monolaurate, polyoxyethylene glycol sorbitan monopalmitate, polyoxyethylene glycol sorbitan monostearate, and combinations thereof; and
water.

2. The agricultural composition according to claim 1, wherein the (C₁₀-C₂₂) alkyl lactate is at least one selected from the group consisting of: decyl lactate, undecyl lactate, dodecyl lactate, tridecyl lactate, tetradecyl lactate, pentadecyl lactate, hexadecyl lactate, heptadecyl lactate, octadecyl lactate, nonadecyl lactate, eicosyl lactate, heneicosyl lactate, and docosyl lactate.

3. The agricultural composition according to claim 1, wherein the (C₁₀-C₂₂) alkyl lactate is at least one selected from the group consisting of: lauryl lactyl lactate, lauryl lactate, myristyl lactate, and cetyl lactate.

4. The agricultural composition according to claim 1, further comprising at least one C₂-C₂₂ carboxylic acid and/or a salt thereof selected from the group consisting of: ethanoic acid, 2-hydroxyethanoic acid, oxoethanoic acid, ethanedioic acid, propanoic acid, propenoic acid, propynoic acid, 2-hydroxypropanoic acid, 3-hydroxypropanoic acid, 2,3-dihydroxypropanoic acid, 2-oxopropanoic acid, 3-oxopropanoic acid, 2,3-oxopropanoic acid, propanedioic acid, 2-hydroxypropanedioic acid, 2-hydroxy-3-oxopropanoic acid, 2,2-dihydroxypropanedioic acid, oxopropanedioic acid, oxirane-2-carboxylic acid, butanoic acid, 2-methylpropanoic acid, (E)-but-2-enoic acid, (Z)-but-2-enoic acid, 2-methylpropenoic acid, but-3-enoic acid, but-2-yonic acid, 2-hydroxybutanoic acid, 3-hydroxybutanoic acid, 4-hydroxybutanoic acid, 2-oxobutanoic acid, 3-oxobutanoic acid, 4-oxobutanoic acid, butanedioic acid, 2-methylpropanedioic acid, (E)-butenedioic acid, (Z)-butenedioic acid, butynedioic acid, hydroxybutanedioic acid, 2,3-dihydroxybutanedioic acid, oxobutanedioic acid, dioxobutanedioic acid, pentanoic acid, 3-methylbutanoic acid, 2-methylbutanoic acid, 2,2-dimethylpropanoic acid, 3-hydroxypentanoic acid, 4-hydroxypentanoic acid, 3-hydroxy-3-methylbutanoic acid, pentanedioic acid, 2-oxopentanedioic acid, 3-oxopentanedioic acid, furan-2-carboxylic acid, tetrahydrofuran-2-carboxylic acid, hexanoic acid, hexanedioic acid, 2,3-dimethylbutanoic acid, 3,3-dimethylbutanoic acid, 2-hydroxypropane-1,2,3-tricarboxylic acid, prop-1-ene-1,2,3-tricarboxylic acid, 1-hydroxypropane-1,2-3-tricarboxylic acid, (2E, 4E)-hexa-2,4-dienoic acid, heptanoic acid, heptanedioic acid, cyclohexanecarboxylic acid, benzenecarboxylic acid, 2-hydroxybenzoic acid, 2,2-dimethylpentanoic acid, 2,3-dimethylpentanoic acid, 2,4-dimethylpentanoic acid, 3,3-dimethylpentanoic acid, 2-ethylpentanoic acid, 3-ethylpentanoic acid, 2-methylhexanoic acid, 3-methylhexanoic acid, 2,2,3-trimethylbutanoic acid, 2-ethyl-2-methylbutanoic acid, 2-ethyl-3-methylbutanoic acid, octanoic acid, benzene-1,2-dicarboxylic acid, benzene-1,3-dicarboxylic acid, benzene-1,4-dicarboxylic acid, 2-methylheptanoic acid, 3-methylheptanoic acid, 4-methylheptanoic acid, 5-methylheptanoic acid, 6-methylheptanoic acid, 2,2-dimethylheptanoic acid, 2,3-dimethylheptanoic acid, 2,4-dimethylheptanoic acid, 2,5-dimethylheptanoic acid, 3,3-dimethylheptanoic acid, 3,4-dimethylheptanoic acid, 3,5-dimethylheptanoic acid, 4,4-dimethylheptanoic acid, 4,5-dimethylheptanoic acid, 5,5-dimethylheptanoic acid, 2-ethanhexanoic acid, 3-ethanhexanoic acid, 4-ethanhexanoic acid, 5-ethanhexanoic acid, 2-octenoic acid, 3-octenoic acid, 4-octenoic acid, 5-octenoic acid, 6-octenoic acid, 7-octenoic acid, benzene-1,3,5-tricarboxylic acid, (E)-3-phenylprop-2-enoic acid, decanoic acid, decanedioic acid, undecanoic acid, dodecanoic acid, benzene-1,2,3,4,5,6-hexacarboxylic acid, tridecanoic acid, tetradecanoic acid, pentadecanoic acid, hexadecanoic acid, heptadecanoic acid, octadecanoic acid, (9Z)-octadec-9-enoic acid, (9Z, 12Z)-octadeca-9,12-dienoic acid, (9Z, 12Z, 15Z)-octadeca-9,12,15-trienoic acid, (6Z, 9Z, 12Z)-octadeca-6,9,12-trienoic acid, (6Z, 9Z, 12Z, 15Z)-octadeca-6,9,12,15-tetraenoic acid, nonadecanoic acid, eicosanoic acid, (5Z, 8Z, 11Z)-eicosa-5,8,11-trenoic acid, (5Z, 8Z, 11Z, 14Z)-eicosa-5,8,11,14-tetraenoic acid, (5Z, 8Z, 11Z, 14Z, 17Z)-eicosa-5,8,11,14,17-pentaenoic acid, heneicosanoic acid, docosanoic acid, (4Z, 7Z, 10Z, 13Z, 16Z, 19Z)-docosa-4,7,10,13,16,19-hexaenoic acid, and salts thereof.

5. The agricultural composition according to claim 1, further comprising at least one plant hormone selected from the group consisting of: abscisic acid, auxins, brassinosteroids, cytokinins, ethylene, gibberellins, jasmonate, jasmonic acid, salicylic acid, strigolactones, polyamines, nitric acid, and triacontanol.

6. The agricultural composition according to claim 1, further comprising a secondary metabolite.

7. The agricultural composition according to claim 6, wherein the secondary metabolite is salicylic acid and/or itaconic acid.

8. The agricultural composition according to claim 1, further comprising a microorganism selected from the group consisting of: viruses, bacteria and fungi.

9. The agricultural composition according to claim 1, further comprising a binder.

10. The agricultural composition according to claim 9, wherein the binder is selected from the group consisting of: polysaccharides, sucrose, fructose, saccharose, pectin, amylopectin, gelatin, starch, modified starch, alginates, modified alginates, natural gums, modified gum, gar gums, rosin, tall oil rich in rosin, (C₁-C₃₀) alkyl cellulose, salts of (C₁-C₃₀) alkyl cellulose, carboxymethyl cellulose, salts of carboxymethyl cellulose, sodium carboxymethyl cellulose, microcrystalline cellulose, polyvinyl pyrrolidone, cross-linked polyvinylpyrrolidone, dimethylaminoethyl-methacrylate copolymer, PVP/hexadecene copolymer, poly acrylates, and combinations thereof.

11. The agricultural composition according to claim 1, further comprising an additive selected from the group consisting of: preservatives, clarifiers, anti-freezing agents, hydrotropes, stabilizers, antioxidants, acidifiers, chelates, complexing agents, dyes, rheology modifiers, antifoams, anti-drift, oil or other solvents, and combinations thereof.

12. The agricultural composition according to claim 1, further comprising an at least one anionic surfactant selected from the group consisting of: (C₆-C₁₈) alkyl benzene sulfonic acid salts, calcium dodecylbenzene sulfonate, sodium dodecylbenzene sulfonate, amine (C₆-C₁₈) alkyl benzene sulfonate, triethanolamine dodecylbenzene sulfonates, (C₆-C₁₈) alkyl ether sulfates, (C₆-C₁₈) alkyl ethoxylated ether sulfates, (C₆-C₁₈) alkyl sulfates, lauryl ether polyethoxylated sodium sulfate, lignosulfonates, phenylsulfonates, naphthalenesulfonates, dibutylnaphthalenesulfonates, (C₆-C₁₈) alkyl phosphate esters, (C₆-C₁₈) alkoxylated sulfates, xylene sulfonate salts, cumene sulfonate salts, lignosulfonates, phenylsulfonates, naphthalenesulfonates, dibutylnaphthalenesulfonates, alkyl polyglycol ether phosphates, polyarylphenyl ether phosphates, alkyl-sulfosuccinates, olefin sulfonates, condensation products of sulfonated naphthalenes with formaldehyde, condensation products of sulfonated naphthalenes with formaldehyde and phenol and optionally urea and condensation products of phenolsulfonic acid with formaldehyde and urea, (C₆-C₁₈) alkoxylated phosphate esters, alkyl phosphates, alkyl aryl phosphates, for example tristyryl phosphates, and polycarboxylates such as for example polyacrylates, maleic anhydride/olefin copolymers, including the alkali metal, alkaline earth, ammonium and amine salts of the aforesaid substances and/or combinations thereof.

13. The agricultural composition according to claim 1, wherein the (C₁₀-C₂₂) alkyl lactate is present in an amount of between about 5 wt. % to about 50 wt. % of the total wt. % of a formulated agricultural composition, wherein the C₂-C₂₂ alcohol is present in an amount of between about 0.1 wt. % to about 20 wt. % of the total wt. % of a formulated agricultural composition, wherein the humectant is present in an amount of between about 1 wt. % to about 30 wt. % of the total wt. % of a formulated agricultural composition, wherein the non-ionic surfactant is present in an amount of between about 1 wt. % to about 50 wt. % of the total wt. % of a formulated agricultural composition, and wherein the water is between about 1 wt. % to about 80 wt. % of the total wt. % of a formulated agricultural composition.

14. The agricultural composition according to claim 13, further comprising a carboxylic acid present in an amount of between about 0.1 wt. % to about 20 wt. % of the total wt. % of a formulated agricultural composition.

15. The agricultural composition according to claim 13, further comprising a plant hormone present in an amount of between about 0.1 wt. % to about 20 wt. % of the total wt. % of a formulated agricultural composition.

16. The agricultural composition according to claim 13, further comprising a secondary metabolite present in an amount of between about 0.1 wt. % to about 20 wt. % of the total wt. % of a formulated agricultural composition.

17. The agricultural composition according claim 13, further comprising a microorganism present in an amount of between about 1 wt. % to about 70 wt. % of the total wt. % of a formulated agricultural composition.

18. The agricultural composition according to claim 13, further comprising a binder present in an amount of between about 0.1 wt. % to about 20 wt. % of the total wt. % of a formulated agricultural composition.

19. The agricultural composition according to claim 13, further comprising an additive present in an amount of between about 0.1 wt. % to about 20 wt. % of the total wt. % of a formulated agricultural composition.

20. An agricultural composition comprising:
at least one (C₁₀-C₂₂) alkyl lactate selected from the group consisting of: lauryl lactyl lactate, lauryl lactate, myristyl lactate, and cetyl lactate;
octan-2-ol;
glycerin;
a polyoxyethylene sorbitan monolaurate;
a secondary metabolite, wherein the secondary metabolite is salicylic acid and/or itaconic acid;
a microorganism;
a binder; and
water.

21. The agricultural composition according to claim 20, wherein the microorganism is at least one of any species in the genera group consisting of: Agrobacterium, Bacillus, Burkholderia, Paenibacillus, Pseudomonas, Rhanella, Rhizobium, Saccharopolyspora, Serratia, Streptomyces, Alternaria, Aerobasidium, Ampelomyces, Aschersonia, Aspergillus, Beauveria, Candida, Clonostachys, Coniothyrium, Cordyceps, Entomophaga, Fusarium, Glomus, Hirustella, Isaria, Lecanicillium, Metarhizium, Paecilomyces, Penicillium, Pichia, Pseudozyma, Saccaharomyces, Talaromyces, Trichoderma, Verticillium, Lagenidium and Baculovirus.

22. An agricultural composition comprising:
at least one (C₁₀-C₂₂) alkyl lactate selected from the group consisting of: lauryl lactyl lactate, lauryl lactate, myristyl lactate, and cetyl lactate;
octan-2-ol;
glycerin;
a polyoxyethylene sorbitan monolaurate;
a binder; and
water.
